(19) United States
(12) Patent Application Publication
(10) Pub. No.: US 2012/0283857 A1
(43) Pub. Date: Nov. 8, 2012

(54) On a mathematical formulation of the concept of changing coalitions in many person differential games

(76) Inventor: Ioannis Boultis, Thessaloniki (GR)

(21) Appl. No.: 13/407,761

(22) Filed: Feb. 29, 2012

Related U.S. Application Data
(60) Provisional application No. 61/449,652, filed on Mar. 5, 2011.
(60) Provisional application No. 61/502,860, filed on Jun. 30, 2011.
(60) Provisional application No. 61/589,799, filed on Jan. 23, 2012.

(51) Int. Cl. G06F 19/00

(52) U.S. Cl. 700/93

(57) ABSTRACT

A differential game is interpreted as a many person game where two coalitions are formed. A coalition change is defined and the time this happens, called c-time, is introduced. Various methods are introduced to obtain optimal c-times. The above are generalized to an arbitrary number of coalition changes, cases where players change values of parameters of a differential game and cases where players choose different strategies in a differential game than those obtained by the Isaacs solution. A broader coalition is introduced that allows players to cooperate though they might be opponents in a particular differential game.

### CROSS-REFERENCE TO RELATED APPLICATIONS

I claim the benefits of the following provisional applications:

| | |
|---|---|
| 1) Application number: 61/449,652 | Filing date: Mar. 05, 2011 |
| 2) Application number: 61/502,860 | Filing date: Jun. 30, 2011 |
| 3) Application number: 61/589,799 | Filing date: Jan. 23, 2012 |

### BACKGROUND OF THE INVENTION

In “Handbook of Game Theory with economic applications, Aumann-Hart editors, vol. 2, chapters 22 and 23” there are some examples of N-person differential games. There are given N payoff functions and the Nash equilibrium is formulated, constrained by differential equations. There are also some references there, for example:
Tolwinski (1982): “On cooperative equilibria in dynamic games”, Automatica, 18,
Ho and Olsder (1983): “Differential games concepts and applications”, Mathematics of conflict (Shubik, ed.),
Kaitala (1986): “Game theory models of fisheries management-a survey”, Dynamic games and applications in economics (Basar, ed.),
Benhabib and Radner (1992): “Joint exploitation of a productive asset”, Economic theory, 2.

According to comments in chapter 23 in “Handbook of Game Theory” mentioned above, in the first three papers there are results on cooperative differential games, and the last one relates these with repeated games. But I have no access to these papers. Also, to my knowledge which is rather limited on the background of the theory of games, repeated games refer to matrix games and not Isaacs games.

The theory of c-games is a mathematical formulation of the concept of changing coalitions in many person differential games. Players take part in sequences of differential games. One can formally describe cases where a player joins a group A in a differential game and play in a particular interval of time against a group B while his objective is the gain of the group B. One can describe cases where the members of a the group B join various groups and then leave these groups to join others and play a new differential game and so on. The theory of c-games has a quite large algebraic structure, in my opinion, to deal with almost any form of coalition change. From the simplest ones, where a single player plays only one differential game and then leaves, to the more complex cases mentioned above.

### BRIEF SUMMARY OF THE INVENTION

Consider a differential game and the control functions Φ={φ1, φ2, . . . , φp} and Ψ={ψ1, ψ2, ψq}. This game can be given a trivial interpretation as a many person differential game. One can assume that a player X1 controls the subset {φ1, φ2} of Φ and he has formed an, elementary, coalition with the others that control the rest functions in Φ. Then player X1 chooses to leave this coalition and join players that control ψ functions, thus a new game will be played. The time t1 of this change, called c-time or time of change, is a variable that the player wants to estimate in an optimal way. If no one else is allowed to change coalitions then player X1 can estimate the optimal time to make this change of elementary coalitions by solving an optimization problem. For this he can use as payoff the payoff in the differential games or any other appropriate function. Obviously these payoff, denoted P1(t1) will be a function of the time t1 where the first game is interrupted and the second begins. In case two players X1 and X2 can change elementary coalitions, the times they choose to do so are denoted t1 and t2. Their payoffs will be functions of both times, P1(t1,t2) and P2(t1,t2). One, quite trivial, way to obtain values for the variables t1 and t2 is to formulate and solve a zero sum continuous game with payoff P1-P2. One can also formulate a non cooperative game and find the Nash solution. Plotting the payoffs of each player as functions of a single time t, one can see in the simplest cases, where the graphs are convex, if a point t is better than another point t′ to make the coalition change. This leads to a different solution method, referred in this paper as empirical solution. One can combine, in a simple way, the empirical solution with the zero sum game solutions or the Nash solutions and obtain new methods. If three players can change coalitions one can formulate a zero sum game with payoff P1+P3−P2. One can interpret this as new kind of coalition among players X1 and X3, this coalition is called c-coalition. The above notions can be generalized to an arbitrary number of players, arbitrary number of elementary coalition changes and the formation of an arbitrary number of c-coalitions. The theory of c-games is a mathematical formulation of these concepts.

### DETAILED DESCRIPTION OF THE INVENTION

In paragraphs [0001] until [0022] the definition of quantities is given using a simple example. In [0023] until [0044] the c-game is defined in an axiomatic way. In [0045] until [0081] the solution concepts are given.

The Differential Game, the E-Coalitions, the E-Game and the One Player Payoff

Consider the differential game of war of attrition and attack with equations

dx(1)/dt=m(1)−c(1,2)φ(2)×(2)−c(1,3)φ(3)×(3)

dx(2)/dt=m(2)−c(2,1)ψ(2)×(1)

dx(3)/dt=m(3)−c(3,1)ψ(3)×(1)

and payoff, called Isaacs payoff,

P(ψ(2),ψ(3),φ(2),φ(3))=∫[(1−ψ(2)−ψ(3))×(1)−(1−φ(2))×(2)−(1−φ(3))×(3)]dt.

The optimal controls are determined by

$${MAX}_{Ψ ( 2 ) , Ψ ( 3 )} {MIN}_{φ ( 2 ) , φ ( 3 )} P ( Ψ ( 2 ) , Ψ ( 3 ) , φ ( 2 ) , φ ( 3 ) )$$

and this method is called Isaacs solution concept.

This game can be interpreted as a many person game where players 2 and 3 form a coalition called an elementary coalition or e-coalition against player 1.

This differential game with the set of players N1={1} and N2={2,3} is called an elementary game or e-game. We call players in N1 maximizers and players in N2 minimizers. The sets N1 and N2 are called elementary coalitions or e-coalitions in the e-game.

One can consider the expression

∫[(1−ψ(2)−ψ(3))×(1)]dt

as payoff of player 1 in the e-game, and similarly the two other terms

∫[[−(1−ψ(2))×(2)]dt

and

∫[[−(1−φ(3))×(3)]dt

as payoff of players 2 and 3 in the e-game.

One can easily write down similar motion equations, Isaacs payoffs and one player payoffs in case players 1 and 2 play against 3 and in case 1 and 3 play against 2.

The E-Coalition Change, the C-Change, the C-Time and the C1-Game

In [0001] one can consider the case where at a particular time t, smaller than the time the differential game ends, player 2 chooses to join player 1 against player 3. We call this change of sets of players an elementary coalition change or an e-coalition change.

We define a c-change to be an ordered pair of games where the first game is interrupted at time t, the second begins at time t and the sets of players of the two games are related by an e-coalition change.

The time t a player chooses to do this change of e-coalitions is called c-time.

This case is written symbolically as

{1;2,3}---->{1,2;3}.

Similarly we can consider the case

{1;2,3}---->{1,3;2}.

We define a game where one e-coalition change can happen, or briefly a C1-game, to be the pair

{{1;2,3}---->{1,2;3},

{1;2,3}---->{1,3;2}}.

Denote {1; 2, 3} by a(0), {1, 2; 3} by a(1) and {1, 3; 2} by a(2). The C1-game can be written as

{(a(0),a(1)),(a(0),a(2))}.

The c-change in

{1;2,3}---->{1,2;3}

will be denoted by

((a(0),a(1)))

and similarly in

{1;2,3}---->{1,3;2}

will be denoted by

((a(0),a(2))).

The Realizations and the Order of an E-Game

Since in the C1-game in [0002] by definition only one e-coalition change can happen, either

a(0),a(1))

or

a(0),a(2))

sequence of the differential games in e-games will be played. We call these sequences realizations, denote them by

A(1)=(a(0),a(1))

and

A(2)=(a(0),a(2))

and denote the C1-game also by {A(1), A(2)} or by {A(j): j in J} where J={1, 2}.

The following notation will also be needed

A(1)=(a(1,0),a(1,1)

and

A(2)=(a(2,0),a(2,1)

where
a(1,0)=a(2,0)=a(0),
a(1,1)=a(1),
a(2,1)=a(2),
   We say that a(0) is an e-game of order 0 and a(11) and a(2) are e-games of order 1 in the C1-game. We say realizations A(1) and A(2) have length 2.

The Tree Structure of the C1-Game

Given the C1-game in [0003] one can easily define a tree with root the e-game a(0), leaves the e-games a(1) and a(2) and edges the c-changes ((a(0), a(1))) and ((a(0), a(2))).

Payoffs in a C1-Game

In the C1-game in [0002] players 2 and 3 have to decide when is the best time to make the c-change. We need to introduce payoffs so the players can choose the time to make the c-change by optimizing these payoffs. The simplest way to define payoffs for the players in the C1-game is to use the one player payoffs in the e-game introduced in [0001].

Assume the C1-game is written, in the notation of [0003], as

{A(j):j in J}

where

A(j)=(a(j,0),a(j,1)

Denote the payoff of player i in e-game a(j,k) by P(i,a(j,k)) where i belongs in {1, 2, 3}, j belongs in {1, 2} and k belongs in {0, 1}. Assume player 2 chooses c-time t to change e-coalition. Then realization A(1) will be played. One can introduce the following one player payoffs

P(i,A(1),t)==E(a(1,0),i)P(i,a(1,0))+E(a(1,1),i)P(i,a(1,1))

in realization A(1), where E(a, i) is a function that takes the value 1 if player i is maximizer in e-game a, −1 if i is minimizer and 0 is i doesn't take part in e-game a.

These payoffs are functions of t because t is the upper limit in the integral defining P(i, a(1,0)) and t is the lower limit in the integral defining P(i, a(1,1)).

Similarly if player 3 chooses to change at time s the one player payoffs in realization A(2) can be

P(i,A(2),s)==E(a(2,0),i)P(i,a(2,0))+E(a(2,1),i)P(i, a(2,1))

One can introduce the following one player payoffs in the C1-game

P(i,t,s)=step(s−t)P(i,A(1),t)+step(t−s)P(i,A(2),s),

where step(x) is the step function that equals 1 if x is larger than 0 and equals 0 if x is smaller or equal than zero.

The Domain of C-Times in a C1-Game

The c-times s and t can take values in the interval that begins at t0(a(1,0)) and ends at t1(a(1,0)) where t0(a(1,0)) is the time the differential game in the root e-game a(1,0) begins and t1(a(1,0)) is the time it ends if it is not interrupted. Whether some of the points t0(a(1,0)) and t1(a(1,0)) are included in the domain or not depends on the exact mathematical definition of the solution and on the general definition of a c-game.

If all e-games are supposed to be played in the realization the players choose, then the domain of c-times consists of the open interval (t0(a(1,0)), t1(a(1,0))). If we allow players to skip the e-game a(1,0)) the interval will contain t0(a(1,0)). If we allow players to skip a(1,1) and a(2,1) then t1(a(1,0)) is included in the domain.

In these first paragraphs we assume that although players are thinking to change e-coalitions until they do that they chose their optimal control functions as these are determined by the Issacs solution of the game. Later we can generalize to include control functions that are not determined by Isaacs solution.

The Game Type Solution of a C1-Game

Given the payoffs in [0005] one can introduce the following way to obtain the “optimal” c-times, called game type solution:

define P(t, s)=P(2, t, s)−P(3, t, s) and formulate and solve the zero sum game

$${MAX}_{t} {MIN}_{s} P ( t , s ) .$$

The Nash Type Solution of a C1-Game

Given the payoffs in [0005] one can introduce the following way to obtain the “optimal” c-times, called Nash type solution:

formulate the game

$${MAX}_{t} P ( 2 , t , s )$$

$${MAX}_{s} P ( 3 , t , s )$$

and find the Nash equilibrium.

The Empirical Solutions of C1-Games

Given the payoffs in [0005] one can introduce methods to obtain the “optimal” c-times called lower empirical type solution, upper empirical type solution, game empirical type solution and Nash empirical type solution.

These methods are based on the following:

a) Assume are given any two times t and t′ in the closed interval [t0(a(1,0)), t1(a(1,0))], such that t<t′.
b) Assume that if player i chooses t to make the c-change his payoff is P(i,t) and is larger or equal P(i,t′) he gets at t′. Then t is better than t′, for player i.
c) Assume player i gets more at t than at t′ if player i′ chooses to make a c-change at t. In that case player i has to force player i′ to make the c-change at t. He can do that by threatening i′ by: if player i makes a c-change at t then player i′ gets worse than he gets in case player i′ makes a c-change at t. In this case also t is better than t′, for player i.

In the upper empirical solution players do not use any threats. In the lower empirical solution all threats are forcing a player to make a c-change. The game and Nash empirical solution are introduced to give a better answer in the question of threats.

Exact definitions of these solution concepts will be given later.

An Example of a C-Coalition

In the cases of [0007] and [0008] solutions one player, say player 2, can introduce as his payoff the sum of his' own one player payoff and the one player payoff of player 1. In that case we say players 1 and 2 formed a c-coalition in the C1-game.

An Example of Additional Variables

One can introduce additional variables in the C1-game, except the c-times. In the example in [0001] player 1 can change the constant c(1) to c(1)+dc in the second game by an unknown amount dc and use this dc as a variable to be determined by the solution concept in [0007] or in [0008], along with the c-times. These type of scalar variables are called additional variables.

An Example of Non-Isaacs Variables

One can also consider the possibility of control functions in [0001] not being determined by the Isaacs solution concept. In that case the one player payoffs will depend on unknown functions. These functions are to be determined by the methods in [0007] or [0008]. These functions are called non-isaacs function variables.

The Value Function as One Player Payoff

In the case examined so far, the Isaacs payoff in [0001] is considered to be a sum of one player payoffs. In case this is not happening and the Isaacs payoff does not contain a terminal part, each player can use as one player payoff in a particular e-game the value function of the differential game in the e-game. Obviously the value function depends in the time a game begins or ends thus depends on c-times. In case of [0001] the one player payoff defined by the value is different from the one player payoff defined as in [0001].

The Terminal Part of Isaacs Payoff 1

Consider the general case where the Isaacs payoff of a differential game in an e-game a contains a terminal part

P=∫[G]dt+H.

Assume this Isaacs payoff can be considered as a sum of one player payoffs

P=SUM∫[G(i)]dt+SUM H(i).

The one player payoff P(i) in the e-game a can be chosen to be

P(i)=∫[G(i)]dt+H(i)

in case the domain where the c-times take values contains the time the differential game in e-game a ends. If this point is not in the domain, thus the differential game will be certainly interrupted, then it is reasonable to choose as one player payoff only the part

P(i)=∫[G(i)]dt

The terminal payoff is always included if the e-game is the last e-game in a realization.

The Terminal Part of Isaacs Payoff 2

Consider the general case where the Isaacs payoff of a differential game in an e-game a contains a terminal part

P=∫[G]dt+H.

Assume a player chooses his one player payoff to be the value of the differential game.

In the calculation of the value the terminal part will be included if the e-game is the last e-game in a realization or if the domain of c-times contains the time the differential game in e-game, a ends. In the other cases the player should omit the terminal part.

Some More General Payoffs

The choice of the payoffs so far was made in a way to stay as close as possible to Isaacs games. But one can choose an arbitrary function P(i,s,t) as one players payoff, for player i, instead of the one chosen in [0005].

A less general choice of payoff is

P(i,t,s)=step(s−t)P(i,A(1),t)+step(t−s)P(i,A(2),s),

where P(i, A(1),t) and P(i, A(2),s) are arbitrary functions and not those given in [0005]. These less general payoffs have the property that the payoff P(i, t, s) depends on t and s as

P(i,t,s)=f(min(t,s)).

Thus one can define another class of payoffs that are the composition of an arbitrary function f and the function min(t,s).

An Example of the Domains DCT(A(j)) that Correspond to Realizations A(j)

In the case of arbitrary payoffs in [0016] one accepts that only one realization will be played also. This condition allows us to introduce subsets of the domain of c-times t and s, in the notation of [0005]. This domain in the cases examined so far is the square defined by the cartesian product of intervals that begin at t0(a(1,0)) and end at t1(a(1,0)), in the notation of [0006]. If player 2 chooses first to make a c-change then t is smaller than s. Similarly if 3 chooses first then s is smaller than t. Thus the subdomain of points (s, t), in the square, that satisfy “t is strict smaller than s” corresponds to realization A(1) and the points that satisfy “s is strict smaller than t” correspond to realization A(2). The union of these subdomains differs from the square by the points (t,s) that satisfy t=s, thus are on the diagonal. This diagonal set is a Lebesque measure zero subset of the square.

The Diagonal Points in the Domain of C-Times

If the solution point given by [0007] or [0008] is away from the diagonal then the solution is well defined. The case where the optimal values obtained by [0007] or [0008] are on the diagonal is not accepted as solution of the C1-game. The same applies in case the solution is given by game empirical or Nash empirical method in. [0009]. Similarly, in case of mixed solutions the volume of the diagonal with respect to the product measure must be zero in order these mixed solutions are accepted as solutions of the C1-game. In that case the probability that players choose to make the c-change simultaneously is zero.

The Case of Discrete C-Times

In case the payoffs depend on c-time variables t and s that take discrete values, the games introduced in [0007], [0008] and [0009] are matrix games.

Assume we use the payoffs in [0005] and t and s take values t1=s1, t2=s2, t3=s3, t4=s4 and t5=s5. The game in [0007] with payoff P(t, s)=P(2, t, s)−P(3, t, s) becomes a matrix game of the form

| | s1 | s2 | s3 | s4 | s5 |
|---|---|---|---|---|---|
| t1 | 0 | p1 | p1 | p1 | p1 |
| t2 | q1 | 0 | p2 | p2 | p2 |
| t3 | q1 | q2 | 0 | p3 | p3 |
| t4 | q1 | q2 | q3 | 0 | p4 |
| t5 | q1 | q2 | q3 | q4 | 0 |

where p1 denotes the value of P(t, s) if player 2 chooses t1 and player 3 chooses any s larger than s1=t1, p2 denotes the value of P(t, s) if player 2 chooses t2 and player 3 chooses any s larger than s2=t2, and so on, and where q1 denotes the value of P(t, s) if player 3 chooses s1 and player 2 chooses any t larger than t1=s1, and so on.

One can easily write the matrices in case of Nash type solutions in [0008] and in games in [0009]. Similarly one can introduce matrices for other type of payoffs. One can generalise easily to discrete games in cases where the payoffs depend on more than two variables and the variables take discrete values.

One problem with these discrete formulations is that the c-times on the diagonal, where c-times are equal, are not accepted as solutions. The obvious reason, in the example of two players, is that players 2 and 3 can not simultaneously join player 1 and play against no one.

A way to overcome this difficulty is to introduce more discrete values and hope that the mixed solutions are such that the measure on the diagonal decreases and in the limit becomes zero. This decrease of probability was observed in numerical simulations when the number of discrete points increased.

Another way is to introduce discrete values that satisfy

t1<s1<t2<s2<t3<s3< . . . <tn<sn

and similarly

s1<t1<s2<t2<s3<t3< . . . <sn<tn

Denote the optimal strategies in first case by SOLT(n, t<s) and SOLS(n, t<s), as functions of the number of discrete values n, and in the second by SOLT(n, s<t) and SOLS(2, s<t). If the expressions

(SOLT(n,t<s)−SOLT(n,s<t))

and

(SOLS(n,t<s)−SOLS(n,s<t))

tend to zero in some sense as the number n of point increases, then we can define the limits of SOLT(n, t<s) and SOLS(n, s<t)) to be a solution of that C1-game. In that case also one must be make certain that the volume of the diagonal with respect to the optimal measures tends to zero.

This approach can be generalized in case of a c-game where the c-time variables are controlled by two players and both players control the same number of c-times, or two groups of players that all players in each group act as one. One has in that case to formulate inequalities of the discrete values for each pair of variables, where the first is controlled by player one and the second by player two. It is assumed that one can define these pairs of c-times. This can be done easily if the c-times in the pair belong to the same C1-subgame and there are no other c-times in the C1-subgame. The notion of a C1-subgame will be defined later.

The arguments in this paragraph are more of a heuristic nature and are not backed by mathematical theorems.

A Min Max Theorem for C1-Games

In the cases examined so far, with payoffs that depend on two variables t and s, one can use a theorem in “Some Topics in Two Person Games” by T. Parthasarathy and T. E. S. Raghavan, to prove the min max theorem. This theorem, in page 125 theorem 5.4.1, has also the advantage that uses absolutely continuous measures for one player, thus the volume of the diagonal is zero.

The Case of Many Players and Many E-Coalition Changes, the C-Game and the Recursive Solution

One can easily generalize the above given concepts in cases of many players and games where more than one e-coalition change are allowed to happen. These definitions are given in the following paragraphs where the exact mathematical formulation of the general theory of c-games is presented. Two new concepts needed to be introduced are the recursive solution and the cooperative solution.

In case of many players and many e-coalition changes the generalization of the differential game is called a c-game.

One can define the e-games exactly as in case of [0001].

A C1-game with many players will have more realizations.

In case more than one e-coalition changes are allowed the realizations will contain more than two e-games.

Given a c-game, one can introduce a tree structure by attaching C1-games in some leaves of an initial-C1-game and the new leaves are called e-games of order 2. Similarly one can attach C1-games to some leaves of order two and call the new leaves e-games of order 3. And so on.

One can define realizations in this case also, as sequences of e-games.

Given the tree of an arbitrary c-game one may try to solve the c-game by solving the C1-games it contains, where in this case are called C1-subgames. This method and its generalizations are called in general mixed recursive solutions of the c-game.

The concept of c-coalition in the general case of c-games is more important than in the case [0013]. A particular c-coalition defines a subset of the set of players who choose control variables in a way that the c-coalition gains, irrespectively of how each player might behave in each differential game, where he can form e-coalitions, the N1 or N2 e-coalitions introduced in [0001], with players of another c-coalition. The solution concepts introduced above are formulated for c-coalitions and not individual players. Of course an individual player can be considered as a c-coalition that contains only this player.

Finally the cooperative solutions are not essential to formulation of the theory of c-games. One can use c-games, and their solutions, to define characteristic functions on a set of players and use these characteristic functions to define the usual notions of cooperative solutions (stable sets, core etc).

Some More General Theorems

One can generalize the theorem mentioned in [0020] in the case of C1-games where more than two players can choose c-times. This generalization depends on the same assumptions used in the theorem in Parthasarathy-Raghavan, but it is more difficult these conditions to be fulfilled in the general case.

By studying these assumptions one can proceed a step further and prove the existence of Nash equilibrium for a C1-game with many players. This can be used to prove the existence of Nash equilibrium for an arbitrary c-game. These theorems have the disadvantage that one uses the Hahn-Banach theorem to prove the existence of tensor products of measures.

Since the generalizations mentioned in this paragraph were made by the author recently, the validity of the arguments in this paragraph depends on whether the proofs of these theorems are correct.

The Differential Game

A differential game as formulated by Isaacs and others, contains the following:

a set X(t)={X1(t), . . . , Xn(t)} of functions that depend on the time variable t, said functions are called usually state variables,

two sets

Φ(t)={φ1(t), . . . ,φp(t)}

and

Ψ(t)={ψ1(t), . . . ,ψq(t)}

of functions called sets of control function variables,

a set of differential equations

dXi(t)/dt=fi(X(t),Φ(t),Ψ(t),t),i=1,2, . . . ,n,

a payoff function

P(Φ(t),Ψ(t))=∫(G(X(t),Φ(t),Ψ(t)))dt+H

called the Isaac's payoff, a method used to obtain values for the control function variables called Isaacs solution concept and is written in the usual symbolic language of game theory as

$${max}_{Ψ ( t )} {min}_{Φ ( t )} P ( Φ ( t ) , Ψ ( t ) ) ,$$

and the value function defined by

$$V = {max}_{Ψ ( t )} {min}_{Φ ( t )} P ( Φ ( t ) , Ψ ( t ) ) .$$

The E-Game

An e-game contains:

a differential game as in [0023],

a set N1 different from the vacuum set called set of maximizers in the e-game, and

a set N2 different from the vacuum set called set of minimizers in the e-game, where furthermore N1 and N2 have no elements in common.

The sets N1 and N2 are called elementary coalitions or e-coalitions. When an e-game is denoted by a the e-coalitions in the e-game are denoted by N1(a) and N2(a). Players in sets N1 and N2 are supposed to control the function variables in the differential game.

It is useful to introduce two sets, the NIN(a) and ADN(a) called sets of players that controls non-isaacs variables and additional variables respectively. These are subsets of the union N1(a) U N2(a).

The E-Coalition Change

An e-coalition change is defined to be the set

{{N1(a),N2(a)},{N1(b),N2(b)}}

where a, b are e-games as in [0024] and N1(a), N2(a), N1(b) and N2(b) are the e-coalitions also defined in [0024], and where furthermore:
there exists a set A1(a) which is a subset of N1(a),
there exists a set A2(a) which is a subset of N1(a) that has no element in common with A1(a),
there exists a set B1(a) which is a subset of N2(a),
there exists a set B2(a) which is a subset of N2(a) that has no element in common with B1(a),
there exists a subset D1(b) of N, where N is a set of players, that has no element in common with the set N1(a) U N2(a),
there exists a subset D2(b) of N that has no element in common with the set N1(a) U N2(a) and furthermore has no element in common with D1(a),
the set N1(b) is equal to the set

N1(a)(A1(a)UA2(a)))UB2(a)UD1(a), and
the set N2(b) is equal to the set

N2(a)(B1(a)UB2(a)))UA2(a)UD2(a).

The interpretation of the above relations is as follows

A(1) is the subset of players in N1(a) that decide to leave e-game a and not play e-game b,

A(2) is the subset of players in N1(a) that decide to leave e-game a and join players in N2(a) and play e-game b, and similarly for B(1) and B(2) in N2(a),

D(1) is the set of players that don't play in e-game a that decide to join players in N1(a) and play e-game b, and similarly for D(2).

The above relations do not exclude the case

N1(a)=N1(b) and N2(a)=N2(b)

and the reason for this is that the theory of c-games can include cases where e-game b can be played by the same e-coalitions in e-game a but the e-game is different, for example in case e-game a contains the game in [0001] and the e-game b contains the game in [0001] where c(1) becomes c′(1), this new c′(1) can be an additional variable, defined below, needed to be determined or a fixed new constant.

In case one wants to consider only cases where players actually change the e-coalitions, the following condition must be included in the definition of e-coalition change:
at least one of N1(a)=N1(b) and N2(a)=N2(b) is not true.

The C-Change

A c-change, denoted by ((a, b)), is defined to be an ordered pair of e-games a,b that satisfy the following conditions:

the differential game in the e-game a is interrupted at time t(a,b) called c-time of the c-change ((a,b)),

the differential game in the e-game b begins at time t(a,b), and

the set {{N1(a), N2(a)}, {N1(b), N2(b)}} is an e-coalition change, defined in [0025].

The Algebraic C-Game

An algebraic c-game contains e-games, a tree structure and elements called realizations.

The Tree Structure

The ordered tree structure in [0027] can be defined as follows:

There exists an ordered tree where each vertex is an e-game in the algebraic c-game, each e-game in the algebraic c-game is a vertex in the tree and the edges are c-changes defined in [0026].

The ordered tree structure can be constructed as follows:
a) there exist a set V(0) that consists of one element v(0), a set VR(0) that consists of one element vr(0) identical to v(0), a set VL(0) equal to the vacuum set, an e-game a(0) in the algebraic c-game called e-game of order zero and also called root of the c-game, said e-game is written also as a(v(0),0) and as a(vr(0),0), and there exists an ordinal MAXN such that all e-games in the c-game are called e-games of order n where n is an ordinal smaller or equal to MAXN, said ordinal MAXN depends on the c-game,
b) there exists a non vacuum set V(1)=V(1,vr(0)), a partition of V(1) into subsets VL(1)=VL(1,vr(0)) and VR(1)=VR(1,vr(0)) where VR(1,vr(0)) is different from the vacuum set if MAXN is different from 1 and VR(1,vr(0)) is the vacuum set if MAXN is equal to 1, and a set

EGO(1)={a(v(1),1):v(1)) in V(1))}
called set of all e-games of order 1, where v(1) takes all values in V(1), where for each v(1) there exists an e-game a(v(1),1) in the algebraic c-game called e-game of order 1, where if v(1) belongs in VR(1) the e-games a(v(1),1) are called roots of subgames and if v(1) belongs in VL(1)) the e-games a(v(1),1) are called leaves, and where the set of all edges in the tree that contain a(0) is

{((a(0),a(v(1),1))):v(1) in V(1))}
where v(1) takes all values in V(1), said set of edges is called C1(a(0))-subgame and a(0) is called root of the C1(a(0))-subgame.
c) assuming the subtree that contains all e-games of order smaller or equal an ordinal n is given and the sets VL(n′), VR(n′), V(n′) and EGO(n′) are defined for all n′ in {0, 1, . . . , n} and VR(n′) is different from the vacuum set for all n′ in {0, 1, . . . , n}, we obtain the subtree that contains all e-games of order smaller or equal n+1 by the following steps:
   c.1) let the set of all e-games of order n be

EGO(n)={a(v(n),n):v(n) in V(n)}
where v(n) takes all values in the set V(n),
c.2) for each vr(n) in VR(n) there exists a set V(n+1,vr(n)), a partition of V(n+1,vr(n)) into subsets VR(n+1,vr(n)) and VL(n+1,vr(n)), and a set

EGO(n+1,vr(n))=={a(v(n+1,vr(n)),n+1):v(n+1,vr(n)) in V(n+1,vr(n))},
where each EGO(n+1,vr(n)) consists of e-games a(v(n+1,vr(n)), n+1) in the algebraic c-game, said e-games are called e-games of order n+1, where v(n+1,vr(n)) takes all values in V(n+1,vr(n)), and where the set of all edges that contain as first element the e-game a(vr(n),n) is

{((a(vr(n),n),a(v(n+1,vr(n)),n+11))): v(n+1,vr(n)) in V(n+1,vr(n))}
where v(n+1,vr(n)) takes all values in V(n+1,vr(n)), said set of edges is called C1(a(vr(n),n)-subgame and a(vr(n),n) is called root of the C1(a(vr(n),n))-subgame, and
c.3) the set V(n+1) is defined to be the union V(n+1)=U V(n+1,vr(n)), the set VR(n+1) is defined to be the union VR(n+1)=U VR(n+1,vr(n)), the set VL(n+1) is defined to be the union VL(n+1)=U VL(n+1,vr(n)), and the set of all e-games a(v(n+1),n+1) of order n+1

EGO(n+1)={a(v(n+1),n+1):v(n+1) in V(n+1)}
is defined to be the union U EGO(n+1,vr(n)), where all unions are over all vr(n) in VR(n), where v(n+1) takes all values in V(n+1), where if n+1 is smaller than MAXN then VR(n+1) is different from the vacuum set and if n+1 is equal to MAXN then VR(n+1) is the vacuum set, where if v(n+1) belongs in VR(n+1) the e-games a(v(n+1),n+1) are called roots of subgames and if v(n+1) belongs in VL(n+1) the e-games a(v(n+1),n+1) are called leaves, and
d) step (c) is repeated until n+1 equals MAXN.

The Realizations

The realizations in [0027] are ordered sequences of e-games

A(j)=(a(j,0),a(j,1), . . . )

that satisfy:
a(j,0) is an e-game of order 0, a(j,1) is an e-game of order 1 etc, and
for each pair a(j,k) and a(j,k+1) in the realization the c-change ((a(j,k), a(j,k+1))) exists in the tree of the c-game.

One can write an algebraic c-game as the set of all its realizations

{A(j):j in J}

where the set J can be chosen to be the interval of ordinals {1, 2, . . . , MAXJ−1, MAXJ} where MAXJ is an ordinal.

Construction and Numbering of Realizations

The realizations in [0027] can be constructed from the tree structure in [0028] and numbered by:
a) sequences (a(0), a(v(1),1)), where v(1) belongs in VL(1), are realizations called realizations of length 2 and the set of all realizations of length 2 is defined by

REAL(1)={(a(0),a(v(1),1))v(1) in VL(1)},
where v(1) takes all values in VL(1), where a(0) is the root of the c-game, and where a(v(1),1) belongs on EGO(1),
b) assuming realizations of length n′+1 and the sets REAL(n′) are defined for all n′ in {1, 2, . . . , n} where n is an ordinal smaller than MAXN, each realization of length n+2 is defined to be a sequence

a(0),a(v(1),1), . . . ,a(v(n+1),n+1)),
where if n′ belongs in {2, . . . , n} then v(n′) belongs in VR(n′, v(n′−1)), where v(1) belongs in VR(1), where v(n+1) belongs in VL(n+1), where a(0) is the root of the c-game, and where if n′ belongs in {1, . . . , n+1 }then a(v(n′),n′) belongs in EGO(n′),
   and the set REAL(n+1) of all realizations of length n+2 is defined to be the set of all realizations

(a(0),a(v(1),1), . . . ,a(v(n+1),n+1)),
where if n′ belongs in {2, . . . , n}then v(n′) takes all values in VR(n′, v(n′−1)), where v(1) takes all values in VR(1), and where v(n+1) takes all values in VL(n+1),
c) step (b) is repeated until realizations of length MAXN+1 and the set REAL(MAXN) are constructed,
d) each realization in REAL(1) is assigned an ordinal by the following steps:
   d.1) choose a realization (a(0), a(v′(1),1)) in REAL(1), denote it by A(1) and write it in the form

A(1)=(a(1,0),a(1,1))
where a(1,0)=a(0) and a(1,1)=a(v′(1),1),
d.2) assuming realizations A(n) are numbered where n takes all values in an interval of ordinals {1, 2, . . . , j} where j is an ordinal, choose a realization a(0), a(v′ (1),1)) in REAL(1)\{A(1), A(2), . . . , A(j)}, denote it by A(j+1) and write it in the form

A(j+1)=(a(j+1,0),a(j+1,1)
where a(j+1,0)=a(0) and a(j+1,1)=a(v′ (1),1), and
d.3) step (d.2) is repeated until all elements in REAL(1) are numbered,
e) assuming all realizations in REAL(n′) are numbered and are written as

A(j)=(a(j,0),a(j,1), . . . ,a(j,n′),
where n′ takes all values in {1, 2, . . . , n} and j takes all values in an interval of ordinals {1, 2, . . . , ORD} where ORD is an ordinal, realizations in REAL(n+1) can be assigned an ordinal by the following steps:
e.1) choose a realization

a(0),a(v′(1),1), . . . ,a(v′(n+1),n+1)
in REAL(n+1), denote it by A(j′) and write it in the form

A(j′)=(a(j′,0),a(j′,1), . . . ,a(j′,n+1),
where j′=ORD+1, where a(j′,0)=a(0), and where if n′ belongs in {1, 2, . . . , n+1 }then a(j′,n′)=a(v′(n′),n′),
e.2) assuming realizations A(n′) that belong in REAL(n+1) are numbered where n′ takes all values in an interval of ordinals {ORD+1, ORD+2, . . . , j−1, j} where j is an ordinal, choose a realization

a(0),a(v″(1),1), . . . ,a(v″(n+1),n+1)
in REAL(k+1)\{A(1), A(2), . . . , A(j)}, denote it by A(j+1) and write it in the form

A(j+1)=(a(j+1,0),a(j+1,1), . . . ,a(j+1,n+1),
where a(j+1,0)=a(0), and where if n′ belongs in {1, 2, . . . , n+1 }then a(j+1,n′)=a(v′(n″),n′), and
e.3) step (e.2) is repeated until all elements in REAL(n+1) are numbered,
f) (e) is repeated until all realizations in REAL(MAXN) are numbered and written in the form

A(j)=(a(j,0),a(j,1), . . . ,a(j,MAXN)
The c-game is said to be in tree form if its realizations are written in the form

a(0),a(v(1),1), . . . ,a(v(n),n), . . . ,a(v(nmax),nmax)).
where if n′ belongs in {2, . . . , n}then v(n′) takes all values in VR(n′, v(n′−1)), v(1) takes all values in VR(1), and where v(nmax) takes all values in VL(nmax), where nmax is the ordinal that all e-games in the realization have order smaller or equal to nmax.

The Domain of C-Times

Assume the game is given in realization form as

{A(j):j in J}

The domain DCT in which the c-times take values is constructed by the following:
given any realisation

A(j)=(a(j,0),a(j,1), . . . ,a(j,n),a(j,n+1), . . . )

the c-time variables are restricted by the inequalities

t(a(j,n),a(j,n+1))<t(a(j,n+1),a(j,n+2))

for all n such that a(j,n), a(j,n+1)) and a(j,n+2) belong in A(j) and all j in J, and the inequalities

t0(a(j,n))<t(a(j,n),a(j,n+1))<t1(a(j,n))

for all n such that a(j,n) and a(j,n+1)) belong in A(j) and all j in J, where t0(a(j,n)) is the time the differential game in e-game a(j,n) begins, and this time is a c-time if n is larger than 0, and t1(a(j,n)) is the time the differential game in e-game a(j,n) ends if it is not interrupted.

One can consider also domains where some of the strict inequalities above are replaced by smaller or equal. This depends on the exact mathematical formulation of the solution method and whether one is willing to accept that pot all c-games in a realization will be played. For example

t0(a(j,n)) smaller or equal t(a(j,n),a(j,n+1))

means that the players are allowed not to play the differential game in e-game a(j,n). Similarly

t(a(j,n),a(j,n+1)) smaller or equal t1(a(j,n))

means that the players can choose to play the differential game in e-game a(j,n) until it ends, and in that case we accept that the c-game also ends and non of the e-games of order larger than n will be played.

A similar interpretation is given in

t(a(j,n),a(j,n+1)) smaller or equal t(a(j,n+1),a(j,n+2))

where players can skip e-game a(j,n+1).

In case we want the differential games in all e-games in a realization to be played, we must choose strict inequalities, and in that case c-times take values in open intervals.

The Subdomains of C-Times that Correspond to Realizations.

In the theory of c-games one must obviously accept that only one realization will be played, since in every C1-subgame the realization of the C1-subgame will be played that corresponds to the c-time in the C1-subgame that takes the smaller value.

One can define subsets DCT(j), of the domain DCT of all c-times in a c-game, that when the c-times take values in the domain DCT(j) realization A(j) will be played. These domains are into one to one correspondence with the realizations.

The domain DCT(j) that corresponds to realization A(j) is constructed by the following inequalities:

t(a(j,n),a(j,n+1))<t(a(j,n+1),a(j,n+2))
for all n such that a(j,n), a(j,n+1)) and a(j,n+2) belong in A(j),

t0(a(j,n))<t(a(j,n),a(j,n+1))<t1(a(j,n))
for all n such that a(j,n) and a(j,n+1)) belong in A(j), and

t(a(j,n),a(j,n+1))<t(a(j,n),a(x(j,n)))
for all n such that a(j,n) and a(j,n+1) belong in A(j) and all x(j,n) in a set X(j,n) where a(x(j,n)) is the second e-game in a realization

A(x(n,j))=(a(j,n),a(x(j,n))
of the C1-subgame with root the e-game a(j,n)) and the index x(j,n) numbers all realizations A(x(n,j)) of this C1-subgame except realization

a(j,n),a(j,n+1)).

One must use strict inequalities, otherwise if two different c-time variables take equal values two c-changes will happen simultaneously and that is not accepted.

It is obvious that the union of the domains DCT(j) is not the domain DCT. The complement of the union of DCT(j) in DCT is called diagonal set. Obviously the Lebesque measure of the diagonal set is zero. On this set there are always c-times in a particular C1-subgame that take equal values. These points can not be excluded from the definition of DCT thus one must accept solutions such that the optimal values of the c-time variables are not on the diagonal. If the solutions are given as probability distributions on the c-time variables one accepts solutions such that the volume of the diagonal set with respect to the optimal measures is zero, thus the probability that two c-time variables take the same value is zero.

The C-Coalitions

Given a set of players N a set of c-coalitions is defined to be a partition of N into non vacuum subsets. Each subset M that belongs in this partition is called a c-coalition.

The Variables in a C-Game

The set of variables in the c-game, denoted VAR, contains:
a) all elements of the set CT of all c-times where CT is defined by

CT=U{t(a,b)}
where t(a,b) is the c-time of c-change ((a,b)) and the union is over all c-changes in the tree in the algebraic c-game,
b) all elements of the set ADVAR of all additional variables where ADVAR is defined by

ADVAR=UADVAR(a)
where ADVAR(a) is defined to be the set of additional variables of the e-game a and the union is over all e-games in the algebraic c-game, and
c) all elements of a set NIVAR called set of all non-Isaacs function variables, where NIVAR is defined by

NIVAR=UNIVAR(a)
where the union is over all e-games in the algebraic c-game and NIVAR(a) is a set called set of all non-Isaacs function variables of the e-game a, said set is defined to be a subset of the set of all control function variables

{φ1(t), . . . ,φp(t),ψ1(t), . . . ,ψq(t)}
of the differential game in e-game a.

Since additional variables and non-isaacs variables are controlled by players we define the following sets:
ADN(a) is the subset of N1(a) U N2(a) of players that control the variables in ADVAR(a), and
NIN(a) is the subset of N1(a) U N2(a) of players that control the variables in NIVAR(a).

This definition of variables in a c-game includes not only the c-times but cases where players change for example the constants in the game in [0001] and cases where not all control functions in [0001] are determined by the Isaacs solution. These variables are to be determined when the c-game will be solved.

The control function variables that are not non-isaacs function variables are called Isaacs variables and they are determined as follows: each differential game is solved by the Isaacs solution concept and all controls are assigned optimal values (these values in general depend on parameters). Then the Isaacs function variables become known functions and the non-Isaacs function variables are treated as unknown variables again, to be determined (assigned an optimal value) by the c-game solution.

The Variables Controlled by a C-Coalition

There exists a family of subsets of VAR defined by the following:
for each c-coalition M in the set of c-coalitions in the c-game, there exists one and only one subset VARS(M) of VAR, said subset VARS(M) is called set of variables controlled by the c-coalition M, and VAR=U VARS(M) where the union is over all c-coalitions M in the set of c-coalitions in the c-game.

Each VARS(M) consists of:
a) all elements of the subset CT(M) of the set CT of all c-times, called set of c-times controlled by c-coalition M, that consists of c-times t(a,b) that satisfy the following: the set

$$\begin{matrix}A 1 ( a ) & U A 2 ( a ) & UB 1 ( a ) & U B 2 ( a ) & UD 1 ( b ) & UD 2 ( b ) \\ & UADN ( b ) & UNIN ( b ) & & & \end{matrix}$$

has at least one element in common with M, where the sets A1(a), A2(a), B1(a), B2(a), D1(b) and D2(b) are defined in [0025] and the sets ADN(b) and NIN(b) in [0034],
b) all elements of the subset ADVAR(M) of the set ADVAR of all additional variables, called the set of additional variables controlled by c-coalition M, that consists of additional variables z that satisfy the following:
   if z belongs in ADVAR(M) then there exists an e-game a in the algebraic c-game and a subset ADVAR(M,a) of the set ADVAR(a) such that z belongs in ADVAR(M,a), said ADVAR(M,a) is called set of additional variables in e-game a controlled by c-coalition M, and
   the set ADN(a) has at least one element in common with M, and
c) all elements of the subset NIVAR(M) of the set NIVAR of non-isaacs function variables, called the set of non-isaacs function variables controlled by c-coalition M, that consists of non-isaacs function variables f that satisfy the following:
   if f belongs in NIVAR(M) then there exists an e-game a in the algebraic c-game and a subset NIVAR(M,a) of the set NIVAR(a) of non-isaacs function variables in e-game a such that f belongs in NIVAR(M,a), said NIVAR(M,a) is called set of non-isaacs function variables in e-game a controlled by c-coalition M, and
   the set NIN(a) has at least one element in common with M.

This definition of the set of c-times CT(M) includes the case when the e-coalitions in e-games a and b are the same but a player at time t(a,b); the c-time, decides to introduce the additional variable, or decides to choose a function variable he controls to have different value than the one obtained from the Isaacs solution, thus in that case one can say player chooses from time t(a,b) to play in a non Isaacs way.

The Payoff of a C-Coalition in a C-Game

We assume there exists a set of functions defined by the following:
for each c-coalition M in the set of c-coalitions in the c-game, there exists one and only one function P(M), called payoff of the c-coalition M in the c-game, that depends on all variables in a subset of VAR.

Cases of Payoffs

A particular type of payoffs that is useful in c-games is defined by the following:

given a c-game in realization form

{A(j):j in J}

A(j)=(a(j,0),a(j,1), . . . ,a(j,k), . . . }

define P(M) by

P(M)=SUM SIG(j)P(M,A(j)

where the sum is over all realizations (all j in J), where SIG(j), also denoted by SIG(A(j)), are functions, each SIG(j) is called sigma function of realization A(j) and has the property that SIG(j) equals zero if realization A(j′) is played where j′ is different from j, and where P(M, A(j)) is a function that depends on variables in VAR and called payoff of c-coalition M in realization A(j).

One can introduce a subcase where the P(M, A(j)) are given by

P(M,A(j))=SUM P(M,a(j,k)

where the sum is over all e-games in realization A(j) and where P(M, a(j,k)) is a function that depends on variables in VAR and is called payoff of c-coalition M in e-game a(j,k)).

A possible definition of sigma function is:
SIG(j) is the characteristic function of the domain-DCT(j) that corresponds to realization A(j).
   These particular sigma functions can be easily written as product of step functions whose arguments are c-times.

A subcase of the payoffs in [0037] is the case where

P(M,a(j,k))=SUM P(m,a(j,k))

where m is a player in M, P(m, a(j,k)) is the payoff of player m in e-game a(j,k), called one player payoff in an e-game, and the sum is over all players m that belong in M.

Another subcase of [0037] is given by

P(M,a(j,k))=SUM E(m,a(j,k))P(m, a(j,k))

where E(m, a(j,k)) is a function that equals 1 if player m belongs in the maximizers in a(j,k), equals −1 if m belongs in the minimizers and equals zero if does not take part in a(j,k).

A subcase of [0039] is when P(m, a(j,k)) is defined to be the value function of the differential game. Whether the value function will contain terminal parts of the Isaacs payoff or not, depends on the definition of the domains of c-times in [0031]. In cases where the c-time t(a(j,k), a(j,k+1)) can take the value t1(a(j,k)), the terminal part of the isaacs payoff has to be included in the definition of one players payoff.

Another subcase of the payoffs in [0039] is the case where the Isaacs payoff can be written as the sum of one player payoffs P(m, a(j,k)), as in case [0001]. If the Isaacs payoff has a terminal part and this part can be written as a sum of terms that can be interpreted as part of the one players payoff, whether these terminal parts will be included in the one players payoff or not, depends on the domain of c-times as in [0040].

A general class of payoffs that are useful in the theory of c-games are those who depend on c-times as follows:
a) let a c-game and {C1(a): a is not a leaf} the set of all its C1-subgames C1(a), where each C1-subgames is given by

C1(a)={(a,b(j(a))):j(a) in J(a)}
b) denote by t(j(a)) the c-time t(a, b(j(a))) denote the set of all c-times of the C1(a)-subgame by

T(a)={t(j(a)):j(a) in J(a)}
and denote the set of all c-times in the c-game by U T(a) where the union is over all e-games a in the c-game that are not leaves,
c) assume that if P(M) depends on a c-time in T(a) then it depends on all c-times in T(a), and
d) the payoff P(M) depends on c-times in U T(a) as a function of the following kind

P(M)=P(M,g(a1),g(a2), . . . )

where

g(ai)=min(t(j(ai)):j(ai) in J(ai)
where the ai are e-games in the c-game that are not leaves and g(ai) are functions that depend on all c-times in T(ai) and their value depends on the minimum value of the c-times. Thus assuming the c-time t′ takes the minimum value val(t′), the value of the function g(ai) is constant for any value val(t″) larger than val(t′) of any c-time t″ in T(ai) different from t′.

The C-Game

A c-game is defined to be a set that contains a set N of players that take part in the c-game, an algebraic c-game defined in [0027], a set of c-coalitions M on N defined in [0033], a set VAR of variables defined in [0034], the sets VAR(M) of variables controlled by c-coalitions M defined in [0035], the payoffs P(M) of c-coalitions defined in [0036] and an axiom.

The Axiom in the Theory of C-Games

The axiom in [0043] states that in any c-game, written in realization form as

{A(j):j in J}

only differential games in the e-games a(j,n) that belong in one and only one realization

A(j)=(a(j,0),a(j,1), . . . ,a(j,n), . . . ,a(j,n(j)))

will be played and in that case we say the realization A(j) is played or players have chosen to play realization A(j), where a(j,n(j)) is the e-game in A(j) that has order n(j) larger than the order of any other e-game in A(j), where j is an element in a set J, where J can be chosen to be an interval of ordinals {1, 2, . . . , MAXJ}, and where furthermore
a) if the domain of c-times is given by strict inequalities then:
   a1) the differential game in the root a(j,0) will be played first from time t0(a(j,0)) until the c-time t(a(j,0), a(j,1)), where t0(a(j,0)) is the time the differential game in e-game a(j,0) begins,
   a2) assuming n is smaller than n(j)−1 and assuming the differential game in e-game a(j,n) is played, at time t(a(j,n), a(j,n+1)) a c-change will happen and the differential game in e-game a(j,n+1) will be played from time t(a(j,n), a(j,n+1)) until time t(a(j,n+1), a(j,n+2)), and
   a3) assuming n is equal to n(j)−1 and assuming the differential game in e-game a(j,n(j)−1) is played, at time t(a(j,n(j)−1), a(j,n(j))) a c-change will happen and the differential game in e-game a(j,n(j)) will be played from time t(a(j,n(j)−1), a(j,n(j))) until time t1(a(j,n(j))), where t1(a(j,n(j))) is the time the differential game in e-game a(j,n(j)) and the c-game end, and
b) if the domain of c-times contains equalities then:
   b1) if t(a(j,0), a(j,1)) is larger than t0(a(j,0)) then
      if t(a(j,0), a(j,1)) is smaller than t1(a(j,0)) then the differential game in the root a(j,0) will be played first from time t0(a(j,0)) until the c-time t(a(j,0), a(j,1)), where t0(a(j,0)) is the time the differential game in e-game a(j,0) begins, and
      if t(a(j,0), a(j,1)) is equal to t1(a(j,0)) then the differential game in e-game a(j,0) and the c-game end at t1(a(j,0)), where t1(a(j,0)) is the time the differential game in e-game a(j,0) ends,
   b2) if t(a(j,0), a(j,1)) is equal to t0(a(j,0)) then the differential game in the root a(j,0) will not be played,
   b3) if t(a(j,n), a(j,n+1)) is different from t(a(j,n+1), a(j,n+2)) for some n smaller than n(j)−1 then
      the differential game in e-game a(j,n+1) will be played,
   b4) assuming n is smaller than n(j)−1 and assuming the differential game in e-game a(j,n) is played, then
      if t(a(j,n), a(j,n+1)) is equal to t1(a(j,n)) then the differential game in e-game a(j,n) and the c-game end at t1(a(j,n)), where t1(a(j,n)) is the time the differential game in e-game a(j,n) ends, and
      if t(a(j,n), a(j,n+1)) is smaller t1(a(j,n)) then at time t(a(j,n), a(j,n+1)) a c-change will happen and
         if t(a(j,n), a(j,n+1)) is different from t(a(j,n+1), a(j,n+2)) then the differential game in e-game a(j,n+1) will be played from time t(a(j,n), a(j,n+1)) until time t(a(j,n+1), a(j,n+2)), and
         if t(a(j,n), a(j,n+1))=t(a(j,n+1), a(j,n+2)) then the differential game in e-game a(j,n+1) will not be played,
   b5) assuming n is equal to n(j)−1 and assuming the differential game in e-game a(j,n(j)-1) is played,
      if t(a(j,n(j)−1), a(j,n(j))) is equal to t1(a(j,n(j)−1)) then
         the differential game in e-game a(j,n(j)−1) and the c-game end at t1(a(j,n(j)−1)), where t1(a(j,n(j)−1)) is the time the differential game in e-game a(j,n(j)−1) ends, and
      if t(a(j,n(j)−1), a(j,n(j))) is smaller t1(a(j,n(j)−1)) then
         at time t(a(j,n(j)−1), a(j,n(j))) a c-change will happen and the differential game in e-game a(j,n(j)) will be played from time t(a(j,n(j)−1), a(j,n(j))) until time t1(a(j,n(j))), where t1(a(j,n(j))) is the time the differential game in e-game a(j,n(j)) and the c-game end.

The Solution Concepts

The solution concepts of a c-game contain: the simple solutions, the game type solutions, the Nash type solutions, the lower empirical solutions, the upper empirical solutions, the empirical game type solutions, the empirical Nash type solutions, the mixed recursive solutions and their subcases of pure recursive solutions, and the cooperative solutions.

The Mixed Recursive Solution

In the mixed recursive solution, written MRS, a problem associated with a c-game is solved by introducing and solving problems that can be considered as subproblems of the initial problem. Since MRS contains all solutions except cooperative solutions, in the following paragraphs [0047] until [0076] MRS is presented. In paragraphs [0060] until [0076] the various types of subproblems and solutions is presented. In the last few paragraphs after [0076] subcases of the MRS are presented, including the solution concepts of c-games, and in the last paragraph the cooperative solutions are mentioned.

The C-Game and the Players in MRS.

MRS contains a c-game, a set of c-coalitions M(i) in the c-game, the payoffs P(M(i)) of c-coalitions M(i), the sets of variables VARM(i) controlled by the c-coalitions M(i) and their union VARS=U VARM(i) that consists of all variables in the c-game that will be assigned optimal values by MRS, where i takes values in a set I.

The Variables at Step k in MRS.

MRS contains a partition of VARS into non vacuum subsets VAR(k), where the index k takes values in a set K and this set can be chosen to be the interval of ordinals {0, 1, 2, . . . , Kmax−1, Kmax}. The variables in VAR(k) are called variables determined at step k.

The Players at Step k in MRS.

MRS contains subsets I(k) of I. The c-coalitions M(i(k)) control the variables in VAR(k), where i(k) belongs in I(k). The following conditions are satisfied:
if a variable belongs in VAR(k) then this variable is controlled by M(i′) for some i′ in I(k), and
if i″ belongs in I(k) then M(i″) controls at least one variable in VAR(k).

The Subproblems at Each Step in MRS.

MRS contains for each k in K a non vacuum set L(k). The sets L(k′} and L(k″) are disjoint for any k′ and k″ in K. An index l(k) is assigned to each subproblem in step k and is referred as (k,l(k))-subproblem, where l(k) belongs in L(k).

The Variables at Each Subproblem in MRS.

MRS contains a partition of each VAR(k) into non vacuum subsets VAR(k,l(k)), where l(k) belongs in L(k). VAR(k,l(k)) consists of variables that will be determined by the solution of (k,l(k))-subproblem. The variables in VAR(k,l(k)) are denoted by z(k,l(k)).

The Players at Each Subproblem MRS.

MRS contains subsets I(k,l(k)) of each I(k), where l(k) belongs in L(k). The c-coalitions M(i(k,l(k))) control the variables in VAR(k, (l)), where i(k,l(k)) belongs in I(k,l(k)). Conditions similar to those in [0047] are satisfied:
if a variable belongs in VAR(k,l(k)) then this variable is controlled by M(i′) for some i′ in I(k,l(k)), and
if i″ belongs in I(k,l(k)) then M(i″) controls at least one variable in VAR(k,l(k)).

The Different Kind of Subproblems in MRS.

The Mixed Recursive Solution method allows the subproblems to be of different kind, hence the name mixed. We need to designate the subproblems that are of the same kind, that's why we introduce the following subsets of each L(k):
a) the subsets NL(k), GL(k), EL(k), SL(k) and OL(k) of each L(k), where for any k the union of these subsets contains all elements of L(k) and for any k any two of said subsets are disjoint if they are different from the vacuum set,
b) a partition of each SL(k) into subsets SPURL(k) and SMIXL(k)
c) a partition of each NL(k) into subsets NPURL(k) and NMIXL(k)
d) a partition of each GL(k) into subsets GPURL(k) and GMIXL(k)
e) the subsets EUL(k), ELL(k) and EGL(k) of each EL(k), where for any k the union of all said subsets contains all elements of EL(k) and where for any k if any two of these subsets are non vacuum then they are disjoint,
f) a partition of each EGL(k) into subsets EGGL(k) and EGNL(k),
g) a partition of each EGGL(k).into subsets EGGPURL(k) and EGGMIXL(k),
h) a partition of each EGNL(k) into subsets EGNPURL(k) and EGNMIXL(k), and
i) the subsets PUROL(k) and MIXOL(k) of OL(k).

We introduce also the following sets.

The sets PURL(k) defined to be the union of SPURL(k), GPURL(k), NPURL(k), EUL(k), ELL(k), EGGPURL(k) and EGNPURL(k). In the subproblems with l(k) in PURL(k) the variables will assigned “pure” optimal values. PUROL(k) is the subset of OL(k) where subproblems contain some variables that will be assigned pure values.

The sets MIXL(k) defined to be the union of SMIXL(k), GMIXL(k), NMIXL(k), EGGMIXL(k) and EGNMIXL(k). In the subproblems with l(k) in MIXL(k) the variables will assigned “mixed” optimal values, ie optimal probability measures on the variables. MIXOL(k) is the subset of OL(k) where subproblems contain some variables that will be assigned “mixed” values.

Because of the nature of the subproblems, the following conditions are satisfied:
j) if l(k) belongs in SL(k) then I(k,l(k)) consists of one element,
k) if l(k) belongs in GL(k) then I(k,l(k)) consists of two elements,
l) if l(k) belongs in NL(k) then I(k,l(k)) contains at least two elements,
m) if l(k) belongs in EL(k) then I(k,l(k)) contains at least two elements,
n) if l(k) belongs in EGGL(k) then I(k,l(k)) consists at of two elements, and
o) if l(k) belongs in OL(k) then I(k,l(k)) contains at least one element.

The sets VAR(k,l(k)) satisfy:
if l(k) belongs in EL(k) then VAR(k,l(k)) consists of c-times, and
if l(k) belongs in MIXL(k) then VAR(k,l(k)) does not contain any element in NIVAR.

The Variables Controlled by C-Coalitions in a Subproblem in MRS.

MRS contains the subsets VARM(i(k,l(k))) of VAR(k,l(k)). VARM(i(k,l(k))) consists of variables controlled by M(i(k,l(k))) in (k,l(k))-subproblem. These satisfy the conditions:
the union U VARM(i(k,l(k))) contains all elements in VAR(k,l(k)), where the union is over all i(k,l(k)) in I(k,l(k)), and
the sets VARM(i′(k,l(k))) and VARM(i″ (k,l(k))) have no element in common for all k in K and all l(k) in

L(k)(EUL(k)UELL(k))
and all i′(k,l(k)) and i″ (k,l(k)) in I(k,l(k)) such that i′(k,l(k)) is different from i″(k,l(k)).

These conditions are needed because of the nature of the subproblems.

The Measure Variables in Each Subproblem in MRS.

MRS contains probability measure variables PROBM(i(k,l(k))) for all k in K, all l(k) in MIXL(k) and all i(k,l(k)) in I(k,l(k)). Each measure PROBM(i(k,l(k))) is on the variables in VARM(i(k,l(k))). Each PROBM(i(k,l(k))) takes values in a space SPACE(k,l(k),i(k,l(k))), where this space in general depends on additional parameters

The Payoffs in Each Subproblem in MRS.

MRS contains functions that are used as payoffs in the subproblems. These are:
a) functions PAY(k,l(k)) for all k in K and all l(k) in the union SL(k) U GL(k). The set of variables of each PAY(k,l(k)) is denoted PAYVAR(k,l(k)) and it is equal to VAR(k,l(k)). Each PAY(k,l(k)) also depends on parameters and their set is denoted by PAYPAR(k,l(k)). Since MRS is a recursive method each PAYPAR(k,l(k)) consists of variables that belong in VAR(k′) where k′ is smaller than k. Obviously PAY(k,l(k)) does not depend on any variable in VAR(k″) where k″ is larger than k.
b) functions PAY(k,l(k),i(k,l(k))) for all k in K, all l(k) in EL(k) U NL(k) and all i(k,l(k)) in I(k,l(k)). The set of variables of each PAY(k,l(k),i(k,l(k))) is denoted by PAYVAR(k,l(k),i(k,l(k))). Each PAYVAR(k,l(k),i(k,l(k))) is a subset of VAR(k,l(k)) and the union over all i(k,l(k)) in I(k,l(k)) of PAYVAR(k,l(k),i(k,l(k))) contains all elements in VAR(k,l(k)). Each PAYVAR(k,l(k),i(k,l(k))) also depends on a set of parameters denoted by PAYPAR(k,l(k),i(k,l(k))). PAYPAR(k,l(k),i(k,l(k))) consists of variables that belong in VAR(k′) where k′ is smaller than k. The union over all i(k,l(k)) in I(k,l(k)) of PAYPAR(k,l(k),i(k,l(k))) is denoted by PAYPAR(k, l(k)). PAY(k,l(k),i(k,l(k))) does not depend on any variable in VAR(k″) where k″ is larger than k.

The parameters in PAYPAR(k,l(k)), defined in (a) and (b) in this paragraph, are variables to be determined at steps k′ smaller than k.

In case one wants to obtain mixed solutions, the payoffs PAY(k,l(k)) and PAY(k,l(k),i(k,l(k))) are considered to be functionals, defined by the same functions, and their variables are the measures PROBM(i(k,l(k))). These functionals are denoted EXPPAY(k,l(k)) and EXPPAY(k,l(k),i(k,l(k))) respectively. The use of the subproblem payoffs as functionals is valid in cases l(k) belongs in SMIXL(k) U GMIXL(k) U NMIXL(k). The cases where l(k) take values in EL(k) and OL(k) are treated separately.

The Optimal Variables in MRS.

Solving a (k,l(k))-subproblem in pure form one assigns optimal values to the variables in VAR(k,l(k)). Since the payoffs depend on parameters, the optimal values depend on parameters. Given a variable z(k,l(k)) its optimal value is denoted by OPTVAR(k,l(k), z(k,l(k))) and each OPTVAR(k,l(k),z(k,l(k))) is a function of the parameters in a set OPTVARPAR(k,l(k), z(k,l(k))). This set is a subset of PAYPAR(k,l(k)) defined in [0056]. OPTVAR(k,l(k),z(k,l(k))) does not depend on any variable in VAR(k″) where k″ is larger than k.

The pure solutions are defined for all (k,l(k))-subproblems where k is in K and l(k) in PURL(k) defined in [0053].

The Optimal Measures in Each Subproblem in MRS.

Solving a (k,l(k))-subproblem in mixed form one obtains optimal values for the measure variables PROBM(i(k,l(k))). Since the payoffs depend on parameters, the optimal values depend on parameters. Given a measure variables PROBM(i(k,l(k))) its optimal value is denoted by QPTPROBM(k,l(k),i(k,l(k))) and each OPTPROBM(k,l(k),i(k,l(k))) is a function of the parameters in a set OPTPROBMPAR(k,l(k),i(k,l(k))). This set is a subset of PAYPAR(k,l(k)) defined in [0056]. OPTBROBM(k,l(k),i(k,l(k))) does not depend on any variable in VAR(k″) where k″ is larger than k.

The mixed solutions are defined for all (k,l(k))-subproblems where k is in K and l(k) in MIXL(k) defined in [0053].

The Optimal Payoffs in Each Subproblem in MRS.

Solving each subproblem one obtains optimal values for the variables z(k,l(k)) in case of pure solutions and of the measures PROBM(i(k,l(k))). These are defined in [0057] and [0058].

The optimal values of the payoffs in each subproblem are defined as follows:
if the solution of the subproblem is pure then the optimal value of the subproblem payoffs is defined to be the value of the subproblem payoffs when its variables take their optimal value, and
if the solution of the subproblem is mixed then the optimal value of the subproblem payoffs is defined to be the expected value of the subproblem payoffs with respect to the optimal measures.
   These definitions of payoffs apply in all cases except when l(k) takes values in OL(k) which will be treated separately.

Since the payoffs and the optimal variables depend on parameters, the optimal payoff values are functions of parameters.

Given the subproblem payoffs PAY(k,l(k)) and PAY(k,l(k),i(k,l(k))) the optimal subproblem payoffs are denoted OPTPAY(k,l(k)) and OPTPAY(k,l(k),i(k,l(k))) respectively. They depend on parameters in the sets OPTPAYPAR(k,l(k)) and OPTPAYPAR(k,l(k),i(k,l(k))) respectively. The parameter sets OPTPAYPAR(k,l(k)) and OPTPAYPAR(k,l(k),i(k,l(k))) are subsets of the sets PAYPAR(k,l(k)) in each subproblem. OPTPAY(k,l(k),i(k,l(k))) and OPTPAY(k,l(k)) do not depend on any variable in VAR(k″) where k″ is larger than k.

The Simple Pure Subproblems in MRS.

If l(k) belongs in SPURL(k) there is a family of optimization problems, denoted SPURL_PROBLEM(k,l(k)) and written as

$${MAX}_{VARM ( i ( k , l ( k ) ) )} PAY ( k , l ( k ) ) ,$$

and their pure solutions. It is assumed that for any value of the payoff parameters in PAYPAR(k,l(k)) the optimization problem SPURL_PROBLEM(k,l(k)) can be solved. The optimal value of each variable z(k,l(k)) in VAR(k,l(k)) is given by OPTVAR(k,l(k),z(k,l(k))) that depends on parameters in OPTVARPAR(k,l(k),z(k,l(k))). The optimal value of PAY(k,l(k)) is given by OPTPAY(k,l(k)) that depends on parameters in OPTPAYPAR(k,l(k),z(k,l(k))).

These problems, along with the interpretation of an Isaacs game with many control variables as a many player game, were the starting point of the c-games. The simple solution is similar to Fermat's treatment of the motion of light rays from air into water.

The Simple Mixed Subproblems in MRS.

If l(k) belongs in SMIXL(k) there is a family of optimization problems, denoted SMIXL_PROBLEM(k,l(k)) and written as

$${MAX}_{PROBM ( i ( k , l ( k ) ) )} EXPPAY ( k , l ( k ) ) ,$$

where EXPPAY(k,l(k)) is defined in [0056], and their mixed solutions. It is assumed that for any value of the payoff parameters in PAYPAR(k,l(k)) the optimization problem SMIXL_PROBLEM(k,l(k)) can be solved. The optimal value of the variable PROBM(i(k,l(k))) is given by OPTPROBM(k,l(k),i(k,l(k))) that depends on parameters in OPTPROBMPAR(k,l(k),i(k,l(k))). The optimal expected value of PAY(k,l(k)) is given by OPTPAY(k,l(k)) that depends on parameters in OPTPAYPAR(k,l(k)).

The Game Type Pure Subproblems in MRS.

If l(k) belongs in GPURL(k) there is a family of zero sum game problems, denoted GPURL_PROBLEM(k,l(k)) and written as

$${MAX}_{VARM ( i ( k , l ( k ) ) )} {MIN}_{VARM ( ci ( k , l ( k ) ) )} PAY ( k , l ( k ) )$$

where ci(k,l(k)) denotes the element in I(k,l(k))\{i(k,l(k))}, and their pure solutions. It is assumed that for any value of the payoff parameters in PAYPAR(k,l(k)) the zero sum game problem GPURL_PROBLEM(k,l(k)) can be solved. The optimal value of each variable z(k,l(k)) in VAR(k,l(k)) is given by OPTVAR(k,l(k),z(k,l(k))) that depends on parameters in OPTVARPAR(k,l(k),z(k,l(k))). The optimal value of PAY(k,l(k)) is given by OPTPAY(k,l(k)) that depends on parameters in OPTPAYPAR(k,l(k)).

The Game Type Mixed Subproblems in MRS.

If l(k) belongs in GMIXL(k) there is a family of zero sum game problems, denoted GMIXL_PROBLEM(k,l(k)) and written as

$${MAX}_{PROBM ( i ( k , l ( k ) ) )} {MIN}_{PROBM ( ci ( k , l ( k ) ) )} EXPPAY ( k , l ( k ) )$$

where EXPPAY(k,l(k)) is defined in [0056] and where ci(k,l(k)) denotes the element in I(k,l(k)){i(k,l(k))}, and their pure solutions. It is assumed that for any value of the payoff parameters in PAYPAR(k,l(k)) the zero sum game problem GMIXL_PROBLEM(k,l(k)) can be solved. The optimal value of each variable PROBM(i(k,l(k))) is given by OPTPROBM(k,l(k),i(k,l(k))) that depends on parameters in OPTPROBMPAR(k,l(k),i(k,l(k))). The optimal expected value of PAY(k,l(k)) is given by OPTPAY(k,l(k)) that depends on parameters in OPTPAYPAR(k,l(k)).

The Nash Type Pure Subproblems in MRS.

If l(k) belongs in NPURL(k) there is a family of game problems, denoted NPURL_PROBLEM(k,l(k)) and written as

$${MAX}_{VARM ( i ( k , l ( k ) ) )} PAY ( k , l ( k ) , i ( k , l ( k ) ) ) , i ( k , l ( k ) ) in I ( k , l ( k ) ) ,$$

and their pure solutions (Nash equilibrium). It is assumed that for any value of the payoff parameters in PAYPAR(k,l(k)) the game problem NPURL_PROBLEM(k,l(k)) can be solved. The optimal value of each variable z(k,l(k)) in VAR(k,l(k)) is given by OPTVAR(k,l(k),z(k,l(k))) that depends on parameters in OPTVARPAR(k,l(k),z(k,l(k))). The optimal value of PAY(k,l(k),i(k,l(k))) is given by OPTPAY(k,l(k),i(k,l(k))) that depends on parameters in OPTPAYPAR(k,l(k),i(k,l(k))).

The Nash Type Mixed Subproblems in MRS.

If l(k) belongs in NMIXL(k) there is a family of game problems, denoted NMIXL_PROBLEM(k,l(k)) and written as

$${MAX}_{PROBM ( i ( k , l ( k ) ) )} EXPPAY ( k , l ( k ) , i ( k , l ( k ) ) ) , i ( k , l ( k ) ) in I ( k , l ( k ) ) ,$$

where EXPPAY(k,l(k),i(k,l(k))) is defined in [0056], and their mixed solutions (Nash equilibrium). It is assumed that for any value of the payoff parameters in PAYPAR(k,l(k)) the game problem NMIXL_PROBLEM(k,l(k)) can be solved. The optimal value of the variable PROBM(i(k,l(k))) is given by OPTPROBM(k,l(k),i(k,l(k))) that depends on parameters in OPTPROBMPAR(k,l(k),i(k,l(k))). The optimal expected value of PAY(k,l(k),i(k,l(k))) is given by OPTPAY(k,l(k),i(k,l(k))) that depends on parameters in OPTPAYPAR(k,l(k),i(k,l(k))).

The Lower Empirical Subproblems in MRS.
a) If l(k) belongs in ELL(k) there is a family of elements ELL_PROBLEM(k,l(k)) called lower empirical type problems, and their solutions called lower empirical solutions. ELL_PROBLEM(k,l(k)) can be formulated in case the subproblem is related to a C1-game, and the set VAR(k,l(k)) contains only c-times. The C1-game is written in realization form as

{A(k,l(k),j(k,l(k))):j(k,l(k)) in J(k,l(k))},
where J(k,l(k)) can be chosen to be the interval of ordinals {1, 2, . . . , Jmax(k,l(k))} and each realization can be given by

A(k,l(k),j(k,l(k)))=(a0(k,l(k)),a1(k,l(k),j(k,l(k)))
where a0(k,l(k)) is the first e-game and a1(k,l(k),j(k,l(k))) is the second e-game in the realization.
b) The set of c-times

T(j(k,l(k)))=t(a0(k,l(k)),a1(k,l(k),j(k,l(k)))
where j(k,l(k)) takes all values in J(k,l(k)) is the set VAR(k,l(k)).

Define the vector c-time variable

T(k,l(k))=(T(1),T(2), . . . ,T(Jmax(k,l(k))

that takes values in the cube

CUBE(k,l(k))=X[to(a0(k,l(k))),t1(a0(k,l(k)))],

where T(j′) denotes the c-time T(j(k,l(k))) when j(k,l(k)) takes the value j′ in J(k,l (k)), t0(a0(k,l(k))) is the time the differential game in e-game a0(k,l(k)) begins and t1(a0(k,l(k))) the time the differential game in e-game a0(k,l(k)) ends if it is not interrupted, [to(a0(k,l(k))), t1(a0(k,l(k)))] is the closed time interval that begins at to(a0(k,l(k))) and ends at t1(a0(k,l(k))), X denotes the cartesian product and the dimension of the cube is Jmax(k,l(k)).
c) Define a family of subsets J(i(k,l(k))) of J(k,l(k)), where each J(i(k,l(k))) contains at least one element, by:
   j(k,l(k)) belongs in J(i(k,l(k))) if the c-coalition M(i(k,l(k))) controls the c-time T(j(k,l(k))).
   One can say that J(i(k,l(k))) determines the realizations the c-coalition M(i(k,l(k))) controls or can choose.
d) Define a family of subsets I(j(k,l(k))) of I(k,l(k)), where each I(j(k,l(k))) contains at least one element, by:
   i(k,l(k)) belongs in I(j(k,l(k))) if the c-coalition M(i(k,l(k))) controls the c-time T(j (k,l(k))).
   One can say that I(j(k,l(k))) determines the c-coalitions that control or can choose realization

A(k,l(k),j(k,l(k))).
e) Define a method called main lower empirical solution, to obtain optimal values for the c-time variables, by the following steps (e1) until (e7)
   e1)
      denote T(k,l(k)) by T,
      denote CUBE(k,l(k)) by CUBE
      denote T(j(k,l(k))) by T(j),
      denote i(k,l(k)) by i,
      denote I(k,l(k)) by I,
      denote J(i(k,l(k))) by J(i),
      denote the payoff PAY(k,l(k),i(k,l(k))) by Pi,
      denote to(a0(k,l(k))) and t1(a0(k,l(k)))
         by to(a0) and t1(a0) respectively,
      denote Pi by Si(j)) if realization j is chosen and j belongs in J(i), thus the M(i) c-coalition can choose to play A(j) realization,
      denote Pi by Qi(j)) if realization j is chosen and j belongs in J\J(i), thus another c-coalition chooses to play A(j) realization,
      denote the value of Pi when the c-time vector
         T takes a particular value and realization j is chosen by Pi(j,T),
      denote the value of Si(j) when the c-time vector T takes a particular value by Si(j,T),
      denote the value of Qi(j) when the c-time vector T takes a particular value by Qi(j,T),
      denote the logical conjunction by AND,
      denote the logical disjunction by OR,
      denote the logical negation by NOT,
      denote the “x is larger or equal y” by “x≧y”,
      denote the “x is larger than y” by “x>y”,
      denote the intersection of two sets SET1 and SET2 by SET1∩SET2
      and denote the “not equal” by ≠.
   e2) consider two points (t,i) and (t′,i′) in

[to(a0),t1(a0)]×J,
and define a binary relation called LOWBETTER by:
   (t,j) is LOWBETTER than (t′,j′)
      if RLOW is true,
where RLOW is the logical proposition defined by the following propositions:
   R1=(t<t′),
   R21=(there exists T in CUBE)
   R22=(there exists T′ in CUBE),
   R23=(there exists j in J),
   R24=(there exists j′ in J),
   R2=R21 AND R22 AND R23 AND R24,
   R3=(min T=T(j)) AND (T(j)=t),
   R4=(min T′=T′(j′)) AND (T′(j′)=t′),
   R5=(Si(j,T) 2 Pi(j′,T′), for all i in I(j)),
   R61=(there exists j″ in J),
   R62=(there exists T″ in CUBE),
   R63=(min T″=T″(j″)) AND (T″(j″)=t),
   R6=R61 AND R62 AND R63,
   R7=(I(j)∩I(j″)=VACUUM SET)
   R8=(Qi(j,T)≧Pi(j′,T′), for all i in I(j″)),
   R9=(Si(j,T)>Qi(j″, T″), for all i in I(j)),
   R101=(there exists j′″ in J
   R102=(there exists T′″ in CUBE)
   R103=(min T′″=T′″(j′″)) AND. (T(j′″)=t),
   R10=R101 AND R102 AND R103
   R11=((I(j)∩I(j′″))≠VACUUM SET
   R12=(Si(j,T)≧Pi(j′,T′),
      for all i in (I(j)∩I(j′″))
   R13=(Qi(j,T)≧Pi(j′,T′),
      for all i in I(j′″)\(I(j)∩I(j′″))),
   R14=(Si(j,T)>Qi(j′″, T′″),
      for all i in I(j)\(I(j)∩I(j′″))),
   R15=R1 AND R2 AND R3 AND R4,
   R16=R5,
   R17=R6 AND R7 AND R8 AND R9
   R18=R10 AND R11 AND R12 AND R13 AND R14,
   RLOW=R15 AND (R16 OR (R17 OR R18)).
Some comments on these propositions:
A c-coalition thinks a point (t,j) is better than (t′,j), or prefers (t,j) than (t,j′), if t is earlier than t′ and the payoff of the c-coalition at (t,j) is larger or equal than its payoff at (t′,j′).
   Proposition R15 defines the points (t,j), (t′,j′), and the c-times T(j) and T′(j′).
   Proposition R16 says that (t,j) is better than (t′,j′) for all c-coalitions M(i) that control T(j)=t, thus they are willing to cooperate and choose c-time T(j)=t simultaneously and play realization j.
Consider now the case where the following (e2.1) and (e2.2) happen:
   e2.1) some c-coalitions prefer realization (t,j) from (t′,j′) but these c-coalitions are a subset of the set of c-coalitions that control T(j), and
   e2.2) some c-coalitions M that control T(j) do not prefer (t,j) from (t′,j′) (their payoff decreases at (t,j)).
Then c-coalitions in (e2.1) must threat the c-coalitions M in (e2.2) and force them to choose j at T(j). The remaining propositions formulate this case.
   Proposition R6 defines a realization j″ that can be used as a threat from those who control T(j″)=t.
   Proposition R8 states that (t,j) is better from (t′,j′) for all c-coalitions that control T(j″)=t.
   Proposition R9 is the threat and states that (t,j″) is worse than (t,j) for c-coalitions that control T(j)=t.
   Proposition R17 defines the threat, in case the set of c-coalitions that control T(j) and the set of c-coalitions that control T(j′) have no element in common (R7).
   Similarly R18 defines the threat, in case the set of c-coalitions that control T(j) and the set of c-coalitions that control T(j′) have common elements (R11)
   Proposition RLOW states that (t,j) is better than (t′,j′) if coalitions that control T(j) are willing to choose this (R16) or are forced to do so, (R17 or R18)
   In lower empirical solution any threat, formulated by R17 and R18 forces c-coalitions that control T(j)=t to choose (t,j).
e3) Consider a point (t′,i′) in

[to(a0),t1(a0)]×J,
and define a unary relation called HASNOLOWBETTER by:
   (t′, j′) HASNOLOWBETTER
   if NOT RLOW is true
   for all (t,j) that satisfy t<t′,
where NOT RLOW is the logical negation of logical proposition RLOW,
e4) define KLOW1 to be the subset of

[to(a0),t1(a0)]×J
that consists of points that satisfy HASNOLOWBETTER and the points in

{to(a0)}×J,
and define TEL1 to be the point in [to(a0), t1(a0)] that satisfies

$$TEL 1 = {sup}_{t} KLOW 1$$

where

$${sup}_{t} KLOW 1$$

denotes the supremum of the set of all all t in [to(a0), t1(a0)] such that (t,j) is in KLOW1,
e5) define KLOW1′ to be the subset KLOW1 that satisfies:
   (t,j) belongs in KLOW1′
   if there exists (t″″, j″″) in KLOW1
   such that t=t″″ and j≠j″″
e6) define the set KLOW2 by

KLOW2=KLOW1\KLOW1′, and
e7) define the lower empirical solution point

ELS=(TEL,j(TEL))
to be the point in KLOW2 that satisfies

$$TEL = {sup}_{t} KLOW 2$$

where

$${sup}_{t} KLOW 2$$

denotes the supremum of the set of all t in [to(a0), t1(a0)] such that (t,j) is in KLOW2 and j(TEL) is the realization index that corresponds to TEL.
ELS exists and is unique if KLOW2 is non vacuum and the set of all t such that (t,j) belongs in KLOW2 is closed from the right.
The set KLOW2 is introduced because in that case the optimal c-time corresponds to a unique realization. In the case one uses KLOW1 this may not happen. But the point TEL1 obtained using KLOW1 domain can be used to define domains of c-times where one can deal with the threats by solving a game. The same applies to the sets KUP1 and KUP2 defined in [0067] later.
f) One can consider methods that are simple variations of the main lower empirical solution method, where the variations are obtained by replacing the equal-smaller inequalities by strict smaller or the strict smaller by equal-smaller in some or all propositions R1, R5, R8, R9, R12, R13 and R14 and/or restricting the domain of c-times to a subset of the closed interval [to(a0), t1(a0)], for example omitting the points t0(a0) and t1(a0).
   These methods can be used to obtain ELS and TEL1 as in (e1) until (e7) of this paragraph.
g) One can apply the lower empirical solution method to ELL_PROBLEM(k,l(k)). It is assumed that for any values of the parameters in the payoffs the lower empirical solution ELS and the point TEL1 exist.
   Denote the solution ELS=(TEL, j(TEL)) of each subproblem ELL_PROBLEM(k,l(k)) by

ELS(k,l(k))=(TEL(k,l(k)),j(TEL)(k,l(k))
and the point TEL1 by TEL1(k,l(k)).
h) Since this method gives as solution a single time value TEL (and the realization j(TEL)) we need the following:
   functions ELL_ASIGNVAR(k,l(k)) are defined that depend on parameters in PAYPAR(k,l(k)) and these functions assign to each c-time variable
      T(j(k,l(k))) an optimal value OPTLOWT(j (k,l(k))) by:
         if j (k,l(k)) equals j(TEL) (k,l(k)) then OPTLOWT(j(k,l(k))) is defined to be the time TEL(k,l(k)), and
         if j (k,l(k)) is different from j (TEL) (k,l(k)) then OPTLOWT(j(k,l(k))) is defined to be a time larger than TEL(k,l(k)).
   In case the subproblem payoffs are of the kind introduced in [0042], the choice of any arbitrary value larger than TEL(k,l(k)), for the c-time variables T(j(k,l(k))) such that j(k,l(k)) is different from j(TEL) (k,l(k)), does not change the value of the payoff.
      Since the subproblem payoffs depend on parameters so does the solution ELS(k,l(k)) and the point TEL1(k,l(k)).
i) Assume the variable z(k,l(k)) in VAR(k,l(k)) is the c-time T(j(k,l(k))). Then the optimal value OPTLOWT(j(k,l(k))) is defined to be OPTVAR(k,l(k),z(k,l(k))) that depends in parameters in OPTVARPAR(k,l(k),z(k,l(k))). The optimal value of each payoff PAY(k,l(k),i(k,l(k))), defined as usual to be the value of the payoff when its variables take optimal values, is OPTPAY(k,l(k),i(k,l(k))) and depends on parameters in OPTPAYPAR(k,l(k),i(k,l(k))).

The Upper Empirical Subproblems in MRS.
a) If l(k) belongs in EUL(k) there is a family of elements EUL_PROBLEM(k,l(k)) called upper empirical type problems and their solutions called upper empirical solutions.
   EUL_PROBLEM(k,l(k)) can be formulated in case the subproblem is related to a C1-game, and the set VAR(k,l(k)) contains only c-times, as in [0066].
   The definitions and quantities of subparagraphs (a) until (d) of paragraph [0066] are included in the case of the present paragraph [0067].
e) Define a method called main upper empirical solution, to obtain optimal values for the c-time variables, by the following steps (e1) until (e7)
   e1) use the notation of (e1) in [0066],
   e2) consider two points (t,i) and (t′,i′) in

[to(a0),t1(a0)]×J,
and define a binary relation called UPBETTER by:
   (t,j) is UPBETTER than (t′,j′)
      if RUP is true,
where RUP is the logical proposition defined by:
   RUP=R1 AND R2 AND R3 AND R4 AND R5
where R1, R2, R3, R4, and R5 are the logical propositions defined in [0066].
e3) Consider a point (t′,i′) in

[to(a0),t1(a0)]×J,
and define a unary relation called HASNOUPBETTER by:
   (t′, j′) HASNOUPBETTER
   if NOT RUP is true
   for all (t,j) that satisfy t<t′,
where NOT RUP is the logical negation of the logical proposition RUP,
e4) define KUP1 to be the subset of

[to(a0),t1(a0)]×J
that consists of points that satisfy HASNOPBETTER and the points in

{to(a0)}×J,
and define TEU1 to be the point in [to(a0), t1(a0)] that satisfies

$$TEU 1 = {sup}_{t} KUP 1$$

where

$${sup}_{t} KUP 1$$

denotes the supremum of the set of all all t in [to(a0), t1(a0)] such that (t,j) is in KUP1,
e5) define KUP1′ to be the subset KUP1 that satisfies
   (t,j) belongs in KUP1′
   if there exists (t″″, j″″) in KUP1
   such that t=t″″ and j≠j″″,
e6) define the set KUP2 by

KUP2=KUP1\KUP1′, and
e7) define the upper empirical solution point

EUS=(TEU,j(TEU))
to be the point in KUP2 that satisfies

$$TEU = {sup}_{t} KUP 2$$

where

$${sup}_{t} KUP 2$$

denotes the supremum of the set of all t in [to(a0), t1(a0)] such that (t,j) is in KUP2 and j(TEU) is the realization index that corresponds to TEU.
EUS exists and is unique if KUP2 is non vacuum and the set of all t such that (t,j) belongs in KUP2 is closed from the right.
f) One can consider methods that are simple variations of the upper empirical solution method, where the variation is obtained by replacing the equal-smaller inequality by strict smaller or the strict smaller by equal smaller in R1 and R5 and/or restricting the domain of c-times to a subset of the closed interval [to(a0), t1(a0)]. These methods can be used to obtain EUS and TEU1 as in (e1) until (e7) of this paragraph.
g) One can apply the upper empirical solution method to EUL_PROBLEM(k,l(k)). It is assumed that for any values of the parameters in the payoffs the upper empirical solution EUS and the point TEU1 exist.
   Denote the solution EUS=(TEU, j(TEU)) of each subproblem EUL_PROBLEM(k,l(k)) by

EUS(k,l(k))=(TEU(k,l(k)),j(TEU)(k,l(k)))
and the point TEU1 by TEU1(k,l(k)).
h) Since this method gives as solution a single time value TEU (and the realization j(TEU)) we need the following:
   functions EUL_ASIGNVAR(k,l(k)) are defined that depend on parameters in PAYPAR(k,l(k)) and these functions assign to each c-time variable T(j(k,l(k))) an optimal value OPTUPT(j (k,l(k))) by:
      if j (k,l(k)) equals j(TEU) (k,l(k)) then OPTUPT(j(k,l(k))) is defined to be the time TEU(k,l(k)), and
      if j(k,l(k)) is different from j(TEU)(k,l(k)) then OPTUPT(j(k,l(k))) is defined to be a time larger than TEU(k,l(k)).
   In case the subproblem payoffs are of the kind introduced in [0042], the choice of any arbitrary value larger than TEU(k,l(k)), for the c-time variables T(j(k,l(k))) such that j (k,l(k)) is different from j(TEU) (k,l(k)), does not change the value of the payoff.
   Since the subproblem payoffs depend on parameters so does the solution EUS(k,l(k)) and the point TEU1(k,l(k)).
i) Assume the variable z(k,l(k)) in VAR(k,l(k)) is the c-time T(j(k,l(k))). Then the optimal value OPTUPT(j(k,l(k))) is defined to be OPTVAR(k,l(k),z(k,l(k))) that depends in parameters in OPTVARPAR(k,l(k),z(k,l(k))). The optimal value of each payoff PAY(k,l(k),i(k,l(k))), defined to be the value of the payoff when its variables take optimal values, is OPTPAY(k,l(k),i(k,l(k))) and depends on parameters in OPTPAYPAR(k,l(k),i(k,l(k))).

The Empirical Game Type Pure Subproblems in MRS.
a) If l(k) belongs in EGGPURL(k) there is a family of elements EGGPURL_PROBLEM(k,l(k)) called empirical game type pure problems, and their solutions called empirical game type pure solutions or EGPS.
   EGGPURL_PROBLEM(k,l(k)) can be formulated in case the subproblem is related to a C1-game, and the set VAR(k,l(k)) contains only c-times, as in [0066].
   The definitions and quantities of subparagraphs (a) until (d) of paragraph [0066] are included in the case of the present paragraph [0068].
   The solutions in [0066] and [0067] are used also in the present paragraph.
b) The payoff functions are PAY(k,l(k,i(k,l(k))). An upper empirical problem with payoffs PAY(k,l(k),i(k,l(k))) is formulated and its solution EUS(k,l(k)) and the point TEU1(k,l(k)) are obtained as in paragraph [0067]. Also a lower empirical problem with payoffs PAY(k,l(k),i(k,l(k))) is formulated and its solution ELS(k,l(k)) and the point TEL1(k,l(k)) are obtained as in paragraph [0066].
c) Define the points T0(k,l(k)) and T1(k,l(k)) by:
   T0(k,l(k)) is defined to be
   either TEL(k,l(k)) or TEL1(k,l(k)), and
   T1(k,l(k)) is defined to be either
   TEU(k,l(k)) or TEU1(k,l(k)).
   The choice of TEL1(k,l(k)) and TEU1(k,l(k)) is better, but one can also use TEU(k,l(k)) and TEL(k,l(k)) when they exist.
d) Define a function EGGPURL_FUN(k,l(k)) that is a function of the functions PAY(k,l(k),i(k,l(k))). It is assumed that the set of variables of EGGPURL_FUN(k,l(k)), denoted by EGGPURL_FUNVAR(k,l(k)), is equal to PAYVAR(k,l(k)). It is also assumed that EGGPURL_FUN(k,l(k)).depends on parameters in a set EGGPURL_FUNPAR(k,l(k)) that is a subset of PAYPAR(k,l(k)).
   This function is interpreted as a measure of the threats in empirical solutions. A simple choice is the difference

PAY(k,l(k),i′(k,l(k)))−PAY(k,l(k),i″(k,l(k)))
of the payoffs of the two c-coalitions in the subproblem.
e) A zero sum game problem is formulated

$${MAX }_{VARM ( i ( k , l ( k ) ) ) } {MIN}_{VARM ( ci ( k , l ( k ) ) )} EGGPURL\_FUN ( k , l ( k ) ) ,$$

where ci(k,l(k)) denotes the element in I(k,l(k))\{i(k,l(k))}, and where the c-times take values in the interval that begins at T0(k,l(k)) and ends at T1(k,l(k)).
The solution of this game problem gives the optimal values for the variables, the c-times T(j(k,l(k))). It is assumed that for any values of the parameters the zero sum game can be solved and the optimal values of c-time variables depend on these parameters.
Assume the variable z(k,l(k)) in VAR(k,l(k)) is the c-time T(j(k,l(k))). Then the optimal value of z(k,l(k)) in the zero sum game, in the present subparagraph (e), is defined to be the value of the function OPTVAR(k,l(k),z(k,l(k))) that depends on parameters in OPTVARPAR(k, (k),z(k, (k))).
f) The optimal value of each variable z(k,l(k)), that belongs in VAR(k,l(k)), given by empirical game type pure solution of the empirical game type pure problem is defined to be the OPTVAR(k,l(k),z(k,l(k))) defined in the previous subparagraph (e). Thus the solution of the game problem in (e) gives the EGPS optimal c-times in the empirical game type pure problem.
   The EGPS optimal values of the payoffs PAY(k,l(k),i(k,l(k))) in the empirical game type pure problem are defined to be the values of these payoffs when their variables take the EGPS optimal values OPTVAR(k,l(k),z(k,l(k))).
   The EGPS optimal value of PAY(k,l(k),i(k,l(k))) in EGGPURL_PROBLEM(k,l(k)) is the function OPTPAY(k,l(k),i(k,l(k))) that depends on parameters in OPTPAYPAR(k,l(k),i(k,l(k))).

The Empirical Game Type Mixed Subproblems in MRS.
a) If l(k) belongs in EGGMIXL(k) there is a family of elements EGGMIXL_PROBLEM(k,l(k)) called empirical game type mixed problems and their solutions called empirical game type mixed solutions or EGMS.
   EGGMIXL_PROBLEM(k,l(k)) can be formulated in case the subproblem is related to a C1-game, and the set VAR(k,l(k)) contains only c-times, as in [0066].
   The definitions and quantities of subparagraphs (a) until (d) of paragraph [0066] are included in the case of the present paragraph [0069].
   The solutions in [0066] and [0067] are used also in the present paragraph.
b) The payoff functions are PAY(k,l(k),i(k,l(k))). An upper empirical problem with payoffs PAY(k,l(k),i(k,l(k))) is formulated and its solution EUS(k,l(k)) and the point TEU1(k,l(k)) are obtained as in paragraph [0067]. Also a lower empirical problem with payoffs PAY(k,l(k),i(k,l(k))) is formulated and its solution ELS(k,l(k)) and the point TEL1(k,l(k)) are obtained as in paragraph [0066].
c) Define the points T0(k,l(k)) and T1(k,l(k)) as in (c) in paragraph [0068].
d) Define a function EGGMIXL_FUN(k,l(k)) as in (d) in paragraph [0068].
   Define the functional EGGMIXL_EXPFUN(k,l(k)) to be the function EGGMIXL_FUN(k,l(k)), where the arguments of the functional are the measures PROBM(i(k,l(k))),
e) A zero sum game problem is formulated

$${MAX}_{PROBM ( i ( k , l ( k ) ) )} \qquad {MIN}_{PROBM ( ci ( k , l ( k ) ) )} EGGMIXL\_EXPFUN ( k , l ( k ) ) ,$$

where ci(k,l(k)) denotes the element in I(k,l(k)){i(k,l(k))}, and where the c-times take values in the interval that begins at T0(k,l(k)) and ends at T1(k,l(k)).
The solution of this game problem gives the optimal values for the variables, the measures PROBM(i(k,l(k))) on the c-times. It is assumed that for any values of the parameters the zero sum game can be solved and the optimal values of the measure variables depend on these parameters.
The optimal value of PROBM(i(k,l(k))) in the zero sum game, in the present subparagraph (e), is defined to be the value of the function OPTPROBM(k,l(k),i(k,l(k))) that depends on parameters in OPTPROBMPAR(k,l(k),i(k,l(k))).
f) The EGMS optimal value of each variable PROBM(i(k,l(k))) given by solution of the empirical game type mixed problem is defined to be the OPTPROBM(k,l(k),i(k,l(k))) defined in the previous subparagraph (e). Thus the solution of the game problem in (e) gives the EGMS optimal c-times in the game type mixed empirical problem.
   The EGMS optimal values of the payoffs PAY(k,l(k),i(k,l(k))) in the empirical game type mixed problem are defined to be the expected values of these payoffs with respect to the product of the EGMS optimal measures OPTPROBM(k,l(k),i(k,l(k))). The integrals are calculated in the domain of c-times defined by: each c-time belongs in the interval that begins at T0(k,l(k)) and ends at T1(k,l(k)).
   The EGMS optimal value of PAY(k,l(k),i(k,l(k))) in EGGMIXL_PROBLEM(k,l(k)) is the function OPTPAY(k,l(k),i(k,l(k))) that depends on parameters in OPTPAYPAR(k,l(k),i(k,l(k))).

The Empirical Nash Type Pure Subproblems in MRS.
a) If l(k) belongs in EGNPURL(k) there is a family of elements EGNPURL_PROBLEM(k,l(k)) called Nash type pure empirical problems and their solutions called empirical Nash type pure solutions or ENPS.
   EGNPURL_PROBLEM(k,l(k)) can be formulated in case the subproblem is related to a C1-game, and the set VAR(k,l(k)) contains only c-times, as in [0066].
   The definitions and quantities of subparagraphs (a) until (d) of paragraph [0066] are included in the case of the present paragraph [0070].
   The solutions in [0066] and [0067] are used also in the present paragraph.
b) The payoff functions are PAY(k,l(k),i(k,l(k))). An upper empirical problem with payoffs PAY(k,l(k),i(k,l(k))) is formulated and its solution EUS(k,l(k)) and the point TEU1(k,l(k)) are obtained as in paragraph [0067]. Also a lower empirical problem with payoffs PAY(k,l(k),i(k,l(k))) is formulated and its solution ELS(k,l(k)) and the point TEL1(k,l(k)) are obtained as in paragraph [0066].
c) Define the points T0(k,l(k)) and T1(k,l(k)) as in (c) in paragraph [0068].
d) Define a functions EGNPURL_FUN(k,l(k),i(k,l(k))), for all i(k,l(k)) in I(k,l(k)), that are a functions of the functions PAY(k,l(k),i′(k,l(k))), where i′(k,l(k)) takes values in I(k,l(k)). The set of variables of EGNPURL_FUN(k,l(k),i(k,l(k))) is denoted by EGNPURL_FUNVAR(k,l(k)),i(k,l(k))). It is assumed that the union, over all i(k,l(k)) in I(k,l(k)),
   U EGNPURL_FUNVAR(k,l(k)),i(k,l(k))) is equal to PAYVAR(k,l(k)). It is also assumed that EGNPURL_FUN(k,l(k),i(k,l(k))) depends on parameters in a set EGNPURL_FUNPAR(k,l(k),i(k,l(k))) that is a subset of PAYPAR(k,l(k)).

These function are interpreted as a measures of the threats in empirical solutions. A simple choice is

EGNPURL_{—}FUN(k,l(k),i(k,l(k)))==PAY(k,l(k),i(k,l(k))).
e) A game problem is formulated

$${MAX}_{VARM ( i ( k , l ( k ) ) )} \qquad {EGNPURL\_FUN ( k , l ( k ) , i ( k , l ( k ) ) )}_{i ( k , l ( k ) ) in I ( k , l ( k ) ) ,} ,$$

where the c-times take values in the interval that begins at T0(k,l(k)) and ends at T1(k,l(k)).
The solution of this game problem (Nash equilibrium gives the optimal values for the variables, the c-times T(j(k,l(k))). It is assumed that for any values of the parameters the game can be solved and the optimal values of c-time variables depend on these parameters.
Assume the variable z(k,l(k)) in VAR(k,l(k)) is the c-time T(j(k,l(k))). Then the optimal value of z(k,l(k)) in the game, in the present subparagraph (e), is defined to be the value of the function OPTVAR(k,l(k),z(k,l(k))) that depends on parameters in OPTVARPAR(k,l(k),z(k,l(k))).
f) The ENPS optimal value of each variable z(k,l(k)), that belongs in VAR(k,l(k)), given by solution of the empirical Nash type pure problem is defined to be the OPTVAR(k,l(k),z(k,l(k))) defined in the previous subparagraph (e). Thus the solution of the game problem in (e) gives the ENPS optimal c-times in the Nash type pure empirical problem.
   The ENPS optimal values of the payoffs PAY(k,l(k),i(k,l(k))) in the empirical Nash type pure problem are defined to be the values of these payoffs when their variables take the ENPS optimal values OPTVAR(k,l(k),z(k,l(k))).
   The ENPS optimal value of PAY(k,l(k),i(k,l(k))) in EGNPURL_PROBLEM(k,l(k)) is the function OPTPAY(k,l(k),i(k,l(k))) that depends on parameters in OPTPAYPAR(k,l(k),i(k,l(k))).

The Empirical Nash Type Mixed Subproblems in MRS.
a) If l(k) belongs in EGNMIXL(k) there is a family of elements EGNMIXL_PROBLEM(k,l(k)) called Nash type mixed empirical problems and their solutions called empirical Nash type mixed solutions or ENMS.
   EGNMIXL_PROBLEM(k,l(k)) can be formulated in case the subproblem is related to a C1-game, and the set VAR(k,l(k)) contains only c-times, as in [0066].
   The definitions and quantities of subparagraphs (a) until (d) of paragraph [0066] are included in the case of the present paragraph [0071].
   The solutions in [0066] and [0067] are used also in the present paragraph.
b) The payoff functions are PAY(k,l(k),i(k,l(k))). An upper empirical problem with payoffs PAY(k,l(k),i(k,l(k))) is formulated and its solution EUS(k,l(k)) and the point TEU1(k,l(k)) are obtained as in paragraph [0067]. Also a lower empirical problem with payoffs PAY(k,l(k),i(k,l(k))) is formulated and its solution ELS(k,l(k)) and the point TEL1(k,l(k)) are obtained as in paragraph [0066].
c) Define the points T0(k,l(k)) and T1(k,l(k)) as in (c) in paragraph [0068].
d) Define functions EGNMIXL_FUN(k,l(k),i(k,l(k))) as in (d) in paragraph [0070].
   Define the functionals EGNMIXL_EXPFUN(k,l(k),i(k,l(k))) to be the functions EGNMIXL_FUN(k,l(k),i(k,l(k))), where the arguments of the functionals are the measures PROBM(i(k,l(k))),
e) A game problem is formulated

$${MAX}_{PROBM ( i ( k , l ( k ) ) )} \qquad {EGNMIXL\_EXPFUN ( k , l ( k ) )}_{i ( k , l ( k ) ) in I ( k , l ( k ) ) ,} ,$$

where the c-times take values in the interval that begins at T0(k,l(k)) and ends at T1(k,l(k)).
The solution of this game problem gives the optimal values for the variables, the measures PROBM(i(k,l(k))) on the c-times. It is assumed that for any values of the parameters the zero sum game can be solved and the optimal values of the measure variables depend on these parameters.
The optimal value of PROBM(i(k,l(k))) in the game, in the present subparagraph (e), is defined to be the value of the function OPTPROBM(k,l(k),i(k,l(k))) that depends on parameters in OPTPROBMPAR(k,l(k),i(k,l(k))).
f) The ENMS optimal value of each variable PROBM(i(k,l(k))) given by solution of the empirical Nash type mixed problem is defined to be the OPTPROBM(k,l(k),i(k,l(k))) defined in the previous subparagraph (e). Thus the solution of the game problem in (e) gives the ENMS optimal c-times in the empirical Nash type mixed problem.
   The ENMS optimal values of the payoffs PAY(k,l(k),i(k,l(k))) in the empirical Nash type mixed problem are defined to be the expected values of these payoffs with respect to the product of the ENMS optimal measures OPTPROBM(k,l(k),i(k,l(k))). The integrals are calculated in the domain of c-times defined by: each c-time belongs in the interval that begins at T0(k,l(k)) and ends at T1(k,l(k)).
   The ENMS optimal value of PAY(k,l(k),i(k,l(k))) in GNMIXL_PROBLEM(k,l(k)) is the function OPTPAY(k,l(k),i(k,l(k))) that depends on parameters in OPTPAYPAR(k,l(k),i(k,l(k))).

The Other Types Subproblems in MRS.

If l(k) takes values in OL(k) then they are given problems OL_PROBLEM(k,l(k)) and their solutions OL_S(k,l(k)).

This paragraph deals with subproblems that can be solved using methods different from the methods used in subproblems so far. This case includes the case where a c-coalition that takes part in this subproblem can choose its variables at will, or by chance. In these cases only the optimal values are needed. Also functions can be introduced, interpreted as payoffs. The set of payoffs can be the vacuum set.

It is assumed that there is given a partition of VAR(k,l(k)) in to subsets OL_PURVAR(k,l(k)) and OL_MIXVAR(k,l(k)).

It is assumed that the optimal values of each variable z(k,l(k)) in OL_PURVAR(k,l(k)) is given by OPTVAR(k,l(k),z(k,l(k))) that depends on parameters in OPTVARPAR(k,l(k),z(k,l(k))) that consists of elements that belong in VAR(k′) where k′ belongs in K and is smaller than k.

It is assumed that there is given an optimal probability measure OPTPROBM(k,l(k)) on the variables in OL_MIXVAR(k,l(k)) that depends on parameters in a set OPTPROBMPAR(k,l(k)) that consists of elements that belong in VAR(k′) where k′ belongs in K and is smaller than k.

The above assumptions are essential in MRS because all variables must be assigned an optimal value, and these assumptions do that. There can be additional quantities which can be used in these problems.

Consider for example the case where some coalitions assign optimal measures in variables they control. This measures are denoted OPTPROBM(k,l(k),mi(k,l(k))), where mi(k,l(k)) belongs in a subset MIXI(k,l(k)) of I(k,l(k)). Then OPTPROBM(k,l(k)) is defined to be the product measure of the optimal measures OPTPROBM(k,l(k),mi(k,l(k))) that depend on parameters in a set OPTPROBMPAR(k,l(k),mi(k,l(k))) that consists of elements that belong in VAR(k′) for k′ in K smaller than k.

One can assume also that they are given functions OPTPAY(k,l(k),oi(k,l(k))), where oi(k,l(k)) takes values in a set OI(k,l(k)). These functions are interpreted as optimal payoffs in the subproblem and in general they depend on parameters in a set that consists of elements in VAR(k′) where k′ belongs in K and is smaller than k.

One can define a subcase where furthermore payoffs PAY(k,l(k),oi(k,l(k))) are given. These depend on variables in a set PAYVAR(k,l(k),oi(k,l(k))) that is a subset of VAR(k,l(k)) and also depend on parameters in PAYPAR(k,l(k),oi(k,l(k))) that consists of elements in VAR(k′) where k′ belongs in K and is smaller than k. Then one can define the optimal payoffs follows:
define PAY1(k,l(k),oi(k,l(k))) to be the function PAY(k,l(k),oi(k,l(k))) when each variable z(k,l(k)) in the intersection of OL_PURVAR(k,l(k)) and PAYVAR(k,l(k),oi(k,l(k))) is replaced with OPTVAR(k,l(k), z(k,l(k))), and
define OPTPAY(k,l(k),oi(k,l(k))) to be the expectation of PAY1(k,l(k),oi(k,l(k))) with respect to the measure OPTPROBM(k,l(k)).

The solution OL_S(k,l(k)) contains necessarily the optimal variables OPTVAR(k,l(k),z(k,l(k))) and the optimal measure OPTPROBM(k,l(k)) but it can contain also the optimal payoffs OPTPAY(k,l(k),oi(k,l(k))) and the measures OPTPROBM(k,l(k),mi(k,l(k))) if these quantities exist.

The Sets of Pure and Mixed Variables in MRS.

There is a partition of VARS into two disjoint subsets. The one contains variables that an optimal value is assigned by MRS, and is called set of pure variables and denoted by PURVAR. The other contains variables that MRS assigns an optimal measure and this set is called set of mixed variables and denoted MIXVAR. One of these two subsets can be the vacuum set. One way to define formally quantities that depend on k and l(k) is to specify the subsets of K and L(k) these quantities are defined. For example in the definition of PURVAR(k,l(k)) below the sets PURL(k) may not exist for certain values of k or even any values of k. A second way is to define them for all k and all l(k) with the understanding that these definitions are valid when k and l(k) exist. To avoid introducing more quantities the second way is used usually in this paper. An example of the first way is in paragraph [0075].

Define the sets PURVAR(k,l(k)), called sets of pure variables in the (k,l(k))-subproblems, for all k in K and all l(k) in PURL(k) U PUROL(k), by
if l(k) belongs in PURL(k) then
PURVAR(k,l(k)) is the set VAR(k,l(k)) and
if l(k) belongs in PUROL(k) then
PURVAR(k,l(k)) is the set OL_PURVAR(k,l(k)).

Define the sets MIXVAR(k,l(k)), called sets of mixed variables in the (k,l(k))-subproblems, for all k in K and all l(k) MIXL(k) U MIXOL(k), by
if l(k) belongs in MIXL(k) then
MIXVAR(k,l(k)) is the set VAR(k,l(k)) and
if l(k) belongs in MIXOL(k) then
MIXVAR(k,l(k)) is the set OL_MIXVAR(k,l(k)).

The Recursive Optimal Variables in MRS.

The optimal variables, and measures, obtained from the solution of subproblems depend on parameters that belong in VARS. Some of these parameters are pure variables, thus their optimal value is obtained is some subproblem. Since the set of pure variables in the MRS solution can be vacuum, the following are valid when there are exist pure variables. Define the set RECOPTVAR of recursive optimal variables that consists of all recursive optimal variables RECOPTVAR(k,l(k),z(k,l(k))) by the following steps:
a) each RECOPTVAR(0,l(0),z(0,l(0))) is defined to be OPTVAR(0,l(0),z(0,l(0))), for all l(0) in PURL(0) U PUROL(0) and all z(0,l(0)) in PURVAR(0,l(0)),
b) assume RECOPTVAR(k′,l′(k′),z′(k′,l′(k′))) are defined for all k′ in {0, 1, . . . , k} and all l′(k′) in PURL(k′) U PUROL(k′) and all z′(k′,l′(k′)) in PURVAR(k′,l′(k′)),
c) for all l(k+1) in PURL(k+1) U PUROL(k+1) and all z(k+1,l(k+1)) in PURVAR(k+1,l(k+1)), RECOPTVAR(k+1,l(k+1),z(k+1,l(k+1))) is defined to be OPTVAR(k+1,l(k+1),z(k+1,l(k+1))) when each z′(k′,l′(k′)) that belongs in the intersection of PURVAR(k′,l′(k′)) and OPTVARPAR(k+1,l(k+1),z(k+1,l(k+1))) is replaced with RECOPTVAR(k′,l′(k′),z′(k′,l′(k′))),
   for all z′(k′,l′(k′)) that belong in the intersection of PURVAR(k′,l′(k′)) and OPTVARPAR(k+1,l(k+1),z(k+1,l(k+1))), and all k′ in {0, 1, . . . , k}, and all l′(k′) in PURL(k′) U PUROL(k′), and
d) repeat step (c) until k+1 equals Kmax.

The Recursive Optimal Measures in MRS.

Define the set RECOPTPROBM of recursive optimal measures to be the union of the sets RECOPTPROBM1 and RECOPTPROBM2 and RECOPTPROBM3.

RECOPTPROBM1 consists of all recursive optimal measures RECOPTPROBM(k,l(k),i(k,l(k))), RECOPTPROBM2 consists of all RECOPTPROBM(k,l(k)), and RECOPTPROBM consists of all RECOPTPROBM(k,l(k),mi(k,l(k),mi(k,l(k)).

For all-k in K such that MIXL(k) is not vacuum and all l(k) in MIXL(k) and all i(k,l(k))

define each RECOPTPROBM(k,l(k),i(k,l(k))) to be OPTPROBM(k,l(k),i(k,l(k))) when each z′(k′,l′(k′)) that belongs in the intersection of
PURVAR(k′,l′(k′)) and OPTPROBMPAR(k,l(k),i(k,l(k))) is replaced with RECOPTVAR(k′,1(k′),z′(k′,l′(k′))),
for all k′ in {0, 1, . . . , k−1}
and all l′(k′) in PURL(k′) U PUROL(k′)
and all z′(k′,l′(k′)) in the intersection of
PURVAR(k′,l′(k′)) and
OPTPROBMPAR(k,l(k),i(k, (k))), and

For all k in K such that MIXOL(k) is not vacuum and all l(k) in MIXOL(k),

define each RECOPTPROBM(k,l(k)) to be OPTPROBM(k,l(k), when each z′(k′,l′(k′)) that belongs in the intersection of PURVAR(k′,l′(k′)) and OPTPROBMPAR(k,l(k)) is replaced with RECOPTVAR(k′,l(k′),z′(k′,l′(k′))),
for all k′ in {0, 1, . . . , k−1}
and all l′(k′) in PURL(k′) U PUROL(k′)
and all z′(k′,l′(k′)) in the intersection of
PURVAR(k′,l′(k′)) and OPTPROBMPAR(k,l(k)).

In the subcase in [0072] where there are given optimal measures OPTPROBM(k,l(k),mi(k,l(k))) the optimal measures RECOPTPROBM(k,l(k),mi(k,l(k))) are defined by:
for all k in K such that MIXOL(k) and MIXI(k,l(k)) are not vacuum, and all l(k) in MIXOL(k) such that MIXI(k,l(k) is not vacuum, and all mi(k,i(k)) in MIXI(k,l(k)),
each RECOPTPROBM(k,l(k),mi(k,l(k))) is defined to be OPTPROBM(k,l(k),mi(k,l(k)))
when each z′(k′,l′(k′)) that belongs in the intersection of PURVAR(k′,l′(k′)) and
OPTPROBMPAR(k,l(k),mi(k,l(k))) is replaced with RECOPTVAR(k′,l(k′),z′(k′,l′(k′))),
   for all k′ in {0, 1, . . . , k−1}
   and all l′(k′) in PURL(k′) U PUROL(k′)
   and all z′(k′,l′(k′)) in the intersection of
   PURVAR(k′,l′(k′)) and
   OPTPROBMPAR(k,l(k),mi(k,l(k))).

The Recursive Optimal Solution of a C-Game in MRS.

An optimal quantity calculated by the mixed recursive solution method is called Mixed Recursive Solution optimal quantity or briefly MRS optimal quantity.

We assume a set of functions F(i) is given, for all i in I, where each F(i) depends on variables that belong in a subset VARF(i) of VARS. These functions can be considered as the payoff of c-coalition M(i) in the MRS method.

Define the functions RECF(i) to be the functions F(i) when each z(k,l(k)) in the intersection of VARF(i) and PURVAR(k,l(k)) is replaced with RECOPTVAR(k,l(k),z(k,l(k))) for all k in K and all l(k) in PURL(k) U OL(k) and all Z(k,l(k)) in the intersection of PURVAR(k,l(k)) and VARF(i).

Define the functions EXPRECF(i) to be the expectations of RECF(i) with respect to the product of all recursive optimal measures. We assume that after the integration is performed EXPRECF(i) does not depend on any variable in VARS.

Define the mixed recursive optimal solution of a c-game to be the set that contains:
a) all MRS optimal pure variables, where a MRS optimal pure variable is defined to be the quantity RECOPTVAR(k,l(k),z(k,l(k))),
b) all MRS optimal measures, where a MRS optimal measure is defined to be either RECOPTPROBM(k,l(k),i(k, (k))) or RECOPTPROBM(k,l(k)) or RECOPTPROBM(k,l(k),mi(k,l(k))) if this exists, and
c) all functions EXPRECF(i), where EXPRECF(i) is defined to be the MRS optimal value of the payoff P(M(i)) of c-coalition M(i) in the c-game.

Since from F(i) are derived the optimal payoffs in the c-game by the recursive method, F(i) are considered to be expressions that contain quantities in the subproblems, for example OPTVAR(k,l(k), z(k,l(k))), z(k,l(k)), OPTPAY(k,l(k), i(k,l(k)), PAY(k,l(k), i(k,l(k)) etc, and these subproblem payoffs can be expressions of the payoffs P(M(i)).

The MRS method provides MRS optimal values, either pure or mixed, for all variables in VARS. If P(M(i)) depend on variables that are controlled by c-coalitions that do not belong in the set {M(i): i in I}then these variables are considered as parameters not determined by the MRS method.

The Pure Recursive Optimal Solution.

In case all subproblems of the MRS are of the same kind, the recursive solution is called pure recursive solution.

For example if only GPURL(k) is non vacuum and the rest subsets of L(k) in [0053] are vacuum the recursive method is called pure recursive solution with pure game type subproblems.

The Solution Concepts of C-Games.

If the set of steps K is an one element set and there is only one subproblem, thus L(k) is also an one element set, and the payoffs P(k,l(k),i(k,l(k))) in this unique subproblem can be the payoffs P(M(i)) in case of Nash or empirical type subproblem or P(k,l(k)) can be P(M(i)) in case of simple subproblem or P(k,l(k)) can be a function of P(M(i)) and P(M(ci)), for example P(M(i))−P(M(ci)), in case of a game subproblem, and the functions F(i) are the payoffs P(M(i)),

then the mixed recursive solution is called a solution concept.

So we obtain the game type solution concepts if the subproblem is a zero sum game with its solutions, the Nash type solution concepts if the subproblem is a Nash game with its Nash equilibrium solutions. Similarly we obtain the simple solution concepts, the empirical solution concept and the subcases of upper empirical, lower empirical, game empirical, Nash empirical and the subcases of pure and mixed solution concepts.

The C1-Subgames Case in MRS.
a) A case of importance is when all (k,l(k))-subproblems are C1(a)-subgames that have as root an e-game a of order k of the c-game that is not a leaf and realizations

A(j′(a))=(a,b(j′(a))),j′(a) in a set J′(a),
where b(j′(a)) are e-games of order k+1 in the c-game such that the c-changes ((a, b(j′(a)))) exist in the c-game and the index j′(a) numbers all e-games b(j′(a)) of order k+1 connected to e-game a by a c-change.
It is assumed that there exists a one to one map from L(k) onto the set of e-games of order k that are not leaves, thus each e-game a of order k can be written as a(k,l(k)).
b) In a subcase of (a) the parameter sets in (k,l(k))-subproblems consist of the time t0(a) the differential game in the root e-game a of the C1(a)-subgame begins.
c) A subcase of (a) is when the payoffs of each c-coalitions are as in [0037]

P(M(i))=SUM SIG(j)P(M(i),A(j))
where the c-game is

{A(j):j belongs in J}
and each realization is given by

A(j)=(a(j,0),a(j,1), . . . ,a(j,k), . . .

and

P(M(i),A(j))=SUM P(M(i),a(j,k))
and where the payoffs P(k,l(k),i(k,l(k))) and P(k,l(k)) in the recursive solution contain as arguments functions P(M(i),a(j,k)).
d) A subcase of (c) is when the payoffs PAY(k,l(k),i(k,l(k))) in a (k,l(k))-problem related to the C1(a)-subgame with root an e-game a of order k are defined as follows:
   d.1) The (k,l(k))-subproblem is on the C1(a)-subgame with realizations

A(j′)=(a,b(j′)),j′ in a set J′,
where j′ and J′ denote the j′(a) and J′(a) in subparagraph (a) of the present paragraph.
   Define the payoff of c-coalition i in the C1(a)-subgame in case i belongs in I(k,l(k)) and a is the a(k,l(k)) e-game to be

P(M(i),k,l(k))=SUM SIG(j′)P(M(i),A(j′))
where the sum is over all j′ in J′, and

P(M(i),A(j′))=P(M(i),a)+P″(M(i),b(j′))
where P(M(i), a) is the given payoff of M(i) in e-game a and P″ (M(i), b(j′)) can be one of the following two:
d.1.1) the payoff P(M(i), b(j′)) of M(i) in e-game b(j′) if b(j′) is a leaf, and
d.1.2) a function of optimal quantities of C1-subgames with root of order larger than k that depend on parameters that belong in VAR(k″) where k″ is equal or smaller than k.
   Define the optimal payoff OPTP(M(i), k,l(k))) of c-coalition i in the C1(a)-subgame, in case i belongs in I(k,l(k)), to be the value of P(M(i), k,l(k)) when its variables take the optimal values obtained by solving the (k,l(k))-subproblem if it contains pure variables, or the expected value of P(M(i), C1(a))) with respect to the optimal measures if it contains mixed variables or the expectation of the value of P(M(i), C1(a))) when pure variables take their optimal values if the problem contains both pure and mixed variables.
   A choice for the function in (d.1.2) can be the optimal payoff of M(i) in the subproblem of the C1-game with root b(j′) of order k+1, if i belongs in I(k+1,l(k+1)) where l′(k+1) is the index value in L(k) assigned to the subproblem with root the e-game b(j′).
   Since the payoffs P(M(i), k, l(k)) and OPTP(M(i), k, l(k)) can be used to define payoffs PAY(k,l(k)), PAY(k,l(k),i(k,l(k))) and PAY(k,l(k),oi(k,l(k))) in the MRS, we assume P(M(i), k, l(k)) and OPTP(M(i), k, l(k)).depend on variables in such way that the properties of the sets of variables and parameters of subproblem payoffs remain valid.
d.2) if l(k) belongs in NL(k) U EL(k) and if i belongs in I(k,l(k)) then the payoff PAY(k,l(k),i(k,l(k))) is defined to be a function of P(M(i′), k, l(k)) where i′belongs in I(k,l(k)). A simple choice is

PAY(k,l(k),i(k,l(k)))=P(M(i),k,l(k)).
d.3) if l(k) belongs in SL(k) the payoff PAY(k,l(k)) is defined to be a function of P(M(i′), k, l(k)) where i′ belongs in I(k,l(k)).
   A simple choice is

PAY(k,l(k))=P(M(i),k,l(k)).
d.4) if l(k) belongs in GL(k) the payoff PAY(k,l(k)) is defined to be a function of P(M(i′), k, l(k)) where i′ belongs in I(k,l(k)).
   A simple choice is

PAY(k,l(k))==P(M(i),k,l(k))−P(M(ci),k,l(k)).
where ci is the element in I(k,l(k))\{i}.
d.5) if l(k) belongs in OL(k) and if oi(k,l(k)) belongs in OI(k,l(k)) then the payoff PAY(k,l(k),oi(k,l(k))) is defined to be a function of P(M(i′), k,l(k)) where i′ belongs in I(k,l(k)).A simple choice is

$$OI ( k , l ( k ) ) = I ( k , l ( k ) )$$

$$\begin{matrix}PAY ( k , l ( k ) , oi ( k , l ( k ) ) ) = PAY ( k , l ( k ) , i ( k , l ( k ) ) ) \\ = P ( M ( i ) , k , l ( k ) ) .\end{matrix}$$

d.6) the functions F(i) can be defined by

F(i)=P(M(i),0,l(0)),
if P(M(i), 0,l(0)) is defined as in (d.1), and if i belongs in I(0,l(0)) and the C1(a)-subgame is the one where a is the e-game of order zero a(0) (the root of the tree), and
F(i) are defined as in [0076] if i does not belong in I(0,l(0)) and the C1(a)-subgame is the one where a is the e-game of order zero a(0).
e) A simple variation of the case in (d) is the case where
   e.1) the (k,l(k))-subproblem is a C1(a)-subgame with root an e-game a of order k when a is not a leaf and this subproblem is formulated as in the previous case (d), and
   e.2) the (k,l(k)) subproblem is game or an optimization problem on the e-game a of order k when a is a leaf (for example the Isaacs game of the differential game in the e-game a).

One can consider the case where a c-game can be solved by MRS and another method and the optimal values of the pure variables, the optimal measures and the optimal payoff values are identical in both methods.

As an example consider the case of a pure recursive method where all subproblems are pure Nash problems and also the c-game can be solved by formulating and solving a single Nash game with payoffs P(M(i)). If one can prove that for a class of c-games the two methods give the same results then one can consider the recursive method as an easier, regarding calculations, version of the Nash game method. But in general recursive solutions, as defined by MRS, can stand by themselves.

The Cooperative Solutions.

Given a set of players N and a characteristic function HAR that assigns a number HAR(M) to each subset M of N, one can formulate cooperative solutions, for example stable sets, core etc. The theory of c-games can be used to define this characteristic function by assigning to a subset M the optimal payoff of c-coalition M in a particular c-game.

1. I claim a method called c-games, said method is a generalization of the theory of differential games, said method can be applied in cases where more than two players take part in a differential game and these players can form and change coalitions, said method comprises of:
a set called set of all players and all its subsets, and
a set called set of all c-games;
wherein a c-game comprises of:
a set N called set of players that take part in the c-game,
a partition of N into disjoint subsets none of which is the vacuum set, said partition is called set of c-coalitions in the c-game and each subset M that belongs in the partition is called a c-coalition,
an element called algebraic c-game,
a set VAR, called set of variables in the c-game, a domain wherein the elements of the set VAR take values and a set of subsets DCT(j) of the domain DCT wherein c-times take values,
a family of non vacuum subsets VARS(M) of VAR,
wherein for each c-coalition M in the set of c-coalitions in the c-game there exists one and only one subset VARS(M) of VAR, said subset VARS(M) is called set of variables controlled by the c-coalition M, and
wherein VAR=U VARS(M), wherein the union is over all c-coalitions M,
a family of functions P(M)
wherein M takes all values in the set of all c-coalitions,
wherein for each M there exists one and only one function P(M),
wherein each P(M) depends on a set VARP(M) of variables, said set is a subset of VAR,
wherein VAR=U VARP(M), wherein the union is over all c-coalitions M, and
wherein each P(M) is called payoff of the c-coalition M in the c-game, and
an axiom;
wherein an algebraic c-game comprises of:
elements called e-games,
an ordered tree structure, and
elements called realizations;
wherein an e-game, denoted by a, comprises of:
a subset N1(a) of the set N, said subset is different from the vacuum set and is called set of maximizers in the e-game a,
a subset N2(a) of the set N, said subset is different from the vacuum set and furthermore N1(a) and N2(a) have no elements in common, said subset N2(a) is called set of minimizers in the e-game,
the set of players that take part in the e-game a, said set is defined to be the union N1(a) U N2(a),
a set ADN(a), wherein ADN(a) is a subset of N1(a) U N2(a),
a set NIN(a), wherein NIN(a) is a subset of N1(a) U N2(a), and
a differential game as formulated by
Isaacs and others, said game contains:
two sets of functions
Φ(t)={φ1(t), . . . ,φp(t)}
and
Ψ(t)={ψ1(t), . . . ,ψq(t)},
and their union called set of control function variables of the differential game,
a payoff function
P(Φ(t),Ψ(t))==∫(G(X(t),Φ(t),Ψ(y)))dt+H
called the Isaac's payoff,
a method used to obtain optimal values for the control function variables, said method is called Isaacs solution concept and is written in the symbolic language of game theory as
$${max}_{Ψ ( t )} \qquad {min}_{Φ ( t )} P ( Φ ( t ) , Ψ ( t ) ) , and$$
the value function defined by
$$V = \begin{matrix}{max}_{Ψ ( t )} & {min}_{Φ ( t )} P ( Φ ( t ) , Ψ ( t ) ) ;\end{matrix}$$
wherein the ordered tree is defined by:
each vertex of the ordered tree is an e-game in the algebraic c-game, each e-game in the algebraic c-game is a vertex in the tree and the edges are called c-changes,
wherein each c-change, denoted by ((a,b)), consists of an ordered pair of e-games a, b that satisfies the following:
the differential game in the e-game a is interrupted at time t(a,b), said time is called c-time of the c-change ((a,b)),
the differential game in the e-game b begins at time t(a,b), and
the set
{{N1(a),N2(a)},{N1(b),N2(b)}}
is an e-coalition change, wherein an e-coalition change is defined by:
N1(a) is the set of maximizers in e-game a,
N2(a) is the set of minimizers in e-game a,
N1(b).is the set of maximizers in e-game b,
N2(b) is the set of minimizers in e-game b,
there exists a set A1(a) which is a subset of N1(a),
there exists a set A2(a) which is a subset of N1(a), said A2(a) has no element in common with A1(a),
there exists a set B1(a) which is a subset of N2(a),
there exists a set B2(a) which is a subset of N2(a), said B2(a) has no element in common with B1(a),
there exists a subset D1(b) of N, said subset has no element in common with the set N1(a) U N2(a),
there exists a subset D2(b) of N, said subset has no element in common with the set N1(a) U N2(a) and furthermore has no element in common with D1(a),
the set N1(b) is equal to the set
(N1(a)\(A1(a)UA2(a)))UB2(a)UD1(a)
and the set N2 (b) is equal to the set
(N2(a)\(B1(a)UB2(a)))UA2(a)UD2(a);
wherein the realizations are defined in the following:
there is a unique e-game a(0) called root and e-game of order zero,
there exist at least one c-change wherein the e-game a(0) is the first e-game in the ordered pair in the c-change,
the set of all c-changes wherein a(0) is the first e-game in the ordered pair is called C1(a(0))-subgame,
an e-game that is the second element in the ordered pair in a c-change wherein the first element is the e-game a(0) is called e-game of order 1,
if a is an e-game of order n and the c-change ((a,b)) exists then the e-game b is called e-game of order n+1, wherein n is an ordinal,
an e-game is called a leaf if there exist no c-change wherein said e-game is the first element in the ordered pair,
the set of all c-changes that contain an e-game a as first element is called a C1(a)-subgame,
if the c-change ((a,b)) exist in the C1(a)-subgame then the ordered pair (a,b) is called a realization in the C1(a)-subgame,
a realization A is a sequence of e-games
a(0),a(1), . . . ,a(n),a(n+1), . . . ,a(nmax)),
wherein the first element of this sequence is the root a(0),
wherein the last element a(nmax) is a leaf,
wherein the e-game a(n) is of order n, and
wherein if a(n) and a(n+1) belong in the realization then there exists a c-change
((a(n),a(n+1))),
the realizations in a c-game can be numbered and can be written in the form
A(j)==(a(j,0),a(j,1), . . . ,a(j,n), . . . ,a(j,n(j)),
wherein the e-game a(j,n) is of order n, and
wherein n(j) is an ordinal such that the order of any e-game in the realization is smaller or equal than n(j), said n(j) depends on j, wherein j is an ordinal,
a c-game is said to be in realization form if its realizations are written in the form
A(j)=(a(j,0),a(j,1), . . . ,a(j,n(j)))
and the c-game in realization form can be written as the set
{A(j):j in J}
wherein J can be an interval of ordinals
{1,2, . . . ,MAXJ}, and
a c-game is said to be in tree form if its realizations are written in the form
(a(0),a(v(1),1), . . . ,a(v(n−1),n−1),a(v(n),n), . . . )
wherein v(n) belongs an index set V(n, v(n−1)), said index set numbers all e-games of order n that belong in the C1(a(v(n−1),n−1)-subgame;
wherein the set VAR consists of:
all elements of the set CT of all c-times, said set is defined to be
CT=U{t(a,b)},
wherein t(a,b) is the c-time of the c-change ((a, b)), and
wherein the union is over all c-changes in the tree in the algebraic c-game in the c-game,
all elements of the set ADVAR, said set is called set of all additional variables, said set is defined to be
ADVAR=UADVAR(a),
wherein the union is over all e-games a in the algebraic c-game, and
wherein ADVAR(a) is a set called the set of all additional variables of the e-game a, said set it is assumed it exists, and
all elements of the set NIVAR, said set is called set of all non-isaacs function variables, said set is defined by
NIVAR=UNIVAR(a),
wherein the union is over all e-games a in the algebraic c-game in the c-game,
wherein each NIVAR(a) is defined to be a subset of the set of control function variables of the differential game in the e-game a,
wherein the elements of each NIVAR(a) are considered as variables and their value needs to be determined along with the other variables in the c-game, and
wherein the control function variables in the differential game in the e-game a that do not belong in NIVAR(a) take the values obtained by solving the differential game in the e-game a using the Isaacs solution concept, said values may depend on parameters;
wherein the domain of the variables in VAR contains the domain DCT in which the c-times take values, said DCT is defined by the inequalities
t(a(j,n),a(j,n+1))<t(a(j,n+1),a(j,n+2))
for all n such that a(j,n), a(j,n+1)) and a(j,n+2) belong, in A(j) and all j in J, and
t0(a(j,n))<t(a(j,n),a(j,n+1))<t1(a(j,n))
for all n such that a(j,n) and a(j,n+1)) belong in A(j) and all j in J,
wherein t(a(j,n), a(j,n+1)) is the c-time of the c-change ((a(j,n), a(j,n+1)))
wherein t0(a(j,n)) is the time the differential game in e-game a(j,n) begins, and this time is a c-time if n is larger than 0, and t1(a(j,n)) is the time the differential game in e-game a(j,n) ends if it is not interrupted,
wherein A(j) is the realization
(a(j,0),a(j,1), . . . ,a(j,n), . . . ),
wherein the c-game is written in realization form as the set
{A(j):j in J}, and
wherein some of the inequality relations can be strict inequality relations and others can be equal or smaller relations and the choice of what type of inequalities will be used depends on the exact mathematical formulation of the solution method of the c-game and on whether the differential games in all e-games in a realization will be certainly played or not;
wherein one can define subsets DCT(j) of the domain DCT and construct a one to one onto map between the set of all DCT(j) and the set of all realizations A(j), said subset DCT(j) that corresponds to realization A(j) is defined by the inequalities
t(a(j,n),a(j,n+1))<t(a(j,n+1),a(j,n+2))
for all n such that a(j,n), a(j,n+1)) and a(j,n+2) belong in A(j),
t0(a(j,n))<t(a(j,n),a(j,n+1))<t1(a(j,n))
for all n such that a(j,n) and a(j,n+1)) belong in A(j), and
t(a(j,n),a(j,n+1))<t(a(j,n),a(x(j,n)))
for all n such that a(j,n) and a(j,n+1)) belong in A(j) and all x(j,n) in a set X(j,n),
wherein A(j) is the realization
(a(j,0),a(j,1), . . . ,a(j,n), . . . ),
wherein the c-game is written in realization form as the set
{A(j):j in J}, and
wherein a(x(j,n)) is the second e-game in a realization
A(x(j,n))=(a(j,n),a(x(j,n))
of the C1(a(j,n))-subgame with root the e-game a(j,n)) wherein the index x(j,n) numbers all realizations of the C1(a(j,n))-subgame except (a(j,n), a(j,n+1));
wherein each VARS(M) consists of:
all elements of the subset CT(M) of the set CT of all c-times, said subset is called set of c-times controlled by c-coalition M, said subset consists of c-times t(a,b) that satisfy:
the union of the sets
A1(a), A2(a), B1(a), B2(a),
D1(b), D2(b), ADN(b) and NIN(b)
has at least one element in common with M,
all elements of the subset ADVAR(M) of the set ADVAR, said subset is called the set of additional variables controlled by the c-coalition M, said subset consists of additional variables z that satisfy:
if z belongs in ADVAR(M) then
there exists an e-game a in the algebraic p-game and a subset ADVAR(M,a) of the set ADVAR(a) such that z belongs in ADVAR(M,a), said ADVAR(N,a) is called set of additional variables in e-game a controlled by c-coalition M, and
the set M has at least one element in common with ADN(a), and
all elements of the subset NIVAR(M) of the set NIVAR, said subset called the set of non-isaacs function variables controlled by c-coalition M, said subset consists of non-isaacs function variables f that satisfy:
if f belongs in NIVAR(M) then there exists an e-game a in the algebraic c-game and a subset NIVAR(M,a) of the set NIVAR(a) such that f belongs in NIVAR(M,a), said NIVAR(M,a) is called set of non-isaacs function variables in e-game a controlled by c-coalition M, and
the set NIN(a) has at least one element in common with M; and
wherein the axiom states that in any c-game, written in realization form as
{A(j):j in J},
only the differential games in the e-games a(j,n) that belong in one and only one realization
A(j)==(a(j,0),a(j,1), . . . ,a(j,n), . . . ,a(j,n(j)))
will be played and in that case we say the realization A(j) is played or players choose to play play realization A(j),
wherein a(j,n(j)) is the e-game in A(j) that has order n(j) larger than the order of any other e-game in A(j),
wherein j is one element in a set J, wherein J can be chosen to be an interval of ordinals {1, 2, . . . , MAXJ}, and
wherein furthermore:
if t(a(j,0), a(j,1)) is larger than t0(a(j,0)) then
if t(a(j,0), a(j,1)) is smaller than
t1(a (j, 0))
then
the differential game in e-game a(j,0) will be played first from the time t0(a(j,0)) until the c-time t(a(j,0), a(j,1)), wherein t0(a(j,0)) is the time the differential game in e-game a(j,0) begins, and
if t(a(j,0), a(j,1)) is equal to t1(a(j,0)) then the differential game in e-game a(j,0) will be played first from time t0(a(j,0)) until the time t1(a(j,0)) when the differential game in e-game a(j,0) and the c-game end, wherein t1(a(j,0)) is the time the differential game in e-game a(j,0) ends,
if t(a(j,0), a(j,1)) is equal to t0(a(j,0)) then
the differential game in the root a(j,0) will not be played,
if t(a(j,n), a(j,n+1)) is different from t(a(j,n+1), a(j,n+2)) for some n smaller than n(j)−1
then
the differential game in e-game a(j,n+1) will be played,
if n is smaller than n(j)−1 and if the differential game in e-game a(j,n) is played then
if t(a(j,n), a(j,n+1)) is equal to t1(a(j,n)) then
the differential game in e-game a(j,n) will be played until the time t1(a(j,n)) when the differential game in e-game a(j,n) and the c-game end, wherein t1(a(j,n)) is the time the differential game in e-game a(j,n) ends and
if t(a(j,n), a(j,n+1)) is smaller than t1(a(j,n))
then
at time t(a(j,n), a(j,n+1)) a c-change will happen and
if t(a(j,n), a(j,n+1)) is different from t(a(j,n+1), a(j,n+2))
then
the differential game in e-game a(j,n+1) will be played from the time t(a(j,n), a(j,n+1)) until the time t(a(j,n+1), a(j,n+2)) and
if t(a(j,n), a(j,n+1)) is equal to t(a(j,n+1), a(j,n+2))
then
the differential game in e-game a(j,n+1) will not be played, and
if n is equal to n(j)-1 and if the differential game in e-game a(j,n(j)−1) is played
then
if t(a(j,n(j)-1), a(j,n(j))) is equal to t1(a(j,n(j)-1))
then
the differential game in e-game a(j,n(j)-1) will be played until the time
t1(a(j,n(j)−1)) when the differential game in e-game a(j,n(j)−1) and the c-game end, wherein t1(a(j,n(j)−1)) is the time the differential game in e-game a(j,f(j)-1) ends and
if t(a(j,n(j)−1), a(j,n(j))) is smaller than t1(a(j,n(j)-1))
then
at time t(a(j,n(j)−1),a(j,n(j))) a c-change will happen and the differential game in e-game a(j,n(j)) will be played from the time t(a(j,n(j)−1), a(j,n(j))).until the time t1(a(j,n(j))), wherein t1(a(j,n(j))) is the time the differential game in e-game a(j,n(j)) and the c-game end.

2. The method of claim 1 wherein furthermore
all c-changes ((a, b)) in the c-game satisfy:
N1(a)=N1(b)) [symbol] (N2(a)=N2(b)) is not true,
wherein ( [symbol] ) is the logical conjunction symbol.

3. The method of claim 1 wherein furthermore
the set of variables VAR consists of c-times.

4. The method of claim 1 wherein furthermore
at least one variable in VAR takes discrete values.

5. The method of claim 1 wherein furthermore
the payoff P(M) of at least one c-coalition M satisfies the following:
if P(M) depends on a c-time t that is a c-time in C1(a)-subgame, for some e-game a in the c-game, then P(M) depends on all c-times in the C1(a)-subgame, and
the function P(M) depends only on the minimum value of the c-times in the C1(a)-subgame.

6. The method of claim 1 wherein furthermore:
the c-game is written in realization form as
{A(j):j in J}
wherein each realization is given by
A(j)=(a(j,0),a(j,1), . . . ,a(j,n(j))),
the payoff P(M) of a c-coalition M is given by
P(M)=SUM SIG(A(j))P(M,A(j)),
wherein the sum is over all j in J,
wherein each SIG(A(j)) is a function that has the following property:
if realization A(j″) is played
then SIG(A(j)) takes the value zero for all j″ and j in J such that j″ is different from j,
said function can be the characteristic function of the domain DCT(j) that corresponds to realization A(j),
wherein each P(M, A(j)) is a function called payoff of c-coalition M(i) in realization A(j) in the c-game, said function it is assumed it exists for all j in J, and
wherein each P(M, A(j)) is given by
P(M,A(j))=SUM P(M,a(j,n)),
wherein a(j,n) is an e-game of order n in realization A(j),
wherein the sum is over all n in the interval {0, 1, . . . , n(j)}, and
wherein each P(M, a(j,n)) is a function called the payoff of c-coalition M(i) in e-game a(j,n) in the c-game, said function it is assumed it exists for all j in J and all n in {0, 1, . . . , n(j)}.

7. The method of claim 6 wherein furthermore
the c-coalition payoff in an e-game is given by
P(M,a(j,n))=SUM E(a(j,n),m)P(m,a(j,n))
wherein m is a player in M and the sum is over all m in M,
wherein E(a(j,n), m) is a function that has the value 1 if m belongs in N1(a(j,n)), the value −1 if m belongs in N2(a(j,n)) and the value
0 if m does not belong in the union of N1(a(j,n)) and N2(a(j,k)), and
wherein each P(m, a(j,n)) is a function called one player payoff, for player m, in e-game a(j,n), said function it is assumed it exists.

8. The method of claim 7 wherein furthermore
the Isaacs payoff of the differential game in e-game a(j,n) is the sum of one player payoffs P(m, a(j,n)) in a(j,n), wherein the sum is over all m in
N1(a(j,n))UN2(a(j,n)).

9. The method of claim 7 wherein furthermore
the one player payoff in e-game a(j,n) is the value function of the differential game in e-game a(j,n).

10. I claim a method called empirical solutions of c-games, said method is a generalization of the theory of differential games and their solution methods, said method can be applied in cases where more than two players take part in a differential game and these players can form and change coalitions, said method comprises of:
a set called set of all players and all its subsets,
a set called set of all c-games, and
a set called set of empirical solution concepts, said set comprises of:
a set of methods called lower empirical solutions,
a set of methods called upper empirical solutions,
a set of methods called empirical game type solutions, and
a set of methods called empirical Nash type solutions;
wherein a c-game comprises of:
a set N called set of players that take part in the c-game,
a partition of N into disjoint subsets none of which is the vacuum set, said partition is called set of c-coalitions in the c-game and each subset M that belongs in the partition is called a c-coalition,
an element called algebraic c-game,
a set VAR, called set of variables in the c-game, a domain wherein the elements of the set VAR take values and a set of subsets DCT(j) of the domain DCT wherein c-times take values,
a family of non vacuum subsets VARS(M) of VAR,
wherein for each c-coalition M in the set of c-coalitions in the c-game there exists one and only one subset VARS(M) of VAR, said subset VARS(M) is called set of variables controlled by the c-coalition M, and
wherein VAR=U VARS(M), wherein the union is over all c-coalitions M,
a family of functions P(M)
wherein M takes all values in the set of all c-coalitions,
wherein for each M there exists one and only one function P(M),
wherein each P(M) depends on a set VARP(M) of variables, said set is a subset of VAR,
wherein VAR=U VARP(M), wherein the union is over all c-coalitions M, and
wherein each P(M) is called payoff of the c-coalition M in the c-game, and
an axiom;
wherein an algebraic c-game comprises of:
elements called e-games,
an ordered tree structure, and
elements called realizations;
wherein an e-game, denoted by a, comprises of:
a subset N1(a) of the set N, said subset is different from the vacuum set and is called set of maximizers in the e-game a,
a subset N2(a) of the set N, said subset is different from the vacuum set and furthermore N1(a) and N2(a) have no elements in common, said subset N2(a) is called set of minimizers in the e-game,
the set of players that take part in the e-game a, said set is defined to be the union N1(a) U N2(a),
a set ADN(a), wherein ADN(a) is a subset of N1(a) U N2(a)
a set NIN(a), wherein NIN(a) is a subset of N1(a) U N2(a), and
a differential game as formulated by Isaacs and others, said game contains:
two sets of functions
Φ(t)={φ1(t), . . . ,φp(t)}
and
Ψ(t)={ψ1(t), . . . ,ψq(t)},
and their union called set of control function variables of the differential game,
a payoff function
P(Φ(t),Ψ(t))==∫(G(X(t),Φ(t),Ψ(y)))dt+H
called the Isaac's payoff,
a method used to obtain optimal values for the control function variables, said method called Isaacs solution concept and is written in the symbolic language of game theory as
$${max}_{Ψ ( t )} \qquad {min}_{Φ ( t )} P ( Φ ( t ) , Ψ ( t ) ) , and$$
the value function defined by
$$V = \begin{matrix}{max}_{Ψ ( t ) } & {min}_{Φ ( t )} P ( Φ ( t ) , Ψ ( t ) ) ; \end{matrix}$$
wherein the ordered tree is defined by:
each vertex of the ordered tree is an e-game in the algebraic c-game, each e-game in the algebraic c-game is a vertex in the tree and the edges are called c-changes,
wherein each c-change, denoted by ((a,b)), consists of an ordered pair of e-games a, b that satisfies the following:
the differential game in the e-game a is interrupted at time t(a,b), said time is called c-time of the c-change ((a,b)),
the differential game in the e-game b begins at time t(a,b), and
the set
{{N1(a),N2(a)},{N1(b),N2(b)}}
is an e-coalition change, wherein an e-coalition change is defined by:
N1(a) is the set of maximizers in e-game a,
N2(a) is the set of minimizers in e-game a,
N1(b) is the set of maximizers in e-game b,
N2(b) is the set of minimizers in e-game b,
there exists a set A1(a) which is a subset of N1(a),
there exists a set A2(a) which is a subset of N1(a), said A2(a) has no element in common with A1(a),
there exists a set B1(a) which is a subset of N2(a),
there exists a set B2(a) which is a subset of N2(a), said B2(a) has no element in common with B1(a),
there exists a subset D1(b) of N, said subset has no element in common with the set N1(a) U N2(a),
there exists a subset D2(b) of N, said subset has no element in common with the set N1(a) U N2(a) and furthermore has no element in common with D1(a),
the set N1(b) is equal to the set
(N1(a)\(A1(a)UA2(a)))UB2(a)UD1(a)
and the set N2(b) is equal to the set
(N2(a)\(B1(a)UB2(a)))UA2(a)UD2(a);
wherein the realizations are defined in the following:
there is a unique e-game a(0) called root and e-game of order zero,
there exist at least one c-change wherein the e-game a(0) is the first e-game in the ordered pair in the c-change,
the set of all c-changes wherein a(0) is the first e-game in the ordered pair is called C1(a(0))-subgame,
an e-game that is the second element in the ordered pair in a c-change wherein the first element is the e-game a(0) is called e-game of order 1,
if a is an e-game of order n and the c-change ((a,b)) exists then the e-game b is called e-game of order n+1, wherein n is an ordinal,
an e-game is called a leaf if there exist no c-change wherein said e-game is the first element in the ordered pair,
the set of all c-changes that contain an e-game a as first element is called a C1(a)-subgame,
if the c-change ((a,b)) exist in the C1(a)-subgame then the ordered pair (a,b) is called a realization in the C1(a)-subgame,
a realization A is a sequence of e-games
(a(0),a(1), . . . ,a(n),a(n+1), . . . ,a(nmax)),
wherein the first element of this sequence is the root a(0),
wherein the last element a(nmax) is a leaf,
wherein the e-game a(n) is of order n, and
wherein if a(n) and a(n+1) belong in the realization then there exists a c-change
((a(n),a(n+1))),
the realizations in a c-game can be numbered and can be written in the form
A(j)==(a(j,0),a(j,1), . . . ,a(j,n), . . . ,a(j,n(j))),
wherein the e-game a(j,n) is of order n, and
wherein n(j) is an ordinal such that the order of any e-game in the realization is smaller or equal than n(j), said n(j) depends on j, wherein j is an ordinal,
a c-game is said to be in realization form if its realizations are written in the form
A(j)=(a(j,0),a(j,1), . . . ,a(j,n(j)))
and the c-game in realization form can be written as the set
{A(j):j in J}
wherein J can be an interval of ordinals {1, 2, . . . , MAXJ}, and
a c-game is said to be in tree form if its realizations are written in the form
(a(0),a(v(1),1), . . . ,a(v(n−1),n−1),a(v(n),n), . . . )
wherein v(n) belongs an index set V(n, v(n−1)), said index set numbers all e-games of order n that belong in the C1(a(v(n−1),n−1)-subgame;
wherein the set VAR consists of:
all elements of the set CT of all c-times, said set is defined to be:
CT=U{t(a,b)},
wherein t(a,b) is the c-time of the c-change ((a, b)), and
wherein the union is over all c-changes in the tree in the algebraic c-game in the c-game,
all elements of the set ADVAR, said set is called set of all additional variables, said set is defined to be
ADVAR=UADVAR(a),
wherein the union is over all e-games a in the algebraic c-game, and
wherein ADVAR(a) is a set called the set of all additional variables of the e-game a, said set it is assumed it exists, and
all elements of the set NIVAR, said set is called set of all non-isaacs function variables, said set is defined by
NIVAR=UNIVAR(a),
wherein the union is over all e-games a in the algebraic c-game in the c-game,
wherein each NIVAR(a) is defined to be a subset of the set of control function variables of the differential game in the e-game a,
wherein the elements of each NIVAR(a) are considered as variables and their value needs to be determined along with the other variables in the c-game, and
wherein the control function variables in the differential game in the e-game a that do not belong in NIVAR(a) take the values obtained by solving the differential game in the e-game a using the Isaacs solution concept, said values may depend on parameters;
wherein the domain of the variables in VAR contains the domain DCT in which the c-times take values, said DCT is defined by the inequalities
t(a(j,n),a(j,n+1))<t(a(j,n+1),a(j,n+2))
for all n such that a(j,n), a(j,n+1)) and a(j,n+2) belong in A(j) and all j in J, and
t0(a(j,n))<t(a(j,n),a(j,n+1))<t1(a(j,n))
for all n such that a(j,n) and a(j,n+1)) belong in A(j) and all j in J,
wherein t(a(j,n), a(j,n+1)) is the c-time of the c-change ((a(j,n), a(j,n+1)))
wherein t0(a(j,n)) is the time the differential game in e-game a(j,n) begins, and this time is a c-time if n is larger than 0, and t1(a(j,n)) is the time the differential game in e-game a(j,n) ends if it is not interrupted,
wherein A(j) is the realization
(a(j,0),a(j,1), . . . ,a(j,n), . . . ),
wherein the c-game is written in realization form as the set
{A(j):j in J}, and
wherein some of the inequality relations can be strict inequality relations and others can be equal or smaller relations and the choice of what type of inequalities will be used depends on the exact mathematical formulation of the solution method of the c-game and on whether the differential games in all e-games in a realization will be certainly played or not;
wherein one can define subsets DCT(j) of the domain DCT and construct a one to one onto map between the set of all DCT(j) and the set of all realizations A(j), said subset DCT(j) that corresponds to realization A(j) is defined by the inequalities
t(a(j,n),a(j,n+1))<t(a(j,n+1),a(j,n+2))
for all n such that a(j,n), a(j,n+1)) and a(j,n+2) belong in A(j),
t0(a(j,n))<t(a(j,n),a(j,n+1))<t1(a(j,n))
for all n such that a(j,n) and a(j,n+1)) belong in A(j), and
t(a(j,n),a(j,n+1))<t(a(j,n),a(x(j,n)))
for all n such that a(j,n) and a(j,n+1)) belong in A(j) and all x(j,n) in a set X(j,n);
wherein A(j) is the realization
(a(j,0),a(j,1), . . . ,a(j,n), . . . ),
wherein the c-game is written in realization form as the set
{A(j):j in J}, and
wherein a(x(j,n)) is the second e-game in a realization
A(x(j,n))=(a(j,n),a(x(j,n))
of the C1(a(j,n))-subgame with root the e-game a(j,n)) wherein the index x(j,n) numbers all realizations of the C1(a(j,n))-subgame except (a(j,n), a(j,n+1));
wherein each VARS(M) consists of:
all elements of the subset CT(M) of the set CT of all c-times, said subset is called set of c-times controlled by c-coalition M, said subset consists of c-times t(a,b) that satisfy:
the union of the sets
A1(a), A2(a), B1(a), B2(a),
D1(b), D2(b), ADN(b) and NIN(b)
has at least one element in common with M,
all elements of the subset ADVAR(M) of the set ADVAR, said subset is called the set of additional variables controlled by the c-coalition M, said subset consists of additional variables z that satisfy:
if z belongs in ADVAR(M) then
there exists an e-game a in the algebraic c-game and a subset ADVAR(M,a) of the set ADVAR(a) such that z belongs in ADVAR(M,a), paid ADVAR(N,a) is called set of additional variables in e-game a controlled by c-coalition M, and
the set M has at least one element in common with ADN(a), and
all elements of the subset NIVAR(M) of the set NIVAR, said subset called the set of non-isaacs function variables controlled by c-coalition M, said subset consists of non-isaacs function variables f that satisfy:
if f belongs in NIVAR(M) then there exists an p-game a in the algebraic c-game and a subset NIVAR(M,a) of the set NIVAR(a) such that f belongs in NIVAR(M,a), said NIVAR(M,a) is called set of non-isaacs function variables in e-game a controlled by c-coalition M, and
the set NIN(a) has at least one element in common with M;
wherein the axiom states that in any c-game, written in realization form as
{A(j):j in J}
only the differential games in the e-games a(j,n) that belong in one and only one realization
A(j)==(a(j,0),a(j,1), . . . ,a(j,n), . . . ,a(j,n(j)))
will be played and in that case we say the realization A(j) is played or players choose to play play realization A(j),
wherein a(j,n(j)) is the e-game in A(j) that has order n(j) larger than the order of any other e-game in A(j),
wherein j is one element in a set J, wherein J can be chosen to be an interval of ordinals {1, 2, . . . , MAXJ}, and
wherein furthermore:
if t(a(j,0), a(j,1)) is larger than t0(a(j,0)) then
if t(a(j,0), a(j,1)) is smaller than
t1(a (j, 0))
then
the differential game in e-game a(j,0) will be played first from the time t0(a(j,0)) until the c-time t(a(j,0), a(j,1)), wherein t0(a(j,0)) is the time the differential game in e-game a(j,0) begins, and
if t(a(j,0), a(j,1)) is equal to t1(a(j,0)) then the differential game in e-game a(j,0) will be played first from time t0(a(j,0)) until the time t1(a(j,0)) when the differential game in e-game a(j,0) and the c-game end, wherein t1(a(j,0)) is the time the differential game in e-game a(j,0) ends,
if t(a(j,0), a(j,1)) is equal to t0(a(j,0)) then
the differential game in the root a(j,0) will not be played,
if t(a(j,n), a(j,n+1)) is different from t(a(j,n+1), a(j,n+2)) for some n smaller than n(j)−1
then
the differential game in e-game a(j,n+1) will be played,
if n is smaller than n(j)−1 and if the differential game in e-game a(j,n) is played then
if t(a(j,n), a(j,n+1)) is equal to t1(a(j,n)) then
the differential game in e-game a(j,n) will be played until the time t1(a(j,n)) when the differential game in e-game a(j,n) and the c-game end, wherein t1(a(j,n)) is the time the differential game in e-game a(j,n) ends and
if t(a(j,n), a(j,n+1)) is smaller than
t1(a(j,n))
then
at time t(a(j,n), a(j,n+1)) a c-change will happen and
if t(a(j,n), a(j,n+1)) is different from t(a(j,n+1), a(j,n+2))
then
the differential game in e-game a(j,n+1) will be played from the time t(a(j,n), a(j,n+1)) until the time t(a(j,n+1), a(j,n+2)) and
if t(a(j,n), a(j,n+1)) is equal to t(a(j,n+1), a(j,n+2))
then
the differential game in e-game a(j,n+1) will not be played, and
if n is equal to n(j)-1 and if the differential game in e-game a(j,n(j)−1) is played
then
if t(a(j,n(j)-1), a(j,n(j))) is equal to t1(a(j,n(j)−1))
then
the differential game in e-game a(j,n(j)−1) will be played until the time t1(a(j,n(j)−1)) when the differential game in e-game a(j,n(j)−1) and the c-game end, wherein t1(a(j,n(j)−1)) is the time the differential game in e-game a(j,n(j)−1) ends and
if t(a(j,n(j)−1), a(j,n(j))) is smaller than t1(a(j,n(j)−1))
then
at time t(a(j,n(j)−1),a(j,n(j))) a c-change will happen and the differential game in e-game a(j,n(j)) will be played from the time t(a(j,n(j)−1), a(j,n(j))) until the time t1(a(j,n(j))), wherein t1(a(j,n(j))) is the time the differential game in e-game a(j,n(j)) and the c-game end;
wherein a lower empirical solution comprises of:
a c-game with at least two c-coalitions, said c-game consists of e-games of order smaller or equal to 1, said c-game can be written in realization form as
{A(j):j in J},
wherein each realization can be written as
A(j)=(a0,a1(j)
wherein a0 is the first e-game and a1(j) is the second e-game in the realization, wherein J can be an interval {1, 2, . . . , Jmax},
a particular subset of the set of c-coalitions in the c-game, said subset consists of c-coalitions M(i2) wherein i2 takes all values in a set I2,
the payoffs P(M(i2)) of M(i2), for all i2 in 12,
the sets of variables VARS(M(i2)) controlled by the c-coalitions M(i2), for all i2 in 12, wherein furthermore it is assumed that each set VARS(M(i2)) consists of c-times, for all i2 in I2, and
the formulation of a problem called lower empirical problem and its solutions, said problem and solutions comprise of:
all c-times T(j)=t(a0, a1(j)) in the c-game and the vector c-time variable
T=(T(1),T(2), . . . ,T(Jmax)
that takes values in the cube
CUBE=X[to(a0),t1(a0)],
wherein t0(a0) is the time the differential game in e-game a0 begins and t1(a0) the time the differential game in e-game a0 ends if it is not interrupted,
wherein [to(a0), t1(a0)] is the closed time interval that begins at to(a0) and ends at t1(a0),
wherein X denotes the cartesian product, and
wherein the dimension of the cube is Jmax, the subsets J(i2) of J,
wherein each J(i2) contains at least one element,
wherein for each i2 in 12 there exists a J(i2), and
wherein each J(i2) is defined by:
j belongs in J(i2) if
the c-coalition M(i2)
controls the c-time T(j),
the subsets I2(j) of I2,
wherein each I2(j) contains at least one element,
wherein for each j in J there exists a I2(j), and
wherein each I2(j) is defined by:
i2 belongs in I2(j) if
the c-coalition M(i2)
controls the c-time T(j),
a method called main lower empirical solution, said method comprises of the steps:
use the following notation, said notation is introduced to make the formulas simpler,
denote (i2) by (i),
denote (I2) by (I),
denote (I2(j)) by (I(j)),
denote (J(i2) by (J(i)),
denote (P(M(i2))) by(Pi),
denote (Pi) by (Si(j)) if realization j is chosen and j belongs in J(i),
denote (Pi) by (Qi(j)) if realization j is chosen and j belongs in J\J(i),
denote the value of Pi when the c-time vector T takes a particular value and realization j is chosen by (Pi(j,T)),
denote the value of Si(j) when the c-time vector T takes a particular value by (Si(j,T)) and
denote the value of Qi(j) when the c-time vector T takes a particular value by (Qi(j,T)),
consider two points (t,i) and (t′,i′) in
[to(a0),t1(a0)]×J,
wherein [to(a0), t1(a0)]×J denotes the cartesian product of the sets [to(a0), t1(a0)] and J, and define a binary relation called LOWBETTER by
(t,j) is LOWBETTER than (t′,j′)
if RLOW is true,
wherein RLOW is the logical proposition defined by the propositions:
R1=(t<t′)
R21=(there exists T in CUBE),
R22=(there exists T′ in CUBE),
R23=(there exists j in J)
R24=(there exists j′ in J)
R2= [symbol] R22 [symbol] R23 [symbol] R24
R3=(min T=T(j)) [symbol] (T(j)=t)
R4=(min T′=T′(j′)) [symbol] (T′(j′)=t′),
R5=(Si(j,T)≧Pi(j′,T′),
for all i in I(j)),
R61=(there exists j″ in J),
R62=(there exists T″ in CUBE
R63=(min T″=T″(j″)) [symbol] (T″(j″)=t),
R6=R61 [symbol] R62 [symbol] R63
R7=(I(j)∩(j″)=Ø),
R8=(Qi(j,T)≧Pi(j′,T′)
for all i in I(j″)),
R9=(Si(j,T)>Qi(j″, T″),
for all i in I(j)),
R101=(there exists j′″ in J
R102=(there exists T′″ in CUBE),
R103=(min T′″=T′″(j′″)) [symbol] (T′″(j′″)=t),
R10=R101 [symbol] R102 [symbol] R103,
R11=((I(j)∩(j′″))≠Ø),
R12=(Si(j,T)≧Pi(j′,T′),
for all i in (I(j)∩(j′″))),
R13=(Qi(j,T)≧Pi(j′,T′), for all i
in I(j′″)\(I(j)∩(j′″))),
R14=(Si(j,T)>Qi(j′″, T′″), for all i in I(j)\(I(j)∩I(j′″))),
R15=R1 [symbol] R2 [symbol] R3 [symbol] R4
R16=R5,
R17=R6 [symbol] R7 [symbol] R8 [symbol] R9
R18=R10 [symbol] R11 [symbol] R12 [symbol] R13 [symbol] R14
and
RLOW=R15 [symbol] (R16 [symbol] (R17 [symbol] R18)),
wherein (≠) denotes (not equal to), (≧) denotes (greater than or equal to), (>) denotes (greater than), (Ø) denotes the vacuum set, (∩) is the intersection of two sets symbol, (\) is the difference of two sets symbol, ( [symbol] ) is the logical conjunction symbol and ( [symbol] ) is the logical disjunction symbol,
consider a point (t′,i′) in
[to(a0),t1(a0)]×J
and define a relation called HASNOLOWBETTER by:
(t′, j′) HASNOLOWBETTER
if NOT RLOW is true
for all (t,j) that satisfy t<t′,
wherein NOT RLOW is the logical negation of proposition RLOW,
define KLOW1 to be the subset of
[to(a0),t1(a0)]×J
that consists of points that satisfy HASNOLOWBETTER and the points in
{to(a0)}×J
and define TEL1 to be the point in [to(a0), t1(a0)] that satisfies
$$TEL 1 = {sup}_{t} KLOW 1 ,$$
wherein
$${sup}_{t} KLOW 1$$
denotes the supremum of the set of all t in [to(a0), t1(a0)] such that (t,j) is in KLOW1,
define KLOW1′ to be the subset KLOW1 that satisfies
(t,j) belongs in KLOW1′
if there exists (t″″, j″″) in KLOW1 such that t=t″″ and j≠j″″,
define the set KLOW2 by
KLOW2=KLOW1\KLOW1′, and
define the main lower empirical solution ELS=(TEL,j(TEL)) that consists of the point TEL in KLOW2 and the realization index j(TEL) that corresponds to TEL, wherein TEL is defined by
$$TEL = {sup}_{t} KLOW 2$$
wherein
$${sup}_{t} KLOW 2$$
denotes the supremum of the set of all t in [to(a0), t1(a0)] such that (t,j) is in KLOW2, and
wherein furthermore ELS exists and is unique if KLOW2 is non vacuum and the set of all t such that (t,j) belongs in KLOW2 is closed from the right, and
methods that are simple variations of the method called main lower empirical solution, wherein a simple variation is
either the replacement of the larger or equal inequalities by strict inequalities or the replacement of the strict inequalities by larger or equal inequalities in one or more of R1, R5, R8, R9, R12, R13 and R14
or the restriction of the domain of c-times to a non vacuum subset of the closed interval [to(a0), t1(a0)]
or both, and
wherein said simple variations can be used to obtain ELS and TEL1 as in the method called main lower empirical solution;
wherein an upper empirical solution comprises of:
c-game with at least two c-coalitions, said c-game consists of e-games of order smaller or equal to 1,
a particular subset of the set of c-coalitions in the c-game, said subset consists of c-coalitions M(i3) wherein i3 takes all values in a set I3,
the payoffs P(M(i3)) of M(i3), for all i3 in I3,
the sets of variables VARS(M(i3)) controlled by the c-coalitions M(i3), for all i3 in I3, wherein furthermore it is assumed that each set VARS(M(i3)) consists of c-times, for all i3 in I3, and
the formulation of a problem called upper empirical problem and its solutions, said problem and solutions comprise of:
the realizations of the c-game defined as in the case of lower empirical solution,
the set of c-times defined as in the case of lower empirical solution,
the vector c-time variable T defined as in the case of lower empirical solution,
the notation i and I for i3 and I3 respectively, said notation is introduced to make the formulas simpler,
the set J and the subsets J(i) of J defined as in the case of lower empirical solution,
the set I and the subsets I(j) of I defined as in the case of lower empirical solution,
a method called main upper empirical solution, said method comprises of the steps:
use the notation and the quantities introduced in the case of the main lower empirical solution,
consider two points (t,i) and (t′,i′) in
[to(a0),t1(a0)]×J
and define a binary relation called UPBETTER by:
(t,j) is UPBETTER than (t′,j′) if RUP is true,
wherein RUP is the logical proposition defined by
RUP=R1 [symbol] R2 [symbol] R3 [symbol] R4 [symbol] R5
wherein R1, R2, R3, R4, and R5 are the logical propositions defined in the case of the main lower empirical solution,
consider a point (t′,i′) in
[to(a0),t1(a0)]×J
and define a relation called HASNOUPBETTER by:
(t′, j′) HASNOUPBETTER
if NOT RUP is true
for all (t,j) that satisfy t<t′,
wherein NOT RUP is the logical negation of proposition RUP,
define KUP1 to be the subset of
[to(a0),t1(a0)]×J
that consists of points that satisfy HASNOUPBETTER and the points in
{to(a0)}×J
and define TEU1 to be the point in [to(a0), t1(a0)] that satisfies
$$TEU 1 = {sup}_{t} KUP 1$$
wherein
$${sup}_{t} KUP 1$$
denotes the supremum of the set of all t in
[to(a0), t1(a0)] such that (t,j) is in KUP1,
define KUP1′ to be the subset KUP1 that satisfies:
(t,j) belongs in KUP1′
if there exists (t″″, j″″) in KUP1
such that t=t″″ and j≠j″″
define the set KUP2 by KUP2=KUP1\KUP1′, and
define the main upper empirical solution EUS=(TEU,j(TEU)) that consists of the point TEU in KUP2 and the realization index j(TEU) that corresponds to TEU, wherein TEU is defined by
$$TEU = {sup}_{t} KUP 2$$
wherein
$${sup}_{t} KUP 2$$
denotes the supremum of the set of all t in [to(a0), t1(a0)] such that (t,j) is in KUP2, and
wherein furthermore EUS exists and is unique if KUP2 is non vacuum and the set of all t such that (t,j) belongs in KUP2 is closed from the right, and
methods that are simple variations of the method called main upper empirical solution,
wherein a simple variation is
either the replacement of the larger or equal inequality by strict inequality or of a strict inequality by a larger or equal inequality in one or more of R1 and R5
or the restriction of the domain of c-times to a non vacuum subset of the closed interval [to(a0), t1(a0)]
or both, and
wherein said simple variations can be used to obtain EUS and TEU1 as in the method called main upper empirical solution;
wherein a empirical game type solution comprises of:
a c-game with two c-coalitions, said c-game consists of e-games of order smaller or equal to 1,
a particular subset of the set of c-coalitions in the c-game, said subset consists of c-coalitions M(i4) wherein i4 takes all values in a set I4 that consists of two elements,
the payoffs P(M(i4)) of M(i4), for all i4 in I4, the sets of variables VARS(M(i4)) controlled by the c-coalitions M(i4), for all i4 in I4,
wherein it is assumed that the set VARS(M(i4)) consists of c-times, for all i4 in I4, and
wherein it is assumed that given any two i4′ and i4″ in I4 such that i4′ is different from i4″ the sets VARS(M(i4′)) and VARS(M(i4″)) have no element in common,
the formulation of a lower empirical problem with payoffs P(M(i4)), the solution TEL and the point TEL1,
the formulation of an upper empirical problem with payoffs P(M(i4), the solution TEU and the point TEU1,
a function PAYGG that has arguments the payoffs P(M(i4)), wherein i4 takes values in I4, said function depends on all variables in the union U VARS(M(i4)) wherein the union is over all i4 in I4,
the formulation of a zero sum game problem, said game is denoted by the prefix (GP), said game problem is written in the symbolic language of game theory as
$${MAX}_{VARS ( M ( i 4 ) )} {MIN}_{VARS ( M ( ci 4 ) )} PAYGG ,$$
wherein ci4 denotes the element in I4\{i4} and
wherein the c-times take values in the interval that begins at T0 and ends at T1 wherein T0 can be either TEL or TEL1 and T1 can be either TEU or TEU1,
and the possible solutions of the zero sum game, said solutions can be pure or mixed exact or pure or mixed approximate solutions, said solutions are denoted by the prefix (GS), and
the empirical game solution of the c-game, said solution is defined by:
if the GS solutions of the GP game are pure, either exact or approximate,
then
the GS optimal values of the c-times of the GP game are by definition the empirical game type solution optimal values of the c-times and
the empirical game type solution optimal payoff value of each payoff P(M(i4)) is defined to be the value of P(M(i4)) when the c-time variables take the empirical game type solution optimal values, for all i4 in I4, and
if the GS solutions of the GP game are mixed, either exact or approximate,
then
the GS optimal probability measures of the GP game are by definition the empirical game type solution optimal measures
and
the empirical game type solution optimal payoff value of each payoff P(M(i4)) is defined to be the expectation of P(M(i4)) with respect to the product of all empirical game type solution optimal measures, for all i4 in I4,
wherein if the payoffs P(M(i4)) and PAYGG depend on variables that do not belong in the union U VARS(M(i4)) said variables are considered as parameters, wherein the union is over all i4 in I4; and
wherein a empirical Nash type solution comprises of:
a c-game with at least two c-coalitions, said c-game consists e-games of order smaller or equal to 1,
a particular subset of the set of c-coalitions in the c-game, said subset consists of c-coalitions M(i5) wherein i5 takes all values in a set I5,
the payoffs P(M(i5)) of M(i5), for all i5 in I5,
the sets of variables VARS(M(i5)) controlled by the c-coalitions M(i5), for all i5 in I5,
wherein it is assumed that the set VARS(M(i5)) consists of c-times for all i5 in I5, and
wherein it is assumed that given any two i5′ and i5″ in I5 such that i5′ is different from i5″ the sets VARS(M(i5′)) and VARS(M(i5″)) have no element in common,
the formulation of a lower empirical problem with payoffs P(M(i5)), the solution TEL and the point TEL1,
the formulation of an upper empirical problem with payoffs P(M(i5)), the solution TEU and the point TEU1,
functions PAYN(i5) that have arguments the payoffs P(M(i5′)), wherein i5 takes all values in I5 and i5′ takes values in I5,
wherein each PAYN(i5) depends on variables in the union U VARS(M(i5″)), wherein the union is over all i5″ in I5, and
wherein if z belongs in the union U VARS(M(i5″)) then z is a variable in PAYN(i5′) for some i5′ in I5, wherein the union is over all i5″ in I5,
the formulation of a game problem, said game is denoted by the prefix (NP), said game problem is written in the symbolic language of game theory as
$${MAX}_{VARS ( M ( i 5 ) )} PAYN ( i 5 ) , i 5 in I 5 ,$$
wherein the c-times take values in the interval that begins at T0 and ends at T1 wherein T0 can be either TEL or TEL1 and T1 can be either TEU or TEU1,
and the possible solutions of the NP game in the form of Nash equilibrium, said solutions can be pure or mixed exact or pure or mixed approximate solutions, said solutions are denoted by the prefix (NS), and
the empirical Nash solution of the c-game, said solution is defined by:
if the NS solutions of the NP game are pure, either exact or approximate,
then
the NS optimal values of the c-times given by the Nash solution of the NP game are by definition the empirical Nash type solution optimal values of the c-times and
the empirical Nash type solution optimal payoff value of each payoff P(M(i5)) is defined to be the value of P(M(i5)) when the c-time variables take the Nash empirical type solution optimal values, for all i5 in I5, and
if the NS solutions of the NP game are mixed, either exact or approximate,
then
the NS optimal probability measures given by the Nash solution of the NP game are by definition the empirical Nash type solution optimal measures
and
the empirical Nash type solution optimal payoff value of each payoff P(M(i5)) is defined to be the expectation of P(M(i5)) with respect to the product of all empirical Nash type solution optimal measures, for all i5 in I5,
wherein if the payoffs P(M(i5)) and PAYN(i5) depend on variables that do not belong in the union U VARS(M(i5)) said variables are considered as parameters, wherein the union is over all i5 in I5.

11. The method of claim 10 wherein furthermore
all c-changes ((a, b)) in the c-game satisfy:
N1(a)=N1(b)) [symbol] (N2(a)=N2(b)) is not true,
wherein ( [symbol] ) is the logical conjunction symbol.

12. I claim a method called elementary solutions of c-games, said method is a generalization of the theory of differential games and their solution methods, said method can be applied in cases where more than two players take part in a differential game and these players can form and change coalitions, said method comprises of:
a set called set of all players and all its subsets,
a set called set of all c-games, and
a set called set of elementary solution concepts, said set comprises of
a set of methods called simple solutions,
a set of methods called game type solutions, and
a set of methods called Nash type solutions;
wherein a c-game comprises of:
a set N called set of players that take part in the c-game,
a partition of N into disjoint subsets none of which is the vacuum set, said partition is called set of c-coalitions in the c-game and each subset M that belongs in the partition is called a c-coalition,
an element called algebraic c-game,
a set VAR, called set of variables in the c-game, a domain wherein the elements of the set VAR take values and a set of subsets DCT(j) of the domain DCT wherein c-times take values,
a family of non vacuum subsets VARS(M) of VAR,
wherein for each c-coalition M in the set of c-coalitions in the c-game there exists one and only one subset VARS(M) of VAR, said subset VARS(M) is called set of variables controlled by the c-coalition M, and
wherein VAR=U VARS(M), wherein the union is over all c-coalitions M,
a family of functions P(M)
wherein M takes all values in the set of all c-coalitions,
wherein for each M there exists one and only one function P(M),
wherein each P(M) depends on a set VARP(M) of variables, said set is a subset of VAR,
wherein VAR=U VARP(M), wherein the union is over all c-coalitions M, and
wherein each P(M) is called payoff of the c-coalition M in the c-game, and
an axiom;
wherein an algebraic c-game comprises of:
elements called e-games,
an ordered tree structure, and
elements called realizations;
wherein an e-game, denoted by a, comprises of:
a subset N1(a) of the set N, said subset is different from the vacuum set and is called set of maximizers in the e-game a,
a subset N2(a) of the set N, said subset is different from the vacuum set and furthermore N1(a) and N2(a) have no elements in common, said subset N2(a) is called set of minimizers in the e-game,
the set of players that take part in the e-game a, said set is defined to be the union N1(a) U N2(a),
a set ADN(a), wherein ADN(a) is a subset of N1(a) U N2(a)
a set NIN(a), wherein NIN(a) is a subset of N1(a) U N2(a), and
a differential game as formulated by
Isaacs and others, said game contains:
two sets of functions
Φ(t)={φ1(t), . . . ,φp(t)}
and
Ψ(t)={ψ1(t), . . . ,ψq(t)},
and their union called set of control function variables of the differential game,
a payoff function
P((Φ(t),Ψ(t))==∫(G(X(t),Φ(t),Ψ(y)))dt+H
called the Isaac's payoff,
a method used to obtain optimal values for the control function variables, said method is called Isaacs solution concept and is written in the symbolic language of game theory as
$${max}_{Ψ ( t )} {min}_{Φ ( t )} P ( Φ ( t ) , Ψ ( t ) ) , and$$
the value function defined by
$$V = {max}_{Ψ ( t )} {min}_{Φ ( t )} P ( Φ ( t ) , Ψ ( t ) ) ;$$
wherein the ordered tree is defined by:
each vertex of the ordered tree is an e-game in the algebraic c-game, each e-game in the algebraic c-game is a vertex in the tree and the edges are called c-changes,
wherein each c-change, denoted by ((a,b)), consists of an ordered pair of e-games a, b that satisfies the following:
the differential game in the e-game a is interrupted at time t(a,b), said time is called c-time of the c-change ((a,b)),
the differential game in the e-game b begins at time t(a,b), and
the set
{{N1(a),N2(a)},{N1(b),N2(b)}}
is an e-coalition change, wherein an p-coalition change is defined by:
N1(a) is the set of maximizers in e-game a,
N2(a) is the set of minimizers in e-game a,
N1(b) is the set of maximizers in e-game b,
N2(b) is the set of minimizers in e-game b,
there exists a set A1(a) which is a subset of N1(a),
there exists a set A2(a) which is a subset of N1(a), said A2(a) has no element in common with A1(a),
there exists a set B1(a) which is a subset of N2 (a),
there exists a set B2(a) which is a subset of N2(a), said B2(a) has no element in common with B1(a),
there exists a subset D1(b) of N, said subset has no element in common with the set N1(a) U N2(a),
there exists a subset D2(b) of N, said subset has no element in common with the set N1(a) U N2(a).and furthermore has no element in common with D1(a),
the set N1(b) is equal to the set
(N1(a)\(A1(a)UA2(a)))UB2(a)UD1(a)
and the set N2(b) is equal to the set
(N2(a)\(B1(a)UB2(a)))UA2(a)UD2(a);
wherein the realizations are defined in the following:
there is a unique e-game a(0) called root and e-game of order zero,
there exist at least one c-change wherein the e-game a(0) is the first e-game in the ordered pair in the c-change,
the set of all c-changes wherein a(0) is the first e-game in the ordered pair is called C1(a(0))-subgame,
an e-game that is the second element in the ordered pair in a c-change, wherein the first element is the e-game a(0) is called e-game of order 1,
if a is an e-game of order n and the c-change ((a,b)) exists then the e-game b is called e-game of order n+1, wherein n is an ordinal,
an e-game is called a leaf if there exist no c-change wherein said e-game is the first element in the ordered pair,
the set of all c-changes that contain an e-game a as first element is called a C1(a)-subgame,
if the c-change ((a,b)) exist in the C1(a)-subgame then the ordered pair (a,b) is called a realization in the C1(a)-subgame,
a realization A is a sequence of e-games a(0), a(11), . . . , a(n), a(n+1), . . . , a(nmax)),
wherein the first element of this sequence is the root a(0),
wherein the last element a(nmax) is a leaf,
wherein the e-game a(n) is of order n, and
wherein if a(n) and a(n+1) belong in the realization
then there exists a c-change
((a(n),a(n+1))),
the realizations in a c-game can be numbered and can be written in the form
A(j)==(a(j,0),a(j,1), . . . ,a(j,n), . . . ,a(j,n(j))),
wherein the e-game a(j,n) is of order n, and
wherein n(j) is an ordinal such that the order of any e-game in the realization is smaller or equal than n(j), said n(j) depends on j, wherein j is an ordinal,
a c-game is said to be in realization form if its realizations are written in the form
A(j)=(a(j,0),a(j,1), . . . ,a(j,n(j))
and the c-game in realization form can be written as the set
{A(j):j in J}
wherein J can be an interval of ordinals {1, 2, . . . , MAXJ}, and
a c-game is said to be in tree form if its realizations are written in the form
(a(0),a(v(1),1), . . . ,a(v(n−1),n−1),a(v(n),n), . . . )
wherein v(n) belongs an index set V(n, v(n−1)), said index set numbers all e-games of order n that belong in the C1(a(v(n−1),n−1)-subgame;
wherein the set VAR consists of:
all elements of the set CT of all c-times, said set is defined to be
CT=U{t(a,b)},
wherein t(a,b) is the c-time of the c-change ((a, b)), and
wherein the union is over all c-changes in the tree in the algebraic c-game in the c-game,
all elements of the set ADVAR, said set is called set of all additional variables, said set is defined to be
ADVAR=UADVAR(a),
wherein the union is over all e-games a in the algebraic c-game, and
wherein ADVAR(a) is a set called the set of all additional variables of the e-game a, said set it is assumed it exists, and
all elements of the set NIVAR, said set is called set of all non-isaacs function variables, said set is defined by
NIVAR=UNIVAR(a),
wherein the union is over all e-games a in the algebraic c-game in the c-game,
wherein each NIVAR(a) is defined to be a subset of the set of control function variables of the differential game in the e-game a,
wherein the elements of each NIVAR(a) are considered as variables and their value needs to be determined along with the other variables in the c-game, and
wherein the control function variables in the differential game in the e-game a that do not belong in NIVAR(a) take the values obtained by solving the differential game in the e-game a using the Isaacs solution concept, said values may depend on parameters;
wherein the domain of the variables in VAR contains the domain DCT in which the c-times take values, said DCT is defined by the inequalities
t(a(j,n),a(j,n+1))<t(a(j,n+1),a(j,n+2))
for all n such that a(j,n), a(j,n+1)) and a(j,n+2) belong in A(j) and all j in J, and
t0(a(j,n))<t(a(j,n),a(j,n+1))<t1(a(j,n))
for all n such that a(j,n) and a(j,n+1)) belong in A(j) and all j in J,
wherein t(a(j,n), a(j,n+1)) is the c-time of the c-change ((a(j,n), a(j,n+1)))
wherein t0(a(j,n)) is the time the differential game in e-game a(j,n) begins, and this time is a c-time if n is larger than 0, and t1(a(j,n)) is the time the differential game in e-game a(j,n) ends if it is not interrupted,
wherein A(j) is the realization
(a(j,0),a(j,1), . . . ,a(j,n), . . . ),
wherein the c-game is written in realization form as the set
{A(j):j in J}, and
wherein some of the inequality relations can be strict inequality relations and others can be equal or smaller relations and the choice of what type of inequalities will be used depends on the exact mathematical formulation of the solution method of the c-game and on whether the differential games in all e-games in a realization will be certainly played or not;
wherein one can define subsets DCT(j) of the domain DCT and construct a one to one onto map between the set of all DCT(j) and the set of all realizations A(j), said subset DCT(j) that corresponds to realization A(j) is defined by the inequalities
t(a(j,n),a(j,n+1))<t(a(j,n+1),a(j,n+2))
for all n such that a(j,n), a(j,n+1)) and a(j,n+2) belong in A(j),
t0(a(j,n))<t(a(j,n),a(j,n+1))<t1(a(j,n))
for all n such that a(j,n) and a(j,n+1)) belong in A(j), and
t(a(j,n),a(j,n+1))<t(a(j,n),a(x(j,n)))
for all n such that a(j,n) and a(j,n+1)) belong in A(j) and all x(j,n) in a set X(j,n),
wherein A(j) is the realization
(a(j,0),a(j,1), . . . ,a(j,n), . . . ),
wherein the c-game is written in realization form as the set
{A(j):j in J}, and
wherein a(x(j,n)) is the second e-game in a realization
A(x(j,n))=(a(j,n),a(x(j,n)))
of the C1(a(j,n))-subgame with root the e-game p(j,n)) wherein the index x(j,n) numbers all realizations of the C1(a(j,n))-subgame except (a(j,n), a(j,n+1));
wherein each VARS(M) consists of:
all elements of the subset CT(M) of the set CT of all c-times, said subset is called set of c-times controlled by c-coalition M, said subset consists of c-times t(a,b) that satisfy:
the union of the sets
A1(a), A2(a), B1(a), B2(a),
D1(b), D2(b), ADN(b) and NIN(b)
has at least one element in common with M,
all elements of the subset ADVAR(M) of the set ADVAR, said subset is called the set of additional variables controlled by the c-coalition M, said subset consists of additional variables z that satisfy:
if z belongs in ADVAR(M) then
there exists an e-game a in the algebraic c-game and a subset ADVAR(M,a) of the set ADVAR(a) such that z belongs in ADVAR(M,a), said ADVAR(N,a) is called set of additional variables in e-game a controlled by c-coalition M, and
the set M has at least one element in common with ADN(a), and
all elements of the subset NIVAR(M) of the set NIVAR, said subset called the set of non-isaacs function variables controlled by c-coalition M, said subset consists of non-isaacs function variables f that satisfy:
if f belongs in NIVAR(M) then there exists an e-game a in the algebraic c-game and a subset NIVAR(M,a) of the set NIVAR(a) such that f belongs in NIVAR(M,a), said NIVAR(M,a) is called set of non-isaacs function variables in e-game a controlled by c-coalition M, and
the set NIN(a) has, at least one element in common with M;
wherein the axiom states that in any c-game, written in realization form as
{A(j):j in J},
only the differential games in the e-games a(j,n) that belong in one and only one realization
A(j)==(a(j,0),a(j,1), . . . ,a(j,n), . . . ,a(j,n(j))
will be played and in that case we say the realization A(j) is played or players choose to play play realization A(j),
wherein a(j,n(j)) is the e-game in A(j) that has order n(j) larger than the order of any other e-game in A(j),
wherein j is one element in a set J, wherein J can be chosen to be an interval of ordinals {1, 2, . . . , MAXJ}, and
wherein furthermore:
if t(a(j,0), a(j,1)) is larger than t0(a(j,0))
then
if t(a(j,0), a(j,1)) is smaller than
t1(a(j,0))
then
the differential game in e-game a(j,0) will be played first from the time t0(a(j,0)) until the c-time t(a(j,0), a(j,1)), wherein t0(a(j,0)) is the time the differential game in e-game a(j,0) begins, and
if t(a(j,0), a(j,1)) is equal to t1(a(j,0)) then the differential game in e-game a(j,0) will be played first from time t0(a(j,0)) until the time t1(a(j,0)) when the differential game in e-game a(j,0) and the c-game end, wherein t1(a(j, 0)) is the time the differential game in e-game a(j,0) ends,
if t(a(j,0), a(j,1)) is equal to t0(a(j,0))
then
the differential game in the root a(j,0) will not be played,
if t(a(j,n), a(j,n+1)) is different from t(a(j,n+1), a(j,n+2)) for some n smaller than n(j)−1
then
the differential game in e-game a(j,n+1) will be played,
if n is smaller than n(j)-1 and if the differential game in e-game a(j,n) is played then
if t(a(j,n), a(j,n+1)) is equal to t1(a(j,n))
then
the differential game in e-game a(j,n) will be played until the time t1(a(j,n)) when the differential game in e-game a(j,n) and the c-game end, wherein t1(a(j,n)) is the time the differential game in e-game a(j,n) ends and
if t(a(j,n), a(j,n+1)) is smaller than t1(a(j,n))
then
at time t(a(j,n), a(j,n+1)) a c-change will happen and
if t(a(j,n), a(j,n+1)) is different from t(a(j,n+1), a(j,n+2))
then
the differential game in e-game a(j,n+1) will be played from the time t(a(j,n), a(j,n+1)) until the time t(a(j,n+1), a(j,n+2)) and
if t(a(j,n), a(j,n+1)) is equal to t(a(j,n+1), a(j,n+2))
then
the differential game in e-game a(j,n+1) will not be played, and
if n is equal to n(j)−1 and if the differential game in e-game a(j,n(j)−1) is played
then
if t(a(j,n(j)−1), a(j,n(j))) is equal to t1(a(j,n(j)−1))
then
the differential game in e-game a(j,n(j)−1) will be played until the time t1(a(j,n(j)−1)) when the differential game in e-game a(j,n(j)−1) and the c-game end, wherein t1(a(j,n(j)−1)) is the time the differential game in e-game a(j,n(j)−1) ends and
if t(a(j,n(j)−1), a(j,n(j))) is smaller than t1(a(j,n(j)−1))
then
at time t(a(j,n(j)−1),a(j,n(j))) a c-change will happen and the differential game in e-game a(j,n(j)) will be played from the time t(a(j,n(j)−1), a(j,n(j))) until the time t1(a(j,n(j))), wherein t1(a(j,n(j))) is the time the differential game in e-game a(j,n(j)) and the c-game end;
wherein a simple solution comprises of:
a c-game,
one particular c-coalition M in the c-game, the payoff P(M) of M,
the set VARS(M) of variables controlled by the c-coalition M,
the formulation of an optimization problem written in the symbolic language of optimization theory
$${MAX}_{VARS ( M )} P ( M ) , and$$
the possible solutions of the optimization problem, said solutions can be exact solutions or approximate solutions, wherein if the payoff P(M) depends on variables that do not belong in VARS(M) then said variables are considered as parameters;
wherein a game type solution comprises of:
a c-game with at least two c-coalitions,
two particular c-coalitions M1 and M2 in the c-game,
the payoffs P(M1) and P(M2) of M1 and M2,
the sets of variables VARS(M1) and VARS(M2) controlled by the c-coalitions M1 and M2 wherein furthermore it is assumed that the sets VARS(M1) and VARS(M2) have no element in common,
a function PAY=PAY(P(M1), P(M2) that has arguments the payoffs P(M1) and P(M2), said function depends on all variables in the union of VARS(M1) and VARS(M2),
the formulation of a zero sum game problem written in the symbolic language of game theory as
$${MAX}_{VARS ( M 1 )} {MIN}_{VARS ( M 2 )} PAY , and$$
the possible solutions of the zero sum game, said solutions can be pure or mixed, exact or approximate solutions, wherein if the payoff PAY depends on variables that do not belong in the union of VARS(M1) and VARS(M2) said variables are considered as parameters; and
wherein a Nash type solution comprises of:
a c-game with at least two c-coalitions,
a particular subset of the set of c-coalitions in the c-game, said subset consists of c-coalitions M(i1) wherein i1 takes all values in a set I1,
the payoffs P(M(i1)) of M(i1), for all i1 in I1,
the sets of variables VARS(M(i1)) controlled by the c-coalitions M(i1), for all i1 in I1, wherein furthermore it is assumed that given any two i1′ and i1″ in I1 such that i1′ is different from i1″ the sets VARS(M(i1′)) and VARS(M(i1″)) have no element in common,
the formulation of a game problem written in the symbolic language of game theory as
$${MAX}_{VARS ( M ( i 1 ) )} P ( M ( i 1 ) ) , i 1 in I 1 , and$$
the possible solutions of the game in the form of Nash equilibrium, said solutions can be pure or mixed solutions or approximate solutions, wherein if the payoffs P(M(i1)) depend on variables that do not belong in the union U VARS(M(i1)) then said variables are considered as parameters, wherein the union is over all i1 in I1.

13. The method of claim 12 wherein furthermore
all c-changes ((a, b)) in the c-game satisfy:
N1(a)=N1(b)) [symbol] (N2(a)=N2(b)) is not true,
wherein ( [symbol] ) is the logical conjunction symbol.

14. The method of claim 12 wherein furthermore
the set of variables VAR consists of c-times.

15. The method of claim 14 wherein furthermore
the variables in VAR take discrete values.

16. The method of claim 15 wherein furthermore:
the set of c-coalitions of the c-game consists of two elements M1′ and M2′,
all C1-subgames contain two c-time variables, t(x) controlled by M1′ and s(x) controlled by M2′, wherein x numbers all C1-subgames in the c-game, said x takes all values in an interval of ordinals {1, 2, . . . , xmax},
the set VARS(M1′) is given by
{t(1),t(2), . . . ,t(x), . . . ,t(xmax)},
the set VARS(M2′) is given by
{s(1),s(2), . . . ,s(x), . . . ,s(xmax)},
each c-time variable t(x) takes discrete time values t(x)1, t(x)2, . . . , t(x) n, and each c-time variable
s takes discrete time values s(x)1, s(x)2, . . . , s(x)n, wherein n takes all values in an interval of ordinals ND={2, 3, . . . , NDmax}, and
for each n in ND two kind of discrete matrix games are formulated:
in the first the c-times satisfy
t(x)1<s(x)1<t(x)2<s(x)2< . . . <t(x)n<s(x)n
for all x in {l,2, . . . ,xmax} and all n in ND, and in the second the c-times satisfy
s(x)1<t(x)1<s(x)2<t(x)2< . . . <s(x)n<t(x)n
the solution of these matrix games exist, said solutions are denoted by (SOLT(n, t<s)) and SOLT(n, s<t)) for the M1′ C-coalition and SOLS(n, s<t)) and (SOLS(n, t<s)) for the M2′ c-coalitions, said solutions are functions of the number n of discrete points, and
if NDmax is not a finite ordinal then the differences
SOLT(n,t<s)−SOLT(n,s<t)
and
SOLS(n,t<s)−SOLS(n,s<t)
tends to zero in some mathematical sense.

17. The method of claim 12 wherein furthermore:
in game type solutions a min-max theorem can be proved for C1-games wherein the set of variables consists of c-times, and
in Nash type solutions an existence theorem for Nash equilibria can be proved for C1-games wherein the set of variables consists of c-times.

18. I claim a method called recursive solutions of c-games, said method comprises of:
a set of elements called c-games, and
a set of elements called mixed type recursive solutions;
wherein a c-game comprises of:
a set N called set of players that take part in the c-game,
a partition of N into disjoint subsets none of which is the vacuum set, said partition is called set of c-coalitions in the c-game and each subset M that belongs in the partition is called a c-coalition,
an element called algebraic c-game,
a set VAR, called set of variables in the c-game, a domain wherein the elements of the set VAR take values and a set of subsets DCT(j) of the domain DCT wherein c-times take values,
a family of non vacuum subsets VARS(M) of VAR,
wherein for each c-coalition M in the set of c-coalitions in the c-game there exists one and only one subset VARS(M) of VAR, said subset VARS(M) is called set of variables controlled by the c-coalition M, and
wherein VAR=U VARS(M), wherein the union is over all c-coalitions M,
a family of functions P(M)
wherein M takes all values in the set of all c-coalitions,
wherein for each M there exists one and only one function P(M),
wherein each P(M) depends on a set VARP(M) of variables, said set is a subset of VAR,
wherein VAR=U VARP(M), wherein the union is over all c-coalitions M, and
wherein each P(M) is called payoff of the c-coalition M in the c-game, and
an axiom;
wherein an algebraic c-game comprises of:
elements called e-games,
an ordered tree structure, and
elements called realizations;
wherein an e-game, denoted by a, comprises of:
a subset N1(a) of the set N, said subset is different from the vacuum set and is called set of maximizers in the e-game a,
a subset N2(a) of the set N, said subset is different from the vacuum set and furthermore N1(a) and N2(a) have no elements in common, said subset N2(a) is called set of minimizers in the e-game,
the set of players that take part in the e-game a, said set is defined to be the union N1(a) U N2(a),
a set ADN(a), wherein ADN(a) is a subset of N1(a) U N2(a)
a set NIN(a), wherein NIN(a) is a subset of N1(a) U N2(a), and
a differential game as formulated by Isaacs and others, said game contains:
two sets of functions
Φ(t)={φ1(t), . . . ,φ(t)}
and
Ψ(t)={ψ1(t), . . . ,ψq(t)},
and their union called set of control function variables of the differential game,
a payoff function
P(Φ(t),Ψ(t))==∫(G(X(t),Φ(t),Ψ(y)))dt+H
called the Isaac's payoff,
a method used to obtain optimal values for the control function variables, said method is called Isaacs solution concept and is written in the symbolic language of game theory as
$${max}_{Ψ ( t )} {min}_{Φ ( t )} P ( Φ ( t ) , Ψ ( t ) ) , and$$
the value function defined by
$$V = {max}_{Ψ ( t )} {min}_{Φ ( t )} P ( Φ ( t ) , Ψ ( t ) ) ;$$
wherein the ordered tree is defined by:
each vertex of the ordered tree is an e-game in the algebraic c-game, each e-game in the algebraic c-game is a vertex in the tree and the edges are called c-changes,
wherein each c-change, denoted by ((a,b)), consists of an ordered pair of e-games a, b that satisfies the following:
the differential game in the e-game a is interrupted at time t(a,b), said time is called c-time of the c-change ((a,b)),
the differential game in the e-game b begins at time t(a,b), and
the set
{{N1(a),N2(a)},{N1(b),N2(b)}}
is an e-coalition change, wherein an e-coalition change is defined by:
N1(a) is the set of maximizers in e-game a,
N2(a) is the set of minimizers in e-game a,
N1(b) is the set of maximizers in e-game b,
N2(b) is the set of minimizers in e-game b,
there exists a set A1(a) which is a subset of N1(a),
there exists a set A2(a) which is a subset of N1(a), said A2(a) has no element in common with A1(a),
there exists a set B1(a) which is a subset of N2(a),
there exists a set B2(a) which is a subset of N2(a), said B2(a) has no element in common with B1(a),
there exists a subset D1(b) of N, said subset has no element in common with the set N1(a) U N2(a),
there exists a subset D2(b) of N, said subset has no element in common with the set N1(a) U N2(a) and furthermore has no element in common with D1(a),
the set N1(b) is equal to the set
(N1(a)\(A1(a)UA2(a)))UB2(a)UD1(a)
and the set N2(b) is equal to the set
(N2(a)\(B1(a)UB2(a)))UA2(a)UD2(a);
wherein the realizations are defined in the following:
there is a unique e-game a(0) called root and e-game of order zero,
there exist at least one c-change wherein the e-game a(0) is the first e-game in the ordered pair in the c-change,
the set of all c-changes wherein a(0) is the first e-game in the ordered pair is called C1(a(0))-subgame,
an e-game that is the second element in the ordered pair in a c-change wherein the first element is the e-game a(0) is called e-game of order 1,
if a is an e-game of order n and the c-change ((a,b)) exists then the e-game b is called e-game of order n+1, wherein n is an ordinal,
an e-game is called a leaf if there exist no c-change wherein said e-game is the first element in the ordered pair,
the set of all c-changes that contain an e-game a as first element is called a C1(a)-subgame,
if the c-change ((a,b)) exist in the C1(a)-subgame then the ordered pair (a,b) is called a realization in the C1(a)-subgame,
a realization A is a sequence of e-games a(0), a(1), . . . , a(n), a(n+1), . . . , a(nmax)),
wherein the first element of this sequence is the root a(0),
wherein the last element a(nmax) is a leaf,
wherein the e-game a(n) is of order n, and
wherein if a(n) and a(n+1) belong in the realization
then there exists a c-change
((a(n),a(n+1))),
the realizations in a c-game can be numbered and can be written in the form
A(j)==(a(j,0),a(j,1), . . . ,a(j,n), . . . ,a(j,n(j))),
wherein the e-game a(j,n) is of order n, and
wherein n(j) is an ordinal such that the order of any e-game in the realization is smaller or equal than n(j), said n(j) depends on j, wherein j is an ordinal,
a c-game is said to be in realization form if its realizations are written in the form
A(j)=(a(j,0),a(j,1), . . . ,a(j,n(j))
and the c-game in realization form can be written as the set
{A(j):j in J}
wherein J can be an interval of ordinals {1, 2, . . . , MAXJ}, and
a c-game is said to be in tree form if its realizations are written in the form
(a(0),a(v(1),1), . . . ,a(v(n−1),n−1),a(v(n),n), . . . )
wherein v(n) belongs an index set V(n, v(n−1)), said index set numbers all e-games of order n that belong in the C1(a(v(n−1),n−1)-subgame;
wherein the set VAR consists of
all elements of the set CT of all c-times, said set is defined to be
CT=U{t(a,b)},
wherein t(a,b) is the c-time of the c-change ((a, b)), and
wherein the union is over all c-changes in the tree in the algebraic c-game in the c-game,
all elements of the set ADVAR, said set is called set of all additional variables, said set is defined to be
ADVAR=UADVAR(a),
wherein the union is over all e-games a in the algebraic c-game and
wherein ADVAR(a) is a set called the set of all additional variables of the e-game a, said set it is assumed it exists, and
all elements of the set NIVAR, said set is called set of all non-isaacs function variables, said set is defined by
NIVAR=UNIVAR(a)
wherein the union is over all e-games a in the algebraic c-game in the c-game,
wherein each NIVAR(a) is defined to be a subset of the set of control function variables of the differential game in the e-game a,
wherein the elements of each NIVAR(a) are, considered as variables and their value needs to be determined along with the other variables in the c-game, and
wherein the control function variables in the differential game in the e-game a that do not belong in NIVAR(a) take the values obtained by solving the differential game in the e-game a using the Isaacs solution concept, said values may depend on parameters;
wherein the domain of the variables in VAR contains the domain DCT in which the c-times take values, said DCT is defined by the inequalities
t(a(j,n),a(j,n+1))<t(a(j,n+1),a(j,n+2))
for all n such that a(j,n), a(j,n+1)) and a(j,n+2) belong in A(j) and all j in J, and
t0(a(j,n))<t(a(j,n),a(j,n+1))<t1(a(j,n))
for all n such that a(j,n) and a(j,n+1)) belong in A(j) and all j in J,
wherein t(a(j,n), a(j,n+1)) is the c-time of the c-change ((a(j,n), a(j,n+1)))
wherein t0(a(j,n)) is the time the differential game in e-game a(j,n) begins, and this time is a c-time if n is larger than 0, and t1(a(j,n)) is the time the differential game in e-game a(j,n) ends if it is not interrupted,
wherein A(j) is the realization
(a(j,0),a(j,1), . . . ,a(j,n), . . . ),
wherein the c-game is written in realization form as the set
{A(j):j in J}, and
wherein some of the inequality relations can be strict inequality relations and others can be equal or smaller relations and the choice of what type of inequalities will be used depends on the exact mathematical formulation of the solution method of the c-game and on whether the differential games in all e-games in a realization will be certainly played or not;
wherein one can define subsets DCT(j) of the domain DCT and construct a one to one onto map between the set of all DCT(j) and the set of all realizations A(j), said subset DCT(j) that corresponds to realization A(j) is defined by the inequalities
t(a(j,n),a(j,n+1))<t(a(j,n+1),a(j,n+2))
for all n such that a(j,n), a(j,n+1)) and a(j,n+2) belong in A(j),
t0(a(j,n))<t(a(j,n),a(j,n+1))<t1(a(j,n))
for all n such that a(j,n) and a(j,n+1)) belong in A(j), and
t(a(j,n),a(j,n+1))<t(a(j,n),a(x(j,n)))
for all n such that a(j,n) and a(j,n+1)) belong in A(j) and all x(j,n) in a set X(j,n),
wherein A(j) is the realization
(a(j,0),a(j,1), . . . ,a(j,n), . . . ),
wherein the c-game is written in realization form as the set
{A(j):j in J}, and
wherein a(x(j,n)) is the second e-game in a realization
A(x(j,n))=(a(j,n),a(x(j,n))
of the C1(a(j,n))-subgame with root the e-game a(j,n)) wherein the index x(j,n) numbers all realizations of the C1(a(j,n))-subgame except (a(j,n), a(j,n+1));
wherein each VARS(M) consists of:
all elements of the subset CT(M) of the set CT of all c-times, said subset is called set of c-times controlled by c-coalition M, said subset consists of c-times t(a,b) that satisfy:
the union of the sets
A1(a), A2(a), B1(a), B2(a),
D1(b), D2(b), ADN(b) and NIN(b)
has at least one element in common with M,
all elements of the subset ADVAR(M) of the set ADVAR, said subset is called the set of additional variables controlled by the c-coalition M, said subset consists of additional variables z that satisfy:
if z belongs in ADVAR(M) then
there exists an e-game a in the algebraic c-game and a subset ADVAR(M,a) of the set ADVAR(a) such that z belongs in ADVAR(M,a), said ADVAR(N,a) is called set of additional variables in e-game a controlled by c-coalition M, and
the set M has at least one element in common with ADN(a), and
all elements of the subset NIVAR(M) of the set NIVAR, said subset called the set of non-isaacs function variables controlled by c-coalition M, said subset consists of non-isaacs function variables f that satisfy:
if f belongs in NIVAR(M) then there exists an e-game a in the algebraic c-game and a subset NIVAR(M,a) of the set NIVAR(a) such that f belongs in NIVAR(M,a), said NIVAR(M,a) is called set of non-isaacs function variables in e-game a controlled by c-coalition M, and
the set NIN(a) has at least one element in common with M;
wherein the axiom states that in any c-game, written in realization form as
{A(j):j in J}
only the differential games in the e-games a(j,n) that belong in one and only one realization
A(j)==(a(j,0),a(j,1), . . . ,a(j,n), . . . ,a(j,n(j))
will be played and in that case we say the realization A(j) is played or players choose to play play realization A(j),
wherein a(j,n(j)) is the e-game in A(j) that has order n(j) larger than the order of any other e-game in A(j),
wherein j is one element in a set J, wherein J can be chosen to be an interval of ordinals {1, 2, . . . , MAXJ}, and
wherein furthermore
if t(a(j,0), a(j,1)) is larger than t0(a(j,0))
then
if t(a(j,0), a(j,1)) is smaller than
t1(a(j,0))
then the differential game in e-game a(j,0) will be played first from the time t0(a(j,0)) until the c-time t(a(j,0), a(j,1)), wherein t0(a(j,0)) is the time the differential game in e-game a(j,0) begins, and
if t(a(j,0), a(j,1)) is equal to t1(a(j,0)) then the differential game in e-game a(j,0) will be played first from time t0(a(j,0)) until the time t1(a(j,0)) when the differential game in e-game a(j,0) and the c-game end, wherein t1(a(j,0)) is the time the differential game in e-game a(j,0) ends,
if t(a(j,0), a(j,1)) is equal to t0(a(j,0))
then
the differential game in the root a(j,0) will not be played,
if t(a(j,n), a(j,n+1)) is different from t(a(j,n+1), a(j,n+2)) for some n smaller than
n(j)−1
then
the differential game in e-game a(j,n+1) will be played,
if n is smaller than n(j)−1 and if the differential game in e-game a(j,n) is played then
if t(a(j,n), a(j,n+1)) is equal to t1(a(j,n))
then
the differential game in e-game a(j,n) will be played until the time (t1(a(j,n)) when the differential game in e-game a(j,n) and the c-game end, wherein t1(a(j,n)) is the time the differential game in e-game a(j,n) ends, and
if t(a(j,n), a(j,n+1)) is smaller than t1(a(j,n))
then
at time t(a(j,n), a(j,n+1)) a c-change will happen and
if t(a(j,n), a(j,n+1)) is different from t(a(j,n+1), a(j,n+2))
then
the differential game in e-game a(j,n+1) will be played from the time t(a(j,n), a(j,n+1)) until the time t(a(j,n+1), a(j,n+2)), and
if t(a(j,n), a(j,n+1)) is equal to t(a(j,n+1), a(j,n+2))
then
the differential game in e-game a(j,n+1) will not be played, and
if n is equal to n(j)−1 and if the differential game in e-game a(j,n(j)−1) is played
then
if t(a(j,n(j)−1), a(j,n(j))) is equal to t1(a(j,n(j)−1))
then
the differential game in e-game a(j,n(j)−1) will be played until the time t1(a(j,n(j)-1)) when the differential game in e-game a(j,n(j)−1) and the c-game end, wherein t1(a(j,n(j)−1)) is the time the differential game in e-game a(j,n(j)−1) ends, and
if t(a(j,n(j)−1), a(j,n(j))) is smaller than t1(a(j,n(j)−1))
then
at time t(a(j,n(j)−1),a(j,n(j))) a c-change will happen and the differential game in e-game a(j,n(j)) will be played from the time t(a(j,n(j)−1), a(j,n(j))) until the time t1(a(j,n(j))), wherein t1(a(j,n(j))) is the time the differential game in e-game a(j,n(j)) and the c-game end; and
wherein a mixed type recursive solution comprises of:
a particular c-game,
a particular subset of the set of c-coalitions of the c-game, said subset consists of elements M(i) wherein the index i takes all values in a set I, wherein I contains at least one element
the sets VARS(M(i)) of variables controlled by the c-coalitions M(i), wherein i takes all values in I,
the payoffs PAY(M(i)) of the c-coalitions M(i), wherein i takes all values in I
the set VARS, said set is defined to be the union U VARS(M(i)), wherein the union is over all i in I,
a non vacuum index set K, said set can be chosen to be the interval of ordinals {0, 1, . . . , Kmax} wherein Kmax is an ordinal
a family of sets I(k),
wherein k takes all values in K, and
wherein each I(k) is a non vacuum subset of I,
a family of sets VAR(k),
wherein k takes all values in K,
wherein each VAR(k) is a subset of VARS,
wherein the family of sets VAR(k) is a partition of VARS, and
wherein each VAR(k) satisfies furthermore
if i belongs in I(k) then VAR(k) contains at least one variable controlled by c-coalition M(i) and
if z′ belongs in VAR(k) then there exists an i′ in I(k) such that the c-coalition M(i′) controls z′,
a family of non vacuum sets L(k),
wherein k takes all values in K, and
wherein the sets L(k′) and L(k″) have no element in common for any k′ and k″ in K such that k′ is different from k″,
the subsets NL(k), GL(k), EL(k), SL(k) and OL(k) of each L(k),
wherein for each k in K the union of all said subsets contains all elements of L(k), and
wherein for each k in K if any two of said subsets are non vacuum then they are disjoint, a partition of each SL(k) into subsets SPURL(k) and SMIXL(k),
a partition of each NL(k) into subsets NPURL(k) and NMIXL(k),
a partition of, each GL(k) into subsets GPURL(k) and GMIXL(k),
the subsets EUL(k), ELL(k) and EGL(k) of each EL(k),
wherein for each k the union of all said subsets contains all elements of EL(k), and
wherein for each k if any two of said subsets are non vacuum then they are disjoint,
a partition of each EGL(k) into subsets EGGL(k) and EGNL(k),
a partition of each EGGL(k) into subsets EGGPURL(k) and EGGMIXL(k),
a partition of each EGNL(k) into subsets EGNPURL(k) and EGNMIXL(k),
the subsets PUROL(k) and MIXOL(k) of each OL(k),
the sets PURL(k) wherein each PURL(k) is defined to be the union of SPURL(k), GPURL(k), NPURL(k), EUL(k), ELL(k), EGGPURL(k) and EGNPURL(k), wherein k takes all values in K,
the sets MIXL(k) wherein each MIXL(k) is defined to be the union of SMIXL(k), GMIXL(k), NMIXL(k), EGGMIXL(k) and EGNMIXL(k), wherein k takes all values in K,
a family of sets I(k,l(k)),
wherein k takes all values in K and l(k) takes all values in L(k),
wherein each I(k,l(k)) is a non vacuum subset of I(k), and
wherein each I(k,l(k)) satisfies furthermore:
if SL(k) is not the vacuum set and l(k) belongs in SL(k) then I(k,l(k)) consists of one element,
if GL(k) is not the vacuum set and l(k) belongs in GL(k) then I(k,l(k)) consists of two elements,
if NL(k) is not the vacuum set and l(k) belongs in NL(k) then I(k,l(k)) contains at least two elements,
if EL(k) is not the vacuum set and l(k) belongs in EL(k) then I(k,l(k)) contains at least two elements,
if EGGL(k) is not the vacuum set and l(k) belongs in EGGL(k) then I(k,l(k)) consists of two elements and
if OL(k) is not the vacuum set and l(k) belongs in OL(k) then I(k,l(k)) contains at least one element
a family of sets VAR(k,l(k)),
wherein k takes all values in K and l(k) takes all values in L(k),
wherein each VAR(k,l(k)) is a subset of VAR(k),
wherein the union U VAR(k,l(k)) contains all elements of VAR(k),
wherein if (k) and l″ (k) belong in L(k) and l′(k) and l″ (k) are different elements then the sets VAR(k,l′(k)) and VAR(k,l″ (k)) are disjoint,
wherein if EL(k) is not the vacuum set and l(k) belongs in EL(k) then VAR(k,l(k)) consists of c-times,
wherein if MIXL(k) is not the vacuum set and l(k) belongs in MIXL(k) then VAR(k,l(k)) does not contain any element in NIVAR, and
wherein each VAR(k,l(k)) satisfies furthermore
if i belongs in I(k,l(k)) then VAR(k,l(k)) contains at least one variable controlled by c-coalition M(i), and
if z′ belongs in VAR(k,l(k)) then there exists an i′ in I(k,l(k)) such that the c-coalition M(i′) controls z′
a family of sets VARM(i(k,l(k))),
wherein k takes all values in K, l(k) takes all values in L(k) and i(k,l(k)) takes all values in I(k,l(k)),
wherein each VARM(i(k,l(k))) consists of all variables in VAR(k,l(k)) controlled by c-coalition M(i(k,l(k))), and
wherein furthermore the sets VARM(i′(k,l(k))) and VARM(i″(k,l(k))) have no element in common for all k in K and all l(k) in
L(k)\(EUL(k)UELL(k)
and all i′(k,l(k)) and i″(k,l(k)) in I(k,l(k)) such that i′(k,l(k)) is different from i″(k,l(k)),
a family of probability measures PROBM(i(k,l(k))), said measures are defined only when k and l(k) exist,
wherein k takes all values in K, l(k) takes all values in MIXL(k) and i(k,l(k)) takes all values in I(k,l(k)),
wherein each PROBM(i(k,l(k))) is a measure on all variables in VARM(i(k,l(k))), and
wherein each PROBM(i(k,l(k))) is considered to be a variable that takes values in a space SPACE(k,l(k),i(k,l(k))), said space depends on parameters
a family of sets of variables, said family consists of:
a family of sets PAYVAR(k,l(k)), said sets are
defined only when k and l(k) exist,
wherein k takes all values in K and l(k) takes all values in the union SL(k) U GL(k),and
wherein each PAYVAR(k,l(k)) is defined to be the set VAR(k,l(k)), and
a family of sets PAYVAR(k,l(k),i(k,l(k))), said sets are defined only when k and l(k) exist,
wherein k takes all values in K, l(k) takes all values in the union EL(k) U NL(k) and i(k,l(k)) takes all values in I(k,l(k)),
wherein each PAYVAR(k,l(k),i(k,l(k))) is a non vacuum subset of VAR(k,l(k)), and
wherein the union U PAYVAR(k,l(k),i(k,l(k))) contains all elements of VAR(k,l(k)), wherein the union is over all i(k,l(k)) in I(k,l(k)),
a family of sets of parameters, said family consists of:
a family of sets PAYPAR(k,l(k)),said sets are defined only when k and l(k) exist,
wherein k takes all values in K and l(k) takes all values in the union SL(k) U GL(k), and
wherein each PAYPAR(k,l(k)) is a subset of the union U VAR(k′), wherein the union is over all k′ in {0, 1, . . . , k−1}, and
a family of sets PAYPAR(k,l(k),i(k,l(k))) and the unions
PAYPAR(k,l(k))=UPAYPAR(k,l(k),i(k,l(k)))
wherein each union U PAYPAR(k,l(k),i(k,l(k))) is over all i(k,l(k)) in I(k,l(k)), said sets are defined only when k and l(k) exist,
wherein k takes all values in K, l(k) takes all values in the union EL(k) U NL(k) and i(k,l(k)) takes all values in I(k,l(k)), and
wherein each PAYPAR(k,l(k),i(k,l(k))) is a subset of the union U VAR(k′), wherein the union is over all k′ in {0, 1, . . . , k−1},
a family of sets OPTVARPAR(k,l(k),z(k,l(k))), said sets are defined only when k and l(k) exist,
wherein k takes all values in K and l(k) takes all values in PURL(k) and z(k,l(k)) takes all values in VAR(k,l(k)), and
wherein each OPTVARPAR(k,l(k),z(k,l(k))) is a subset of PAYPAR(k,l(k))
a family of sets OPTPROBMPAR(k,l(k),i(k,l(k))), said sets are defined only when k and l(k) exist,
wherein k takes all values in K, l(k) takes all values in MIXL(k) and i(k,l(k)) takes all values in I(k,l(k)), and
wherein each OPTPROBMPAR(k,l(k),i(k,l(k))) is a subset of PAYPAR(k,l(k)),
a family of functions OPTVAR(k,l(k),z(k,l(k))), said functions are defined only when k and l(k) exist,
wherein k takes all values in K, l(k) takes all values in PURL(k) and z(k,l(k)) takes all values in VAR(k,l(k)),
wherein if z belongs in VARS and OPTVAR(k,l(k),z(k,l(k))) depends on z then z belongs in OPTVARPAR(k,l(k),z(k,l(k))), and
wherein for any value of the variables the function OPTVAR(k,l(k),z(k,l(k))) takes values in the domain of the variable z(k,l(k))
a family of functions OPTPROBM(k,l(k),i(k,l(k))), said functions are defined only k and l(k) exist,
wherein k takes all values in K, l(k) takes all values in MIXL(k) and i(k,l(k)) takes all values in I(k,l(k)),
wherein if z belongs in VARS and OPTPROBM(k,l(k),i(k,l(k))) depends on z then z belongs in OPTPROBMPAR(k,l(k),i(k,l(k)),
wherein for any value of the variables in OPTPROBMPAR(k,l(k),i(k,l(k))) the value of OPTPROBM(k,l(k),i(k,l(k))) is a probability measure on all variables in VARM(i(k,l(k))), and
wherein for any value of the variables in OPTPROBMPAR(k,l(k),i(k,l(k))) the value of OPTPROBM(k,l(k),i(k,l(k))) belongs in the space SPACE(k,l(k),i(k,l(k))), said space depends on the values of the elements in PAYPAR(k,l(k))
a family of subproblem payoff functions, said family consists of:
a family of functions PAY(k,l(k)), said functions are defined only when k and l(k) exist,
wherein k takes all values in K and l(k) takes all values in the union SL(k) U GL(k), and
wherein if z belongs in VARS and PAY(k,l(k)) depends on z then z belongs in the union PAYPAR(k,l(k)) U PAYVAR(k,l(k)), and
a family of functions PAY(k,l(k),i(k,l(k))), said functions are defined only when k and l(k) exist,
wherein k takes all values in K, l(k) takes all values in the union EL(k) U NL(k) and i(k,l(k)) takes all values in I(k,l(k)), and
wherein if z belongs in VARS and PAY(k,l(k),i(k,l(k))) depends on z then z belongs in the union of PAYPAR(k,l(k),i(k,l(k))) and PAYVAR(k,l(k),i(k,l(k))),
a family of sets, said family consists of:
a family of sets OPTPAYPAR(k,l(k)), said sets are defined only when k and l(k) exist,
wherein k takes all values in K and l(k) takes all values in the union SL(k) U GL(k), and
wherein each OPTPAYPAR(k,l(k)) is a subset of PAYPAR(k,l(k)), and
a family of sets OPTPAYPAR(k,l(k),i(k,l(k))), said sets are defined only when k and l(k) exist,
wherein k takes all values in K, l(k) takes all values in the union EL(k) U NL(k) and i(k,l(k)) takes all values in I(k,l(k)), and
wherein each OPTPAYPAR(k,l(k),i(k,l(k))) is a subset of PAYPAR(k,l(k))
a family of functions, said family consists of:
a family of functions OPTPAY(k,l(k)), said functions are defined only when k and l(k) exist,
wherein k takes all values in K and l(k) takes all values in the union SL(k) U GL(k), and
wherein if z belongs in VARS and OPTPAY(k,l(k)) depends on z then z belongs in OPTPAYPAR(k,l(k)), and
a family of functions OPTPAY(k,l(k),i(k,l(k))), said functions are defined only when k and l(k) exist,
wherein k takes all values in K, l(k) takes all values in the union EL(k) U NL(k) and i(k,l(k)) takes all values in I(k,l(k)), and
wherein if z belongs in VARS and OPTPAY(k,l(k),i(k,l(k))) depends on z then z belongs in OPTPAYPAR(k,l(k),i(k,l(k))),
the assumption that given any optimization or game or empirical problem, wherein the payoff functions in said problem depend on parameters, the problem can be solved for any values of the parameters in a non vacuum domain, said solutions can be exact or approximate,
the pure solution of optimization or game or empirical problems, said solution comprises of the optimal value of each variable z(k,l(k)) and the optimal value of each payoff,
wherein the payoff functions depend on parameters in PAYPAR(k,l(k)),
wherein said solution can be exact or approximate,
wherein k takes all values in k, l(k) takes all values in PURL(k) and z(k,l(k)) takes all values in VAR(k,l(k)),
wherein for each particular value val(z′) of each variable z′ in PAYPAR(k,l(k)) the optimal value of each variable z(k,l(k)) in VAR(k,l(k)) is defined to be the value of the function OPTVAR(k,l(k),z(k,l(k))) when each variable z′ in OPTVARPAR(k,l(k),z(k,l(k))) takes the value val(z′) whenever z′ in PAYPAR(k,l(k)) belongs also in OPTVARPAR(k,l(k),z(k,l(k))), and in that case we say the optimal value of z(k,l(k)) is the function OPTVARPAR(k,l(k),z(k,l(k))),
wherein for each particular value val(z′) of each variable z′ in PAYPAR(k,l(k)) the optimal value of the payoff is defined to be the value of the payoff when each variable z(k,l(k)) in VAR(k,l(k)) takes the optimal value, whenever the payoff depends on z(k,l(k)), and
wherein furthermore:
if the payoff in the problem is the function PAY(k,l(k))
then
for each particular value val(z′) of each variable z′ in PAYPAR(k,l(k)) the optimal value of PAY(k,l(k)) is equal to the value of OPTPAY(k,l(k)) when each variable z′ in OPTPAYPAR(k,l(k)) takes the value val(z′) whenever z′ in PAYPAR(k,l(k)) belongs also in OPTPAYPAR(k,l(k)), and in that case we say the optimal value of the payoff PAY(k,l(k)) is the function OPTPAY(k,l(k)), and
if the payoffs in the problem are the functions PAY(k,l(k),i(k,l(k)))
then
for each particular value val(z′) of each variable z′ in PAYPAR(k,l(k)) the optimal value of PAY(k,l(k),i(k,l(k)))) is equal to the value of OPTPAY(k,l(k),i(k,l(k))) when each variable z′ in OPTPAYPAR(k,l(k),i(k,l(k))) takes the value val(z′) whenever z′ in PAYPAR(k,l(k)) belongs also in OPTPAYPAR(k,l(k),i(k,l(k)))), for all i(k,l(k))) in I(k,l′(k))), and in that case we say the optimal value of the payoff PAY(k,l(k),i(k,l(k))) is the function OPTPAY(k,l(k),i (k,l(k)),
the mixed solution of optimization or game or empirical problems, said solution comprises of the optimal value of each variable PROBM(i(k,l(k))) and the optimal value of each payoff,
wherein the payoff functions depend on parameters in PAYPAR(k,l(k)),
wherein said solution can be exact or approximate,
wherein k takes all values in k, l(k) takes all values in MIXL(k) and i(k,l(k)) takes all values in I(k,l(k)),
wherein for each particular value val(z′) of each variable z′ in PAYPAR(k,l(k)) the optimal value of each PROBM(i(k,l(k))) is defined to be the value of the function OPTPROBM(k,l(k),i(k,l(k))) when each variable z′ in OPTPROBMPAR(k,l(k),i(k,l(k))) takes the value val(z′) whenever z′ in PAYPAR(k,l(k)) belongs also in
OPTPROBMPAR(k,l(k),i(k,l(k))), for all (k,l(k)) in I(k,l(k)), and in that case we say the optimal value of the variable PROBM(k,l(k),i(k,l(k))) is the function OPTPROBM(k,l(k),i(k,l(k))),
wherein for each particular value val(z′) of each variable z′ in PAYPAR(k,l(k)) the optimal value of the payoff is defined to be the expectation of the payoff with respect to the product of OPTPROBM(k,l(k),i(k,l(k))) wherein the product is over all i(k,l(k)) in I(k,l(k)), and
wherein furthermore
if the payoff in the problem is the function PAY(k,l(k))
then
for each particular value val(z′) of each variable z′ in PAYPAR(k,l(k)) the optimal value of PAY(k,l(k)) is equal to the value of OPTPAY(k,l(k)) when each variable z′ in OPTPAYPAR(k,l(k)) takes the value val(z′) whenever z′ in PAYPAR(k,l(k)) belongs also in OPTPAYPAR(k,l(k)), and in that case we say the optimal value of the payoff PAY(k,l(k)) is the function OPTPAY(k,l(k)), and
if the payoffs in the problem are the functions PAY(k,l(k),i(k,l(k)))
then
for each particular value val(z′) of each variable z′ in PAYPAR(k,l(k)) the optimal value of PAY(k,l(k),i(k,l(k)))) is equal to the value of OPTPAY(k,l(k),i(k,l(k))) when each variable z′ in OPTPAYPAR(k,l(k),i(k,l(k))) takes the value val(z′) whenever z′ in PAYPAR(k,l(k)) belongs also in OPTPAYPAR(k,l(k),i(k,l(k)))), for all i(k,l(k))) in I(k,l(k))), and in that case we say the optimal value of the payoff PAY(k,l(k),i(k,l(k))) is the function OPTPAY(k,l(k), i(k,l(k))),
a family of optimization problems SPURL_PROBLEM(k,l(k)) and their solutions, said problems and solutions are defined only when k and l(k) exist,
wherein k takes all values in K and l(k) takes all values in SPURL(k),
wherein each SPURL_PROBLEM(k,l(k)) can be written, using the symbolic language of optimization theory, as
$${MAX}_{VARM ( i ( k , l ( k ) ) )} PAY ( k , l ( k ) ) , and$$
wherein the solution of each SPURL_PROBLEM(k,l(k)) comprises of the optimal value OPTVAR(k,l(k),z(k,l(k))) of each variable z(k,l(k)) in VAR(k,l(k)) and the optimal value OPTPAY(k,l(k)) of PAY(k,l(k))
a family of zero sum game problems GPURL_PROBLEM(k,l(k)) and their solutions, said problems and solutions are defined only when k and l(k) exist,
wherein k takes all values in K and l(k) takes all values in GPURL(k),
wherein each GPURL_PROBLEM(k,l(k)) can be written, using the symbolic language of game theory, as
$${MAX}_{VARM ( i ( k , l ( k ) ) )} {MIN}_{VARM ( ci ( k , l ( k ) ) )} PAY ( k , l ( k ) )$$
wherein ci(k,l(k)) denotes the element in I(k,l(k))\{i(k,l(k))}, and
wherein the solution of each GPURL_PROBLEM(k,l(k)) comprises of the optimal value OPTVAR(k,l(k),z(k,l(k))) of each variable z(k,l(k)) in VAR(k,l(k)) and the optimal value OPTPAY(k,l(k)) of PAY(k,l(k)),
a family of game problems NPURL_PROBLEM(k,l(k)) and their solutions, said problems and solutions are defined only when k and l(k) exist,
wherein k takes all values in K and l(k) takes all values in NPURL(k),
wherein each NPURL_PROBLEM(k,l(k)) can be written, using the symbolic language of game theory, as
$${MAX}_{VARM ( i ( k , l ( k ) ) )} PAY ( k , l ( k ) , i ( k , l ( k ) ) ) , i ( k , l ( k ) ) in I ( k , l ( k ) ) , and$$
wherein the solution, in the form of Nash equilibrium, of each NPURL_PROBLEM(k,l(k)) comprises of the optimal value OPTVAR(k,l(k),z(k,l(k))) of each variable z(k,l(k)) in VAR(k,l(k)) and the optimal value OPTPAY(k,l(k),i(k,l(k))) of PAY(k,l(k),i(k,l(k))) for all i(k,l(k)) in I(k, l (k)),
a family of functionals, said family consists of:
a family of functionals EXPPAY(k,l(k)), said functionals are defined only when k and l(k) exist,
wherein k takes all values in K and l(k) takes all values in the union SMIXL(k) U GMIXL(k),
wherein each EXPPAY(k,l(k)) is the functional defined by the function PAY(k,l(k))), and
wherein the arguments of the functional are the measures PROBM(i(k,l(k))), and
a family of functionals EXPPAY(k,l(k),i(k,l(k))), said functionals are defined only when k and l(k) exist,
wherein k takes all values in K, l(k) takes all values in NMIXL(k) and i(k,l(k)) takes all values in I(k,l(k)),
wherein each EXPPAY(k,l(k),i(k,l(k))) is the functional defined by the function PAY(k,l(k), i(k,l(k))), and
wherein the arguments of the functional are the measures PROBM(i(k,l(k))),
a family of optimization problems
SMIXL_PROBLEM(k,l(k)) and their solutions, said problems and solutions are defined only when k and l(k) exist,
wherein k takes values in K and l(k) takes all values in SMIXL(k),
wherein each SMIXL_PROBLEM(k,l(k)) can be written, using the symbolic language of optimization theory, as
$${MAX}_{PROBM ( i ( k , l ( k ) ) )} EXPPAY ( k , l ( k ) ) , , and$$
wherein the solution of each SMIXL_PROBLEM(k,l(k)) comprises of the optimal value. OPTPROBM(k,l(k),i(k,l(k))) of the variable PROBM(k,l(k),i(k,l(k))) and the optimal value OPTPAY(k,l(k)) of PAY(k,l(k)), wherein i(k,l(k)) takes all values in I(k,l(k))
a family of zero sum game problems
GMIXL_PROBLEM(k,l(k)) and their solutions, said problems and solutions are defined only when k and l(k) exist,
wherein k takes all values in K and l(k) takes all values in GMIXL(k),
wherein each GMIXL_PROBLEM(k,l(k)) can be written, using the symbolic language of game theory, as
$${MAX}_{PROBM ( i ( k , l ( k ) ) )} {MIN}_{PROBM ( ci ( k , l ( k ) ) )} EXPPAY ( k , l ( k ) )$$
wherein ci(k,l(k)) denotes the element in I(k,l(k))\{i(k,l(k))}, and
wherein the solution of each GMIXL_PROBLEM(k,l(k)) comprises of the optimal value OPTPROBM(k,l(k),i(k,l(k))) of each variable PROBM(k,l(k),i(k,l(k))) and the optimal value OPTPAY(k,l(k)) of PAY(k,l(k)), wherein i(k,l(k)) takes all values in I(k,l(k))
a family of game problems NMIXL_PROBLEM(k,l(k)) and their solutions, said problems and solutions are defined only when k and l(k) exist,
wherein k takes all values in K and l(k) takes all values in NMIXL(k),
wherein each NMIXL_PROBLEM(k,l(k)) can be written, using the symbolic language of game theory, as
$${MAX}_{PROBM ( i ( k , l ( k ) ) )} EXPPAY ( k , l ( k ) , i ( k , l ( k ) ) ) , \\ i ( k , l ( k ) ) in I ( k , l ( k ) ) , and$$
wherein the solution, in the form of Nash equilibrium, of each NMIXL_PROBLEM(k,l(k)) comprises of the optimal value OPTPROBM(k,l(k),i′(k,l(k))) of each variable PROBM(k,l(k),i′(k,l(k))) and the optimal value OPTPAY(k,l(k),i(k,l(k))) of each PAY(k,l(k),i(k,l(k))), wherein i′(k,l(k)) and i(k,l(k)) take all values in I(k,l(k))
a family of elements ELL_PROBLEM(k,l(k)) called lower empirical problems and their solutions called lower empirical solutions, said elements ELL_PROBLEM(k,l(k)) are defined only when k and l(k) exist,
wherein k takes all values in K and l(k) takes all values in ELL(k), and
wherein each ELL_PROBLEM(k,l(k)) and its solution comprise of:
a c-game such that the algebraic c-game in the c-game consists of e-games of order smaller or equal to 1, said c-game can be written in realization form as
{A(k,l(k),j(k,l(k))):j(k,l(k)) in J(k,l(k))},
wherein J(k,l(k)) can be chosen to be the interval of ordinals
{1, 2, . . . , Jmax(k,l(k))} wherein Jmax(k,l(k)) is an ordinal larger than 1, and
wherein each realization can be given by
A(k,l(k),j(k,l(k)))==(a0(k,l(k)),a1(k,l(k),j(k,l(k)))
wherein a0(k,l(k)) is the first e-game and a1(k,l(k),j(k,l(k))) is the second e-game in the realization,
the set of c-times
T(j(k,l(k)))==t(a0(k,l(k)),a1(k,l(k),j(k,l(k)))
wherein for each value j(k,l(k)) in J(k,l(k)) there exists a c-time T(j(k,l(k))), and
wherein said set of c-times is VAR(k,l(k)),
the vector c-time variable
T(k,l(k))==(T(1),T(2), . . . ,T(Jmax(k,l(k))
that takes values in the cube
CUBE(k,l(k))==X[to(a0(k,l(k))),t1(a0(k,l(k)))],
wherein T(j′) is the c-time T(j(k,l(k))) when j(k,l(k)) takes the value j′ in J(k,l(k)),
wherein t0(a0(k,l(k))) is the time the differential game in e-game a0(k,l(k)) begins and t1(a0(k,l(k))) the time the differential game in e-game a0(k,l(k)) ends if it is not interrupted,
wherein [to(a0(k,l(k))), t1(a0(k,l(k)))] is the closed time interval that begins at to(a0(k,l(k))) and ends at t1(a0(k,l(k))),
wherein X denotes the cartesian product, and
wherein the dimension of the cube is
Jmax(k,l(k)),
a family of subsets J(i(k,l(k))) of J(k,l(k)),
wherein each J(i(k,l(k))) contains at least one element, and
wherein each J(i(k,l(k))) is defined by: j(k,l(k)) belongs in J(i(k,l(k))) if the c-coalition M(i(k,l(k))) controls the c-time T(j(k,l(k))),
a family of subsets I(j(k,l(k))) of I(k,l(k)),
wherein each I(j(k,l(k))) contains at least one element, and
wherein each I(j(k,l(k))) is defined by: i(k,l(k)) belongs in I(j(k,l(k))) if the c-coalition M(i(k,l(k))) controls the c-time T(j (k,l(k))),
a method called main lower empirical solution, said method comprises of the steps:
use the following notation, said notation is introduced to make the formulas, shorter,
denote (T(k,l(k))) by (T),
denote (CUBE(k,l(k))) by (CUBE),
denote (T(j(k,l(k)))) by (T(j)),
denote (i(k,l(k))) by (i),
denote (I(k,l(k))) by (I),
denote (J(i(k,l(k)))) by (J(i)),
denote (PAY(k,l(k),i(k,l(k)))) by (Pi),
denote (to(a0(k,l(k)))) and (t1(a0(k,l(k)))) by (to(a0) and (t1(a0)) respectively,
denote (Pi) by (Si(j)) if realization j is chosen and j belongs in J(i),
denote (Pi) by (Qi(j)) if realization j is chosen and j belongs in J\J(i),
denote the value of Pi when the c-time vector T takes a particular value and realization j is chosen by (Pi(j,T)),
denote the value of Si(j) when the c-time vector T takes a particular value by (Si(j,T)) and
denote the value of Qi(j) when the c-time vector T takes a particular value by (Qi(j,T)),
consider two points (t,i) and (t′,i′) in
[to(a0),t1(a0)]×J,
wherein [to(a0), t1(a0)]×J denotes the cartesian product of the sets
[to(a0), t1(a0)] and J, and define a binary relation called LOWBETTER by:
(t,j) is LOWBETTER than (t′,j′)
if RLOW is true,
wherein RLOW is the logical proposition defined by the propositions:
R1=(t<t′),
R21=(there exists T in CUBE),
R22=(there exists T′ in CUBE),
R23=(there exists j in J),
R24=(there exists j′ in J),
R2=R21 [symbol] R22 [symbol] R23 [symbol] R24,
R3=(min T=T(j)) [symbol] (T(j)=t
R4=(min T′=T′(j′)) [symbol] (T′(j′)=t′),
R5=(Si(j,T)≧Pi(j′,T′)
for all i in I(j)),
R61=(there exists j″ in J),
R62=(there exists T″ in CUBE),
R63=(min T″=T″(j″) [symbol] (T″(j″)=t),
R6=R61 [symbol] R62 [symbol] R63,
R7=(I(j)∩I(j″)=Ø),
R8=(Qi(j,T)≧Pi(j′,T′)
for all i in I(j″)),
R9=(Si(j,T)>Qi(j″, T″),
for all i in I(j)),
R101=(there exists j′″ in J),
R102=(there exists T′″ in CUBE),
R103=(min T′″=T′″(j′″)) [symbol] (T′″(j′″)=t),
R10=R101 [symbol] R102 [symbol] R103,
R11=((I(j)∩I(j′″))≠Ø),
R12=(Si(j,T)≧Pi(j′,T′),
for all i in (I(j)∩I(j′″))),
R13=(Qi(j,T)≧Pi(j′,T′), for all i in I(j′″)\(I(j)∩I(j′″)),
R14=(Si(j,T)>Qi(j′″, T′″), for all i in I(j)\(I(j)∩(j′″))),
R15=R1 [symbol] R2 [symbol] R3 [symbol] R4,
R16=R5
R17=R6 [symbol] R7 [symbol] R8 [symbol] R9,
R18=R10 [symbol] R11 [symbol] R12 [symbol] R13 [symbol] R14 and
RLOW=R15 [symbol] (R16 [symbol] (R17 [symbol] R18)),
wherein (≠) denotes (not equal to), (≧) denotes (greater than or equal to), (>) denotes (greater than), (Ø) denotes the vacuum set, (∩) is the intersection of two sets symbol, (\) is the difference of two sets symbol, ( [symbol] ) is the logical conjunction symbol and ( [symbol] ) is the logical disjunction symbol,
consider a point (t′,i′) in
[to(a0),t1(a0)]×J
and define a relation called HASNOLOWBETTER by:
(t′, j′) HASNOLOWBETTER
if NOT RLOW is true
for all (t,j) that satisfy t<t′,
wherein NOT RLOW is the logical negation of logical proposition RLOW,
define KLOW1 to be the subset of
[to(a0),t1(a0)]×J
that consists of points that satisfy HASNOLOWBETTER and the points in
{to(a0)}×J
and define TEL1 to be the point in [to(a0), t1(a0)] that satisfies
$$TEL 1 = {sup}_{t} KLOW 1 ,$$
wherein
$${sup}_{t} KLOW 1$$
denotes the supremum of the set of all t in [to(a0), t1(a0)] such that (t,j) is in KLOW1,
define KLOW1′ to be the subset KLOW1 that satisfies:
(t,j) belongs in KLOW1′
if there exists (t″″, j″″) in KLOW1
such that t=t″″ and j≠j″″,
define the set KLOW2 by
KLOW2=KLOW1\KLOW1′, and
define the main lower empirical solution ELS=(TEL,j(TEL)) that consists of the point TEL in KLOW2 and the realization index j(TEL) that corresponds to TEL, wherein TEL is defined by
$$TEL = {sup}_{t} KLOW 2$$
wherein
$${sup}_{t} KLOW 2$$
denotes the supremum of the set of all t in [to(a0), t1(a0)] such that (t,j) is in KLOW2, and
wherein furthermore ELS exists and is unique if KLOW2 is non vacuum and the set of all t such that (t,j) belongs in KLOW2 is closed from the right,
methods that are simple variations of the method called main lower empirical solution,
wherein a simple variation is
either the replacement of the larger or equal inequality by strict inequality or the replacement of the strict inequality by larger or equal inequality in one or more of R1, R5, R8, R9, R12, R13 and R14
or the restriction of the domain of c-times to a non vacuum subset of the closed interval [to(a0), t1(a0)]
or both; and
wherein said simple variations can be used to obtain ELS and TEL1 as in the method called main lower empirical solution, and
the application of either the method called main lower empirical solution or one of its simple variations to the problem
ELL_PROBLEM(k,l(k)),
wherein the solution ELS=(TEL, j(TEL)) is written as
ELS(k,l(k))==(TEL(k,l(k)),j(TEL)(k,l(k))
and the point TEL1 is written as TEL1(k,l(k)), said solution and point depend on the values val(z′) of the variables z′ in PAYPAR(k,l(k)),
wherein there exist a function ELL_ASIGNVAR(k,l(k)), said function depends on the values val(z′) of the variables z′ in PAYPAR(k,l(k)),said function assigns to each c-time variable T(j(k,l(k))) an optimal value OPTLOWT(j(k,l(k))), said optimal value depends on the values val(z′) of the variables z′ in PAYPAR(k,l(k)),
wherein OPTLOWT(j(k,l(k))) is defined to be the time TEL(k,l(k)) if j(k,l(k)) equals j(TEL)(k,l(k)), and
wherein OPTLOWT(j(k,l(k))) is defined to be a value larger than TEL(k,l(k)) if j(k,l(k)) is different from j(TEL) (k,l(k)),
wherein whenever z(k,l(k)) is the c-time T(j(k,l(k))) OPTLOWT(j(k,l(k))) is defined to be OPTVAR(k,l(k),z(k,l(k))), and
wherein the optimal value of PAY(k,l(k),i(k,l(k))) is OPTPAY(k,l(k),i(k,l(k))),
a family of elements EUL_PROBLEM(k,l(k)) called upper empirical type problems and their solutions called upper empirical solutions, said elements EUL_PROBLEM(k,l(k)) are defined only when k and l(k) exist,
wherein k takes all values in K and l(k) takes all values in EUL(k), and
wherein each EUL_PROBLEM(k,l(k)) and its solution comprise of:
a c-game defined as in the case of lower empirical solution,
the set of c-times T(j(k,l(k))) defined as in the case of lower empirical solution,
the vector c-time variable T(k,l(k)) defined as in the case of lower empirical solution,
a family of subsets J(i(k,l(k))) of J(k,l(k)) defined as in the case of lower empirical solution,
a family of subsets I(j(k,l(k))) of I(k,l(k)) defined as in the case of lower empirical solution,
a method called main upper empirical solution, said method comprises of the steps:
use the notation introduced in the case of the lower empirical solution,
consider two points (t,i) and (t′,i′) in
[to(a0),t1(a0)]×J,
wherein [to(a0), t1(a0)]×J denotes the cartesian product of the sets
[to(a0), t1(a0)] and J, and define a binary relation called UPBETTER by
(t,j) is UPBETTER than (t′,j′)
if RUP is true,
wherein RUP is the logical proposition defined by
RUP=R1 [symbol] R2 [symbol] R3 [symbol] R4 [symbol] R5
wherein R1, R2, R3, R4, and R5 are the logical propositions defined in the case of the lower empirical solution,
consider a point (t′,i′) in
[to(a0),t1(a0)]×J
and define a relation called HASNOUPBETTER by
(t′, j′) HASNOUPBETTER
if NOT RUP is true
for all (t,j) that satisfy t<t′,
wherein NOT RUP is the logical negation of logical proposition RUP,
define KUP1 to be the subset of
[to(a0),t1(a0)]×J
that consists of points that satisfy HASNOUPBETTER and the points in
{to(a0)}×J
and define TEU1 to be the point in [to(a0), t1(a0)] that satisfies
$$TEU 1 = {sup}_{t} KUP 1$$
wherein
$${sup}_{t} KUP 1$$
denotes the supremum of the set of all t in
[to(a0), t1(a0)] such that (t,j) is in KUP1,
define KUP1′ to be the subset KUP1 that satisfies:
(t,j) belongs in KUP1′
if there exists (t″″, j″″) in KUP1
such that t=t″″ and j≠j″″,
define the set KUP2 by KUP2=KUP1\KUP1′, and
define the main upper empirical solution EUS=(TEU,j(TEU)) that consists of the point TEU in KUP2 and the realization index j(TEU) that corresponds to TEU, wherein TEU is defined by
$$TEU = {sup}_{t} KUP 2$$
wherein
$${sup}_{t} KUP 2$$
denotes the supremum of the set of all t in [to(a0), t1(a0)] such that (t,j) is in KUP2, and
wherein furthermore EUS exists and is unique if KUP2 is non vacuum and the set of all t such that (t,j) belongs in KUP2 is closed from the right,
methods that are simple variations of the method called main upper empirical solution,
wherein a simple variation is
either the replacement of the larger or equal inequality by strict inequality or the replacement of the strict inequality by larger or equal inequality in one or more of R1 and R5
or the restriction of the domain of c-times to a non vacuum subset of the closed interval [to(a0), t1(a0)]
or both, and
wherein said simple variation can be used to obtain EUS and TEU1 as in the method called main upper empirical solution, and
the application of either the method called main upper empirical solution or its simple variations to the problem
EUL_PROBLEM(k,l(k)),
wherein the solution EUS=(TEU, j(TEU)) is written as
EUS(k,l(k))==(TEU(k,l(k)),j(TEU)(k,l(k))
and the point TEU1 is written as TEU1(k,l(k)), said solution and point depend on the values val(z′) of the variables z′ in PAYPAR(k,l(k)),
wherein there exists a function EUL_ASIGNVAR(k,l(k)), said function depends on the values val(z′) of the variables z′, said function assigns to each c-time variable T(j(k,l(k))) an optimal value OPTUPT(j(k,l(k))), said optimal value depends on the values val(z′) of the variables z′,
wherein OPTUPT(j(k,l(k))) is defined to be the time TEU(k,l(k)) if j(k,l(k)) equals j (TEU) (k,l(k)), and
wherein OPTUPT(j(k,l(k))) is defined to be a value larger than TEU(k,l(k)) if j (k,l(k)) is different from j(TEU) (k,l(k)),
wherein whenever z(k,l(k)) is the c-time T(j(k,l(k))) OPTUPT(j (k,l(k))) is defined to be OPTVAR(k,l(k),z(k,l(k))), and
wherein the optimal value of PAY(k,l(k),i(k,l(k))) is OPTPAY(k,l(k),i(k,l(k))),
a family of elements EGGPURL_PROBLEM(k,l(k)) called empirical game type pure problems and their solutions called empirical game type pure solutions, said elements are defined only when k and l(k) exist,
wherein k takes all values in K and l(k) takes all values in EGGPURL(k), and
wherein each EGGPURL_PROBLEM(k,l(k)) comprises of:
a set GAMEINFO(k,l(k)), said set is introduced to simplify the presentation of empirical game problems, said set comprises of:
c-game and the c-time variables as in the case of lower empirical solution,
the functions PAY(k,l(k),i(k,l(k))) for all values of i(k,l(k)) in I(k,l(k)),
an upper empirical problem with payoffs PAY(k,l(k),i(k,l(k))), its solution EUS(k,l(k)) and the point TEU1(k,l(k)),
a lower empirical problem with payoffs PAY(k,l(k),i(k,l(k))), its solution ELS(k,l(k)) and the point TEL1(k,l(k)), and
for each particular value val(z′) of each variable z′ in PAYPAR(k,l(k)) the times T0(k,l(k)) and T1(k,l(k)),
wherein T0(k,l(k)) can be either TEL(k,l(k)) or TEL1(k,l(k)),
wherein T1(k,l(k)) can be either TEU(k,l(k)) or TEU1(k,l(k)), and
wherein T0(k,l(k)) and T1(k,l(k)) depend on the values val(z′) of the variables z′,
a function EGGPURL_FUN(k,l(k)),
wherein EGGPURL_FUN(k,l(k)) is a function of the functions PAY(k,l(k),i(k,l(k)))
wherein i(k,l(k)) takes values in I(k,l(k)),
wherein EGGPURL_FUN(k,l(k)) depends on all variables in PAYVAR(k,l(k)), and
wherein if z belongs in VARS\VAR(k,l(k)) and EGGPURL_FUN(k,l(k)) depends on z then z belongs in VAR(k′) wherein k′ belongs in K and is smaller than k,
the formulation of a zero sum game problem
$${MAX}_{VARM ( i ( k , l ( k ) ) )} {MIN}_{VARM ( ci ( k , l ( k ) ) )} EGGPURL\_FUN ( k , l ( k ) ) ,$$
wherein ci(k,l(k)) denotes the element in
I(k,l(k))\{i(k,l(k))}
wherein the c-times take values in the interval that begins at T0(k,l(k)) and ends at T1(k,l(k)), and
wherein the solution of said game problem exists and the optimal value of each variable z(k,l(k)) in VAR(k,l(k)) is OPTVAR(k,l(k),z(k,l(k))), and
the empirical game type pure solution of EGGPURL_PROBLEM(k,l(k)), said solution is denoted by the prefix (EGPS), said solution comprises of:
the EGPS optimal value of each variable z(k,l(k)) in VAR(k,l(k)), said optimal value is defined to be OPTVAR(k,l(k),z(k,l(k))), and
the EGPS optimal value of each PAY(k,l(k),i(k,l(k))), said optimal value of PAY(k,l(k),i(k,l(k))) is OPTPAY(k,l(k),i(k,l(k))),
a family of EGNPURL_PROBLEM(k,l(k)) elements called empirical Nash type pure problems and their solutions called empirical Nash type pure solutions, said elements are defined only when k and l(k) exist,
wherein k takes all values in K and l(k) takes all values in EGNPURL(k), and
wherein each EGNPURL_PROBLEM(k,l(k)) comprises of:
a set GAMEINFO(k,l(k)), said set is defined as in the case of EGGPURL_PROBLEM(k,l(k)),
a family of functions
EGNPURL_FUN(k,l(k),i(k,l(k))),
wherein i(k,l(k)) takes all values in I(k,l(k)),
wherein each EGNPURL_FUN(k,l(k),i(k,l(k))) is a function of the functions PAY(k,l(k),i′(k,l(k))) wherein i′(k,l(k)) takes values in I(k,l(k)),
wherein each variable z(k,l(k)) in VAR(k,l(k)) is a variable in at least one EGNPURL_FUN(k,l(k),i(k,l(k))), for some i(k,l(k)) in I(k,l(k)), and
wherein if z belongs in VARS\VAR(k,l(k)) and EGNPURL_FUN(k,l(k),i(k,l(k))) depends on z then z belongs in VAR(k′) wherein k′ belongs in K and is smaller than k,
the formulation of a game problem,
$${MAX}_{VARM ( i ( k , l ( k ) ) )} EGNPURL\_FUN ( k , l ( k ) , i ( k , l ( k ) ) ) , \\ i ( k , l ( k ) ) in I ( k , l ( k ) ) ,$$
wherein the c-times take values in the interval that begins at T0(k,l(k)) and ends at T1(k,l(k)), and
wherein the solution, in the form of Nash equilibrium, of said game problem exists and the optimal value of each variable z(k,l(k)) in VAR(k,l(k)) is OPTVAR(k,l(k),z(k,l(k))), and
the empirical Nash type pure solution of EGNPURL_PROBLEM(k,l(k)), said solution is denoted by the prefix (ENPS), said solution comprises of:
the ENPS optimal value of each variable z(k,l(k)) in VAR(k,l(k)), said optimal value is defined to be OPTVAR(k,l(k),z(k,l(k))), and
the ENPS optimal value of each PAY(k,l(k),i(k,l(k))), said optimal value of PAY(k,l(k),i(k,l(k))) is OPTPAY (k,l(k), i(k,l(k)))
a family of elements EGGMIXL_PROBLEM(k,l(k)) called empirical game type mixed problems and their solutions called empirical game type mixed solutions, said elements are defined only when k and l(k) exist,
wherein k takes all values in K and l(k) takes all values in EGGMIXL(k),
wherein for each value of k and l(k) there exists a EGGMIXL_PROBLEM(k,l(k)) in the family, and
wherein each EGGMIXL_PROBLEM(k,l(k)) comprises of
a set GAMEINFO(k,l(k)), said set is defined as in the case of EGGPURL_PROBLEM(k,l(k)),
a function EGGMIXL_FUN(k,l(k)),
wherein EGGMIXL_FUN(k,l(k)) is a function of the functions PAY(k,l(k),i(k,l(k))) wherein i(k,l(k)) takes values in I(k,l(k)),
wherein EGGMIXL_FUN(k,l(k)) depends on all variables in VAR(k,l(k)), and
wherein if z belongs in VARS\VAR(k,l(k)) and EGGMIXL_FUN(k,l(k)) depends on z then z belongs in VAR(k′) wherein k′ belongs in K and is smaller than k,
a functional EGGMIXL_EXPFUN(k,l(k)), said functional is the functional defined by the function EGGMIXL_FUN(k,l(k)), wherein the arguments of the functional are the measures PROBM(i(k,l(k))),
the formulation of a zero sum game problem
$${MAX}_{PROBM ( i ( k , l ( k ) ) ) } {MIN}_{PROBM ( ci ( k , l ( k ) ) )} EGGMIXL\_EXPFUN ( k , l ( k ) ) ,$$
wherein ci(k,l(k)) denotes the element in
I(k,l(k))\{i(k,l(k))},
wherein the c-times take values in the interval that begins at T0(k,l(k)) and ends at T1(k,l(k)), and
wherein the solution of said game problem exists and the optimal value of each variable PROBM(i(k,l(k))) is OPTPROBM(k,l(k),i(k,l(k))), and
the empirical game type mixed solution of EGGMIXL_PROBLEM(k,l(k)), said solution is denoted by the prefix (EGMS), said solution comprises of:
the EGMS optimal value of each variable PROBM(i(k,l(k))), said optimal value is defined to be OPTPROBM(k,l(k),i(k,l(k))), and
the EGMS optimal value of each PAY(k,l(k),i(k,l(k))), said optimal value of PAY(k,l(k),i(k,l(k))) is OPTPAY(k,l(k),i(k,l(k))),
a family of elements EGNMIXL_PROBLEM(k,l(k)) called empirical Nash type mixed problems and their solutions called empirical Nash type mixed solutions, said elements are defined only when k and l(k) exist,
wherein k takes all values in K and l(k) takes all values in EGNMIXL(k),
wherein for each value of k and l(k) there exists a EGNMIXL_PROBLEM(k,l(k)) in the family, and
wherein each EGNMIXL_PROBLEM(k,l(k)) comprises of:
a set GAMEINFO(k,l(k)), said set is defined as in the case of EGGPURL_PROBLEM(k,l(k)),
a family of functions
EGNMIXL_FUN(k,l(k),i(k,l(k))),
wherein i(k,l(k)) takes all values in I(k,l(k)),
wherein each EGNMIXL_FUN(k,l(k),i(k,l(k))) is a function of the functions PAY(k,l(k),i′(k,l(k)))
wherein i′(k,l(k)) takes values in I(k,l(k)),
wherein each variable z(k,l(k)) in VAR(k,l(k)) is a variable in at least one EGNMIXL_FUN(k,l(k),i(k,l(k))), for some i(k,l(k)) in I(k,l(k)), and
wherein if z belongs in VARS\VAR(k,l(k)) and EGNMIXL_FUN(k,l(k),i(k,l(k))) depends on z then z belongs in VAR(k′) wherein k′ belongs in K and is smaller than k,
a family of functionals
EGNMIXL_EXPFUN(k,l(k),i(k,l(k))),
wherein i(k,l(k)) takes all values in I(k,l(k)),
wherein each
EGNMIXL_EXPFUN(k,l(k),i(k,l(k))) is the functional defined by the function EGNMIXL_FUN(k,l(k),i(k,l(k))), and
wherein the arguments of the functionals are the measures PROBM(i′(k,l(k))) wherein i′(k,l(k)) belongs in I(k,l(k)),
the formulation of a game problem
$${MAX}_{PROBM ( i ( k , l ( k ) ) )} EGNMIXL\_EXPFUN ( k , l ( k ) ) . , \\ i ( k , l ( k ) ) in I ( k , l ( k ) ) ,$$
wherein the c-times take values in the interval that begins at T0(k,l(k)) and ends at T1(k,l(k)), and
wherein the solution, in the form of Nash equilibrium, of said game problem exists and the optimal value of each variable PROBM(i(k,l(k))) is OPTPROBM(k,l(k),i(k,l(k))), and
the empirical Nash type mixed solution of EGNMIXL_PROBLEM(k,l(k)), said solution is denoted by the prefix (ENMS), said solution comprises of:
the ENMS optimal value of each variable PROBM(i(k,l(k))), said optimal value is defined to be OPTPROBM(k,l(k),i(k,l(k))), and
the ENMS optimal value of each PAY(k,l(k),i(k,l(k))), said optimal value of PAY(k,l(k),i(k,l(k))) is OPTPAY(k,l(k),i(k,l(k))),
a family of elements called other type problems OL_PROBLEM(k,l(k)) and their solutions OL_S(k,l(k)), said elements are defined only when k and l(k) exist,
wherein k takes all values in K and l(k) takes all values in OL(k), and
wherein each OL_S(k,l(k)) comprises of:
the set VAR(k,l(k)) of variables,
a partition of VAR(k,l(k)) into two subsets OL_PURVAR(k,l(k)) and OL_MIXVAR(k,l(k)),
wherein OL_PURVAR(k,l(k)) is not vacuum if PUROL(k) is not vacuum and l(k) belongs in PUROL(k),
wherein OL_MIXVAR(k,l(k)) is not vacuum if MIXOL(k) is not vacuum and l(k) belongs in MIXOL(k), and
wherein OL_MIXVAR(k,l(k)) does not contain any element that belongs in NIVAR,
a family of functions OPTVAR(k,l(k),z(k,l(k))), said functions exist only if k and l(k) and z(k,l(k)) exist,
wherein l(k) belongs in PUROL(k) and z(k,l(k)) takes all values in OL_PURVAR(k,l(k)), and
wherein the set of variables of each OPTVAR(k,l(k),z(k,l(k))) is the set OPTVARPAR(k,l(k), z (k, l(k))),
wherein OPTVARPAR(k,l(k),z(k,l(k))) consists of elements in VAR(k′) wherein k′ belongs in K and is smaller than k, and
wherein for each value of the variables in OPTVARPAR(k,l(k),z(k,l(k))) the function OPTVAR(k,l(k),z(k,l(k))) takes values in the domain of the variable z(k,l(k)), and
a function OPTPROBM(k,l(k)), said function exists only if k and l(k) exist,
wherein l(k) belongs in MIXOL(k), and wherein the set of variables of OPTPROBM(k,l(k)) is the set OPTPROBMPAR(k,l(k)),
wherein OPTPROBMPAR(k,l(k)) consists of elements in VAR(k′) wherein k′ belongs in K and is smaller than k, and
wherein for each value val(z) of each variable z in OPTPROBMPAR(k,l(k)) the value of the function OPTPROBM(k,l(k)) is a probability measure on OL_MIXVAR(k,l(k)),
the sets PURVAR(k,l(k)), said sets are defined only
when k and l(k) exist,
wherein k takes all values in K and l(k) takes all values in PURL(k) U PUROL(k), and
wherein each PURVAR(k,l(k)) is defined by:
if l(k) belongs in PURL(k)
then PURVAR(k,l(k)) is the set VAR(k,l(k)) and
if l(k) belongs in PUROL(k)
then PURVAR(k,l(k)) is the set OL_PURVAR(k,l(k))
the set RECOPTVAR, said set consists of all elements RECOPTVAR(k,l(k),z(k,l(k))), said elements are defined by induction on k, wherein k takes all values in the interval K={0, 1, . . . , Kmax}, in the following steps:
each RECOPTVAR(0,1(0),z(0,1(0))) is defined to be OPTVAR(0, 1(0),z(01, (0))), wherein 1(0) takes all values in PURL(0) U PUROL(0) and z(0,1(0)) takes all values in PURVAR(0,1(0)), and
if RECOPTVAR(k′,l′(k′),z′(k′,l′(k′))) are defined for all k′ in {0, 1, . . . , k} and all l′(k′) in PURL(k′) U PUROL(k′) and all z′(k′,l′(k′)) in PURVAR(k′,l′(k′)),
then each RECOPTVAR(k+1,l(k+1),z(k+1,l(k+1))) is defined to be OPTVAR(k+1,l(k+1),z(k+1,l(k+1))),
wherein l(k+1) takes all values in PURL(k+1) U PUROL(k+1) and z(k+1,l(k+1)) takes all values in PURVAR(k+1,l(k+1)), and
wherein furthermore each z′(k′,l′(k′)) that belongs in the intersection of PURVAR(k′,l′(k′)) and OPTVARPAR(k+1,l(k+1),z(k+1,l(k+1))) is replaced with
RECOPTVAR(k′,1′ (k′),z′(k′,l′(k′))),
wherein k′ takes all values in
{0,1, . . . ,k},
wherein l′(k′) takes all values in PURL(k′) U PUROL(k′), and
wherein z′(k′,l′(k′)) takes all values in the intersection of PURVAR(k′,l′(k′)) and
OPTVARPAR(k+1,l(k+1),z(k+1,l(k+1))),
the set RECOPTPROBM, said set is the union of the sets RECOPTPROBM1 and RECOPTPROBM2,
wherein RECOPTPROBM1 consists of all RECOPTPROBM(k,l(k),i(k,l(k))),
wherein k takes all values in K and l(k) takes all values in MIXL(k) and i(k,l(k)) takes all values in I(k,l(k)), and
wherein each RECOPTPROBM(k,l(k),i(k,l(k))) is defined to be OPTPROBM(k,l(k),i(k,l(k))) wherein furthermore each z′(k′,l′(k′)) that belongs in the intersection of PURVAR(k′,l′(k′)) and OPTPROBMPAR(k,l(k),i(k,l(k))) is replaced with RECOPTVAR(k′,l(k′),z′(k′,l′(k′))),
wherein k′ takes all values in
{0,1, . . . ,k−1},
wherein l′(k′) takes all values in PURL(k′) U PUROL(k′), and
wherein z′(k′,l′(k′)) takes all values in the intersection of PURVAR(k′,l′(k′)) and OPTPROBMPAR (k,l(k),i(k, (k))), and
wherein RECOPTPROBM2 consists of all RECOPTPROBM(k,l(k)),
wherein k takes all values in K and l(k) takes all values in MIXOL(k), and
wherein each RECOPTPROBM(k,l(k)) is defined to be OPTPROBM(k,l(k))
wherein furthermore each z′(k′,l′(k′)) that belongs in the intersection of PURVAR(k′,l′(k′)) and OPTPROBMPAR(k,l(k)) is replaced with
RECOPTVAR(k′,l(k′),z′(k′,l′(k′))),
wherein k′ takes all values in
{0,1, . . . ,k−1},
wherein l′(k′) takes all values in PURL(k′) U PUROL(k′), and
wherein z′(k′,l′(k′)) takes all values in the intersection of PURVAR(k′,l′(k′)) and OPTPROBMPAR(k,l(k)),
a family of functions F(i),
wherein i takes all values in I,
wherein for each i there exists one F(i), and
wherein each F(i) depends on variables that belong in a subset VARF(i) of VARS, and
the mixed recursive optimal solution of the c-game with respect to the particular mixed recursive method, said solution is denoted the prefix (MRS), said solution comprises of:
the MRS optimal values of all variables z(k,l(k)) that belong in PURVAR(k,l(k)) in the c-game,
wherein the MRS optimal value of z(k,l(k)) is defined to be RECOPTVAR(k,l(k),z(k,l(k))),
the MRS optimal values of all measure variables PROBM(i(k,l(k))) and all measure variables PROBM(k,l(k)),
wherein the MRS optimal value of PROBM(i(k,l(k))) is defined to be RECOPTPROBM(k,l(k),i(k,l(k))), and
wherein the MRS optimal value of PROBM(k,l(k)) is defined to be RECOPTPROBM(k,l(k)), and
the MRS optimal value of the payoff P(M(i)) of each c-coalition M(i) in the c-game, wherein i takes all values in I, and wherein each MRS optimal value is defined by:
define RECF(i) be the function F(i)
wherein furthermore each z(k,l(k)) in the intersection of VARF(i) and PURVAR(k,l(k)) is replaced by RECOPTVAR(k,l(k),z(k,l(k))),
wherein k takes all values in K,
wherein l(k) takes all values in PURL(k) U PUROL(k), and
wherein z(k,l(k)) takes all values in the intersection of PURVAR(k,l(k)) and VARF(i),
define EXPRECF(i) to be the expectation of RECF(i) with respect to the product of all measures
RECOPTPROBM(k,l(k),i(k,l(k))) and RECOPTPROBM(k,l(k)),
wherein it is assumed that after the integrations are performed the resulting expression EXPRECF(i) does not depend on any variable that belongs in VARS, and
define the MRS optimal value of the payoff P(M(i)) to be EXPRECF(i).

19. The method of claim 18 wherein furthermore only one of the sets {SL(k): k in K}, {GL(k): k in K}, {NL(k): k in K}, {ELL(k): k in K}, {EUL(k): k in K}, {EGGL(k): k in K} and {EGNL(k): k in K}contains elements that are different from the vacuum set and the rest sets and the set {OL(k): k in K}contain the vacuum set.

20. The method of claim 18 wherein furthermore:
K is an one element set and L(k) is an one element set,
F(i) are defined to be P(M(i)), wherein i belongs in I,
P(k,l(k)) is defined to be P(M(i)) if SL(k) is not the vacuum set and l(k) belongs in SL(k), wherein i belongs in I(k,l(k)),
P(k,l(k)) is defined to be a function of the functions P(M(i′)) if GL(k) is not the vacuum set and l(k) belongs in GL(k), wherein i′ belongs in I(k,l(k)), and
P(k,l(k),i(k,l(k))) is defined to be P(M(i)) if NL(k)U EL(k) is not the vacuum set and l(k) belongs in NL(k)U EL(k), wherein i belongs in I(k,l(k)).

21. The method of claim 18 wherein furthermore
k takes values in the interval K={0, 1, . . . , Kmax}wherein Kmax is equal to MAXN−1 wherein MAXN is the maximum order of e-games in the c-game,
for each k in K there exist one to one map from the set L(k) onto the set of all e-games of order k in the c-game that are not leaves, wherein to the element l(k) corresponds the e-game a(k,l(k)),
the c-game is written in realization form as
{A(j):j in J}
wherein each realization is given by
A(j)==(a(j,0),a(j,1), . . . ,a(j,k),a(j,k+1), . . . ,a(j,k(j))),
wherein k(j) belongs in the union K U {MAXN},
for all k in K and all l(k) in L(k) and all a(k,l(k)) the C1(a(k,l(k)))-subgame with root the e-game a(k,l(k)) of order k is written as
C1(a(k,l(k)))=={A(j′(k,l(k))):j′(k,l(k)) in J′(k,l(k))}
wherein each realization is
A(j′(k,l(k)))==(a(k,l(k)),b(j′(k,l(k)))),
said realization is written also as
A(j′(k,l(k)))==(a(j,k),a(j,k+1)
wherein a(k,l(k)) is the e-game a(j,k) and b(j′(k,l(k))) is the c-game a(j,k+1) for some j in J,
for all k in K and all l(k) in L(k)
the set VAR(k,l(k)) consists of all c-times in the C1(a(k,l(k)))-subgame, all additional variables that belong in the sets ADVAR(a) and all non-isaacs variables that belong in the sets NIVAR(a), wherein a is an e-game in C1(a(k,l(k)))-subgame,
the payoffs P(M(i)) of each c-coalition M(i) in the c-game are given by
P(M(i))=SUM SIG(A(j))P(M(i),A(j)),
wherein i belongs in I and the sum is over all j in J,
wherein each SIG(A(j)) is a function that has the following property:
if realization A(j″) is played
then SIG(A(j)) takes the value zero
for all j″ and j in J
such that j″ is different from j,
said function can be the characteristic function of the domain DCT(j) that corresponds to realization A(j),
wherein each P(M(i), A(j)) is a function called payoff of c-coalition M(i) in realization A(j) in the c-game, said function it is assumed it exists for all j in J and all i in I, and
wherein each P(M(i), A(j)) is given by
P(M(i),A(j))=SUM P(M(i),a(j,k)),
wherein a(j,k) is an e-game of order k in realization A(j),
wherein the sum is over all k in the interval {0, 0.1, . . . , k(j)}, and
wherein each P(M(i), a(j,k)) is a function called the payoff of c-coalition M(i) in e-game a(j,k) in the c-game, said function it is assumed it exists for all j in J and all k in {0, 1, . . . , k(j)},
there exist functions P(M(i(k,l(k))),k,l(k)), said functions are called payoff of c-coalition M(i(k,l(k))) in C1(i(k,l(k))-subgame,
wherein k takes all values in K and l(k) takes all values in L(k) and I takes all values in I(k,l(k)), and
wherein each P(M(i(k,l(k))),k,l(k)) is given by:
denote (i(k,l(k)) by (i′)
denote (a(k,l(k)) by (a)
denote (j′) and (J′) by (j′(k,l(k))) and J′(k, l (k))) respectively,
denote realization (A(j′(k,l(k)))) by (A(j′)),
denote the e-games (a(j,k)) and b(j′(k,l(k)))) by (a) and (b(j′) respectively, and
define P(M(i(k,l(k))),k,l(k)) by
P(M(i′),k,l(k))==SUM SIG(A(j′))P(M(i′),A(j′)),
wherein the sum is over all j′ in J′,
wherein each SIG(A(j′)) is a function that has the following property:
if realization A(j′″) of the C1(a)-subgame is played
then SIG(A(j′)) takes the value zero, for all j′″ and j′ in J′ such that j′″ is different from j′,
said function can be the characteristic function of the domain DCT(j′) that corresponds to realization A(j′), and
wherein P(M(i), A(j′)) is defined by
P(M(i′),A(j′))==P(M(i′),a)+P″(M(i′),b(j′))
wherein P(M(i′),a) is the given payoff of M(i′) in e-game a, and
wherein if b(j′) is a leaf then P″(M(i′), b(j′)) is the given payoff P(M(i′), b(j′)) of M(i′) in e-game b(j′),
the functions PAY(k,l(k)) and PAY(k,l(k),i(k,l(k))) are functions of the functions
P(M(i′),k,l(k)), wherein i′ belongs in I(k,l(k)), whenever the functions PAY(k,l(k)) or PAY(k,l(k),i(k,l(k))) exist, and
each set PAYPAR(k,l(k)) is {t0(a(k,l(k))} wherein t0(a(k,l(k)) is the time the differential game in e-game a(k,l(k)) begins, for all k in K and all l(k) in L(k).

22. The method of claim 21 wherein furthermore:
if i belongs in I(0,1(0))
then if i is i(0,1(0))
then F(i) is defined to be
P(M(i(0,1(0)),0,1(0))), and
if b(j′) is not a leaf and the e-game b(j′) of order k+1 is written as b(k+1,l(k+1)) for some l(k+1) in L(k+1) and i′ belongs in I(k+1, l(k+1)
then
P″(M(i′), b(j′)) is defined to be the optimal value OPTP(M(i′),k+1,l(k+1)) of P(M(i′),k+1,l(k+1)),
said optimal value is defined by:
if l(k+1) belongs in PURL(k+1)
then
OPTP(M(i′),k+1,l(k+1)) is defined to be the value of P(M(i′),k+1,l(k+1)) when its variables z(k+1,l(k+1)) that belong in VAR(k+1,l(k+1)) take the optimal values OPTVAR(k+1,l(k+1),z(k+1,l(k+1))),
if l(k+1) belongs in MIXL(k+1)
then
OPTP(M(i′),k+1,l(k+1)) is defined to be the expected value of P(M(i′),k+1,l(k+1)) with respect to the optimal measures OPTPROBM(k+1,l(k+1),i(k+1,l(k+1))), and
if l(k+1) belongs in OL(k+1)
then
P1(M(i′),k+1,l(k+1)) is defined to be the value of P(M(i′),k+1,l(k+1)) when its variables z(k+1,l(k+1)) that belong in OL_PURVAR(k+1,l(k+1)) take the optimal values OPTVAR(k+1,l(k+1),z(k+1,l(k+1))) and OPTP(M(i′),k+1,l(k+1)) is defined to be the expected value of P1(M(i′),k+1,l(k+1)) with respect to the optimal measure OPTPROBM(k+1,l(k+1)).

23. The method of claim 22 wherein furthermore
if l(k) belongs in SL(k)
then PAY(k,l(k)) is defined to be P(M(i),k,l(k)), wherein i belongs in I(k,l(k)),
if l(k) belongs in GL(k)
then PAY(k,l(k)) is defined to be
P(M(i),k,l(k))−P(M(ci),k,l(k)),
wherein i and ci belong in I(k,l(k)), and
if l(k) belongs in NL(k) U EL(k)
then PAY(k,l(k),i(k,l(k))) is defined to be
P(M(i),k,l(k)),
wherein i=i(k,l(k)) and i belongs in I(k,l(k)).

24. The method of claim 23 wherein furthermore
the set VARS consists of c-times and all c-changes ((a, b)) in the c-game satisfy:
N1(a)=N1(b)) [symbol] (N2(a)=N2(b)) is not true, wherein ( [symbol] ) is the logical conjunction symbol.

25. The method of claim 18 wherein furthermore
k takes values in the interval K={0, 1, . . . , Kmax}wherein Kmax is equal to MAXN wherein MAXN is the maximum order of e-games in the c-game,
for each k in K there exist one to one map from the set L(k) onto the set of all e-games of order k in the c-game, wherein to the element l(k) corresponds the e-game a(k,l(k)),
the c-game is written in realization form as
{A(j):j in J}
wherein each realization is given by
A(j)==(a(j,0),a(j,1), . . . ,a(j,k),a(j,k+1), . . . ,a(j,k(j))),
wherein k(j) belongs in K,
for all k in K and all l(k) in L(k) and all a(k,l(k)) that are not leaves
the C1(a(k,l(k)))-subgame with root the e-game a(k,l(k)) of order k is written as
C1(a(k,l(k)))=={A(j′(k,l(k))):j′(k,l(k)) in J′(k,l(k))}
wherein each realization is
A(j′(k,l(k)))==(a(k,l(k)),b(j′(k,l(k)))),
said realization is written also as
A(j′(k,l(k)))=(a(j,k),a(j,k+1)
wherein a(k,l(k)) is the e-game a(j,k) and b(j′(k,l(k))) is the c-game a(j,k+1) for some j in J,
for all k in K and all l(k) in L(k) and all a(k,l(k)) that are not leaves
the set VAR(k,l(k)) consists of all c-times in the C1(a(k,l(k)))-subgame, all additional variables that belong in the sets ADVAR(a) and all non-isaacs variables that belong in the sets NIVAR(a), wherein a is an e-game in C1(a(k,l(k)))-subgame,
for all k in K and all l(k) in L(k) and all a(k,l(k)) that are leaves
the set VAR(k,l(k)) consists of all additional variables that belong in the ADVAR(a(k,l(k))) and all non-isaacs variables that belong in the set NIVAR(a(k,l(k))),
the payoffs P(M(i)) of each c-coalition M(i) are given by
P(M(i))=SUM SIG(A(j))P(M(i),A(j)),
wherein i belongs in I and the sum is over all j in J,
wherein each SIG(A(j)) is a function that has the following property:
if realization A(j″) is played
then SIG(A(j)) takes the value zero
for all j″ and j in J
such that j″ is different from j,
said function can be the characteristic function of the domain DCT(j) that corresponds to realization A(j),
wherein each P(M(i), A(j)) is a function called payoff of c-coalition M(i) in realization A(j) in the c-game, said function it is assumed it exists for all j in J and all i in I, and
wherein each P(M(i), A(j)) is given by
P(M(i),A(j))=SUM P(M(i),a(j,k)),
wherein a(j,k) is an e-game of order k in realization A(j),
wherein the sum is over all k in the interval {0, 1, . . . , k(j)}, and
wherein each P(M(i), a(j,k)) is a function called the payoff of c-coalition M(i) in e-game a(j,k) in the c-game, said function it is assumed it exists for all j in J and all k in {0, 1, . . . , k(j)},
there exist functions P(M(i(k,l(k))),k,l(k)),
wherein k takes all values in K and l(k) takes all values in L(k) and i(k,l(k)) takes all values in I(k,l(k)), and
wherein if a(k,l(k)) is not a leaf then each P(M(i′),k,l(k)), wherein i′=i(k,l(k)), is given by:
denote (a(k,l(k)) by (a
denote (j′) and (J′) by (j′(k,l(k))) and J′(k,l(k))) respectively,
denote realization (A(j′(k,l(k)))) by (A (j′)),
denote the e-games (a(j,k)) and b(j′(k,l(k)))) by (a) and (b(j′) respectively, and
define P(M(i′),k,l(k)) by
(M(i′),k,l(k))==SUM SIG(A(j′))P(M(i′),A(j′)),
wherein the sum is over all j′ in J′,
wherein each SIG(A(j′)) is a function that
has the following property:
if realization A(j′″) of the C1(a)-subgame is played
then SIG(A(j′)) takes the value zero, for all j′″ and j′ in J′ such that j′″ is different from j′,
said function can be the characteristic function of the domain DCT(j′) that corresponds to realization A(j′), and
wherein P(M(i′), A(j′)) is defined by
P(M(i′),A(j′))==P(M(i′),a)+P″(M(i′),b(j′))
wherein P(M(i′),a) is the given payoff of M(i′) in e-game a,
the functions PAY(k,l(k)) and PAY(k,l(k),i(k,l(k))) and are functions of the functions
P(M(i′),k,l(k)), wherein i′belongs in I(k,l(k)), whenever the functions PAY(k,l(k)) or
PAY(k,l(k),i(k,l(k))) exist, and
each set PAYPAR(k,l(k)) is {t0(a(k,l(k))} wherein t0(a(k,l(k)) is the time the differential game in e-game a(k,l(k)) begins, for all k in K and all l(k) in L(k).

26. The method of claim 25 wherein furthermore
if i belongs in I(0,1(0))
then if i is i(0,1(0))
then F(i) is defined to be P(M(i(0,1(0)),0,1(0))), and
if b(j′) of order k+1 is written as b(k+1,l(k+1)) for some l(k+1) in L(k+i) and i′ belongs in I(k+1, l(k+1) then
P″(M(i′), b(j′)) is defined to be the optimal value OPTP(M(i′),k+1,l(k+1)) of the given function P(M(i′),k+1,l(k+1)), said optimal value is defined by:
if l(k+1) belongs in PURL(k+1)
then OPTP(M(i′),k+1,l(k+1)) is defined to be the value of P(M(i′),k+1,l(k+1)) when the variables z(k+1,l(k+1)) in VAR(k+1,l(k+1)) take the optimal values
OPTVAR(k+1,l(k+1),z(k+1,l(k+1))),
if l(k+1) belongs in MIXL(k+1)
then OPTP(M(i′),k+1,l(k+1)) is defined to be the expected value of P(M(i′),k+1,l(k+1)) with respect to the optimal measures
OPTPROBM(k+1,l(k+1),i(k+1,l(k+1))), and
if l(k+1) belongs in OL(k+1)
then P1(M(i′),k+1,l(k+1)) is defined to be the value of P(M(i′),k+1,l(k+1)) when the variables z(k+1,l(k+1)) in
OL_PURVAR(k+1,l(k+1)) take the optimal values OPTVAR(k+1 μl(k+1),z(k+1,l(k+1)))
and
OPTP(M(i′),k+1,l(k+1)) is defined to be the expected value of P1(M(i′),k+1,l(k+1)) with respect to the optimal measure OPTPROBM(k+1,l(k+1)).

27. The method of claim 26 wherein furthermore
if l(k) belongs in SL(k)
then PAY(k,l(k)) is defined to be P(M(i′),k,l(k)), wherein i′ belongs in I(k,l(k)),
if l(k) belongs in GL(k)
then PAY(k,l(k)) is defined to be
P(M(i′),k,l(k))−P(M(ci′),k,l(k)),
wherein i′ and ci′ belong in I(k,l(k)), and
if l(k) belongs in NL(k) U EL(k)
then PAY(k,l(k),i(k,l(k))) is defined to be P(M(i′),k,l(k)), wherein i′=i(k,l(k)) and i′ belongs in I(k,l(k)).

28. The method of claim 27 wherein furthermore
all c-changes ((a, b)) in the c-game satisfy:
(N1(a)=N1(b)) [symbol] (N2(a)=N2(b)) is not true, wherein ( [symbol] ) is the logical conjunction symbol.

29. The method of*claim 18 wherein furthermore
the set VARS consists of c-times and all c-changes ((a, b)) in the c-game satisfy:
N1(a)=N1(b)) [symbol] (N2(a)=N2(b)) is not true, wherein ( [symbol] ) is the logical conjunction symbol.
